(19) United States
(12) Patent Application Publication
(10) Pub. No.: US 2021/0140252 A1
(43) Pub. Date: May 13, 2021

(54) Multi-Screen Drilling Mud and Completion Fluids Screen System and Methods Thereof

(71) Applicant: Black Diamond Oilfield Rentals LLC, Houston, TX (US)

(72) Inventors: Christopher M. Biggerstaff, Houston, TX (US); Don A. Comeaux, Houston, TX (US); Charles G. Kibbe, New Iberia, LA (US); Jeremy Hebert, New Iberia, LA (US)

(73) Assignee: Black Diamond Oilfield Rentals LLC, Houston, TX (US)

(21) Appl. No.: 17/088,035

(22) Filed: Nov. 3, 2020

Related U.S. Application Data
(60) Provisional application No. 62/932,789, filed on Nov. 8, 2019.
(60) Provisional application No. 62/983,151, filed on Feb. 28, 2020.

(51) Int. Cl. E21B 21/06

(52) U.S. Cl. CPC E21B 21/065; B07B 1/469

(57) ABSTRACT

A multi-screen drilling mud screen system, comprises a drilling mud screen comprising a body, a drilling mud or completion fluid inlet at the first end of the body (or outlet at the second end of the body), a filter having openings, wherein the filter is fluidly connected to the body, a drilling mud or completion fluid outlet (or inlet) at the openings of the filter, and an end cap connected to the filter, wherein the filter comprises a plurality of rods spaced a distance apart disposed within a formed sheet having drilled holes or slots spaced apart to form the openings in the filter, or a wire wrap disposed within a formed sheet having drilled holes or slots spaced apart to form the openings in the filter. Methods of installing and using the drilling mud screen are also disclosed.

### PRIOR RELATED APPLICATIONS

This application claims benefit of U.S. Provisional Patent Application Ser. No. 62/983,151 entitled “MULTI-SCREEN DRILLING MUD AND COMPLETION FLUIDS SCREEN SYSTEM AND METHODS THEREOF,” filed on Feb. 28, 2020 and U.S. Provisional Patent Application Ser. No. 62/932,789 entitled “MULTI-SCREEN DRILLING MUD AND COMLPETION FLUIDS SCREEN SYSTEM AND METHODS THEREOF,” filed on Nov. 8, 2019; the entire contents of which are hereby incorporated by reference, for any and all purposes.

### FEDERALLY SPONSORED RESEARCH STATEMENT

Not Applicable (N/A)

### REFERENCE TO MICROFICHE APPENDIX

N/A

### FIELD OF INVENTION

The present invention relates generally to an improved drilling mud and completion fluid screen system and methods thereof and, more particularly, to an improved multi-screen drilling mud and completion fluid screen system and methods thereof for drilling and completion operations.

### BACKGROUND OF THE INVENTION

Many drilling rigs are used for both drilling and completion operations.

Often, these drilling rigs use drill pipe mud screens that are in-line with the drilling assembly to filter debris from drilling mud. Typically, drilling mud screens are installed on the drill floor or at the bottom of the drill string. If the drilling mud screen is installed on the drill floor, the drilling mud screen must be reinstalled or replaced every time a section of standpipe is added to the drill string. In other words, the drilling mud screens must be installed at the top of each 90-foot stand of pipe above the rig crew. As each stand of drill pipe is drilled down to the derrick floor, the top drive sub-connection is separated from the drill pipe stand connection and the drilling mud screen is installed to the top of the next stand of pipe going in the hole. This is a dangerous practice that can result in accidents to the crew below.

If the drilling mud screen is installed at the bottom of the drill string, the drilling mud screen must be brought to the surface to be replaced. This is an inefficient practice that can results in lost drilling time.

Further, drilling mud screens are not designed to be used for both drilling and completion operations. If the drilling mud screen is not designed for both drilling and completion operations, the drilling mud screen must be removed for completion operations and hydrostatic testing. This is also an inefficient practice that results in lost completion time.

Instead of a drilling mud screen, a filter press is used to remove debris from completion fluids at high volumetric flow but low pressure (e.g., about 32 barrels per minute at about 200 psi). The filter press is not capable of filtering debris at about 800 gallons per minute at about 8000 psi. This is an inefficient method that results in lost throughput.

Thus, an improved multi-screen drilling mud and completion fluid screen system is needed to eliminate these problems.

### SUMMARY OF THE INVENTION

In an embodiment, a drilling mud screen system comprises a first body having a first drilling mud or completion fluid inlet, an optional first drilling mud or completion fluid inlet, a first drilling mud or completion fluid outlet and a drilling mud screen access port, a drilling mud screen, and a first end cap.

In an aspect of the invention, a multi-screen drilling mud screen comprises a first body having a first drilling mud or completion fluid inlet and a first drilling mud or completion fluid outlet, a second body having a second drilling mud or completion fluid inlet and a second drilling mud or completion fluid outlet and a drilling mud screen assembly disposed within the first body and the second body between the first drilling mud or completion fluid inlet and the second drilling mud or completion fluid outlet.

In an embodiment, a multi-screen drilling mud screen system, comprises a first body having a first end and a second end, a first drilling mud or completion fluid inlet at the first end of the first body, a first drilling mud or completion fluid outlet at the second end of the first body, a second body having a first end, a mid-portion and a second end, a second drilling mud or completion fluid inlet at the first end of the second body, a second drilling mud or completion fluid outlet at the second end of the second body, a union system, comprising a third body having a first inlet at a first end and a first outlet at second end, a fourth body having a second inlet at a first end and a second outlet at a second end, and a fifth body having a first and second end and a drilling mud screen assembly.

In an embodiment, the first drilling mud or completion fluid outlet of the first body is fluidly connected to the second drilling mud or completion fluid inlet of the second body.

In an embodiment, the second end of the first body is disposed through the first end of the fifth body such that a portion of the third body is disposed between the second end of the second body and a portion of the first end of the fifth body.

In an embodiment, the first end of the second body is disposed through the second end of the fifth body such that a portion of the fourth body is disposed between the first end of the second body and a portion of the second end of the fifth body.

In an embodiment, a first shoulder connection is between the first body and the third body. In an embodiment, a first shoulder connection is between the first body and the third body and/or between the first body and the fifth body.

In an embodiment, a second shoulder connection is between the second body and the fourth body. In an embodiment, a second shoulder connection is between the second body and the fourth body and/or between the second body and the fifth body.

In an embodiment, the first shoulder connection comprises a first box shoulder and a first pin shoulder. In an embodiment, the first shoulder connection comprises a first box shoulder of the first body at a first box angle with respect to a first perpendicular to a centerline of the first body at a first end point, and a first pin shoulder of the third body at a first pin angle with respect to a second perpendicular to the centerline of the first body at a second end point.

In an embodiment, the first box angle is from about 0 degrees to about 30 degrees. In an embodiment, the first box angle is about 15 degrees. In an embodiment, the first box angle is about 0 degrees.

In an embodiment, the first pin angle is from about 0 degrees to about 30 degrees. In an embodiment, the first pin angle is about 15 degrees. In an embodiment, the first pin angle is about 0 degrees.

In an embodiment, the second shoulder connection comprises a second box shoulder and a second pin shoulder. In an embodiment, the second shoulder connection comprises a second box shoulder of the second body at a second box angle with respect to a third perpendicular to a centerline of the second body at a third end point, and a second pin shoulder of the fourth body at a second pin angle with respect to a fourth perpendicular to the centerline of the second body at a fourth end point.

In an embodiment, the second box angle is from about 0 degrees to about 30 degrees. In an embodiment, the second box angle is about 15 degrees. In an embodiment, the second box angle is about 0 degrees.

In an embodiment, the second pin angle is from about 0 degrees to about 30 degrees. In an embodiment, the second pin angle is about 15 degrees. In an embodiment, the second pin angle is about 0 degrees.

In an embodiment, the drilling mud screen assembly is disposed within the first body and the second body between the first drilling mud or completion fluid inlet and the second drilling mud or completion fluid outlet.

In an embodiment, the drilling mud screen assembly comprises an assembly body having a first end and a second end, one or more drilling mud or completion fluid inlet at the first end of the assembly body, one or more drilling mud or completion fluid outlet at the second end of the assembly body and one or more drilling mud screens fluidly connected to the one or more drilling mud or completion fluid outlet at the second end of the assembly body.

In another embodiment, the drilling mud screen assembly comprises an assembly body having a first end and a second end, one or more drilling mud or completion fluid inlets at the first end of the assembly body, one or more drilling mud or completion fluid outlets at the second end of the assembly body, and one or more drilling mud screens fluidly connected to the one or more drilling mud or completion fluid inlet at the first end of the assembly body.

In an embodiment, the one or more drilling mud screens are structured to filter particle sizes from about 3/16-inches and larger from drilling mud. In an embodiment, the one or more drilling mud screens are structured to filter particle sizes from about 200 microns to about 2500 microns from completion fluids.

In an embodiment, the drilling mud screen assembly comprises from about one to about twenty drilling mud screens. In an embodiment, the drilling mud screen assembly comprises from about one to about ten drilling mud screens. In an embodiment, the drilling mud screen assembly comprises about four drilling mud screens.

In an embodiment, one or more of the assembly body and the drilling mud screen is constructed from AISI 4145 or equivalent material, stainless steel or combinations thereof. In an embodiment, one or more of the assembly body and the drilling mud screen has a hardened coating. In an embodiment, one or more of the assembly body and the drilling mud screen has a Carbide coating with about 6% Cobalt binder or equivalent material.

In an embodiment, the assembly body has a means to engage a puller/installer tool. In an embodiment, each one of the drilling mud screen has a means to engage a drilling mud screen puller/installation tool.

In an embodiment, the assembly body of the drilling mud screen assembly has a means to engage a drilling mud screen puller/installer tool. In an embodiment, the drilling mud screen body of each of the one or more drilling mud screen has a means to engage a drilling mud screen puller/installer tool.

In an embodiment, the first end of the assembly body of the drilling mud screen assembly has a means to engage a drilling mud screen puller/installer tool. In an embodiment, a first end of each of the one or more drilling mud screen has a means to engage a drilling mud screen puller/installer tool.

In an embodiment, the assembly body has a first portion and a second portion, wherein the first portion has a first length from about 4-inches to about 8-inches, and the second portion has a second length from about 5-inches to about 15-inches.

In an embodiment, the assembly body comprises a centerline, wherein the centerline of the assembly body and an outer surface of the assembly body form an angle, and wherein the angle is from about 30-degrees to about 60-degrees.

In an embodiment, the assembly body comprises a centerline, wherein a plurality of drilling mud or completion fluid inlets are disposed radially around the centerline of the assembly body and a plurality of drilling mud or completion fluid outlets are disposed radially around the centerline of the assembly body.

In an embodiment, each of the one or more drilling mud screen comprises a drilling mud screen body having a first end and a second end; a drilling mud or completion fluid inlet at the first end of the drilling mud screen body; a filter having a first end, a second end and openings, wherein the first end of the filter is fluidly connected to the second end of the drilling mud screen body; a drilling mud or completion fluid outlet at the openings of the filter; and an end cap fluidly connected at the second end of the filter.

In another embodiment, each of the one or more drilling mud screen comprises a drilling mud screen body having a first end and a second end, a drilling mud or completion fluid inlet at the first end of the drilling mud screen body, a filter having a first end, a second end and openings, wherein the second end of the filter is fluidly connected to the first end of the drilling mud screen body, a drilling mud or completion fluid inlet at the openings of the filter, and an end cap fluidly connected at the first end of the filter,

In an embodiment, each of the one or more drilling mud screens are structured to filter particles sizes from about 3/16-inches and larger from drilling mud. In an embodiment, each of the one or more drilling mud screens are structured to filter particle sizes from about 200 microns to about 2500 microns from completion fluid.

In an embodiment, one or more of the drilling mud screen body, the filter and the end cap are constructed of AISI 4145 or equivalent material, tool steel, stainless steel or combinations thereof. In an embodiment, one or more of the drilling mud screen body, the filter and the end cap has a hardened coating. In an embodiment, one or more of the drilling mud screen body, the filter and the end cap has a Carbide coating with about 6% Cobalt binder or equivalent material.

In an embodiment, the filter comprises a plurality of rods spaced a distance apart to form the openings in the filter. In an embodiment, the filter comprises a formed sheet having drilled holes or slots spaced apart to form the openings in the filter. In an embodiment, the filter comprises a plurality of rods spaced apart disposed in a formed sheet having drilled holes or slots spaced apart to form the openings in the filter. In an embodiment, the filter comprises a wire wrap disposed in a formed sheet having drilled holes or slots spaced apart to form the openings in the filter.

In an embodiment, an inner surface of the end cap and a centerline of the body form a first angle. In an embodiment, the first angle is from about 30-degrees to about 160-degrees. In an embodiment, the first angle is about 120-degrees. In an embodiment, the first angle is about 90-degrees.

In another embodiment, an outer surface of the end cap and a centerline of the body form a second angle. In an embodiment, the second angle is from about 30-degrees to about 90-degrees. In an embodiment, the second angle is about 45-degrees.

In an embodiment, a drilling mud screen comprises a body having a first end and a second end; a drilling mud or completion fluid inlet at the first end of the body; a filter having a first end, a second end and openings, wherein the filter is fluidly connected to the second end of the body; a drilling mud or completion fluid outlet at the openings of the filter; and an end cap fluidly connected at the second end of the filter, wherein the filter comprises a plurality of rods spaced a distance apart disposed within a formed sheet having drilled holes or slots spaced apart to form the openings in the filter, or a wire wrap disposed within a formed sheet having drilled holes or slots spaced apart to form the openings in the filter.

In another embodiment, a drilling mud screen comprises a body having a first end and a second end, a drilling mud or completion fluid inlet at the first end of the body, a filter having a first end, a second end and openings, wherein the second end of the filter is fluidly connected to the second end of the body, a drilling mud or completion fluid outlet at the openings of the filter, an end cap fluidly connected at the first end of the filter, wherein the filter comprises a plurality of rods spaced a distance apart disposed within a formed sheet having drilled holes or slots spaced apart to form the openings in the filter, or a wire wrap disposed within a formed sheet having drilled holes or slots spaced apart to form the openings in the filter.

In an embodiment, each of the one or more drilling mud screens are structured to filter particles sizes from about 3/16-inches and larger from drilling mud. In an embodiment, each of the one or more drilling mud screens are structured to filter particle sizes from about 200 microns to about 2500 microns from completion fluid.

In an embodiment, one or more of the body, the filter and the end cap are constructed of AISI 4145 or equivalent material, tool steel, stainless steel or combinations thereof. In an embodiment, one or more of the drilling mud screen body, the filter and the end cap has a hardened coating. In an embodiment, one or more of the drilling mud screen body, the filter and the end cap has a Carbide coating with about 6% Cobalt binder or equivalent material.

In an embodiment, the body has a means to engage a puller/installer tool.

In an embodiment, the filter comprises the plurality of rods spaced a distance apart disposed within the formed sheet having drilled holes or slots to form the openings in the filter. In an embodiment, the drilled holes or slots are drilled in offset rows or straight rows from the first end to the second end. In an embodiment, each of the plurality of rods have a first end and a second end and wherein each of the rods are tapered from first end to the second end. In an embodiment, the filter is tapered from the first end to the second end.

In an embodiment, the filter comprises the wire wrap disposed in the formed sheet having drilled holes or slots spaced apart to form the openings in the filter. In an embodiment, the drilled holes or slots are drilled in offset rows or straight rows from the first end to the second end. In an embodiment, the filter is tapered from the first end to the second end.

In an embodiment, the drilling mud screen system further comprises a first assembly (e.g., cross-over connection) having a first end and a second end, a third drilling mud or completion fluid inlet at the first end of the first assembly, a third drilling mud or completion fluid outlet at the second end of the first assembly, a second assembly (e.g., cross-over connection) having a first end and a second end, a fourth drilling mud or completion fluid inlet at the first end of the second assembly and a fourth drilling mud or completion fluid outlet at the second end of the second assembly. In an embodiment, the third drilling mud or completion fluid outlet of the first assembly is fluidly connected to the first drilling mud or completion fluid inlet of the first body. In an embodiment, the second drilling mud or completion fluid outlet of the second body is fluidly connected to the fourth drilling mud or completion fluid inlet of the second assembly.

In an embodiment, the second end of the first body is modified to reduce an inside surface exit angle to transition from a first inner diameter of the first body to a second inner diameter of the fifth body. In an embodiment, the exit angle is from about 10-degrees to about 90-degrees. In an embodiment, the exit angle is about 40-degrees.

In an embodiment, the first end of the second body is modified to reduce an inside surface entry angle to transition from a first inner diameter of the fifth body to a second inner diameter of the second body. In an embodiment, the entry angle is from about 10-degrees to about 90-degrees. In an embodiment, the entry angle is about 30-degrees.

In an embodiment, the mid-portion of the second body is modified to reduce an inside surface entry angle to transition from a first inner diameter of the second body to a second inner diameter of the second body. In an embodiment, the entry angle is from about 10-degrees to about 90-degrees. In an embodiment, the entry angle is about 10-degrees or about 15-degrees.

In an embodiment, the second end of the third body and the first end of the fifth body form a first union.

In an embodiment, the second end of the fifth body and the first end of the fourth body form a second union.

In an embodiment, the third drilling mud outlet of the first assembly is fluidly connected to the first drilling mud or completion fluid inlet of the first body via a connection.

In an embodiment, the second drilling mud or completion fluid outlet of the second body is fluidly connected to the fourth drilling mud or completion fluid inlet of the second assembly via a connection.

In an embodiment, the fifth body is capable of receiving a portion of the first body when the first drilling mud or completion fluid outlet of the first subassembly is opened.

In an embodiment, the fifth body is capable of receiving a portion of the second body when the second drilling mud or completion fluid inlet of the second subassembly is opened.

In an embodiment, the drilling mud screen system further comprises a skid comprising a base and a first support having a first end and a second end. In an embodiment, the first end of the first support is attached to the base. In an embodiment, the second end of the first support is attached to the union system.

In an embodiment, the first support is capable of being lowered, pivoted, raised, rotated or any combination thereof. In an embodiment, the first support is capable of being lowered, pivoted, raised, rotated or any combination thereof via a connection, coupling and/or extension. In an embodiment, the first support is capable of being automatically lowered, pivoted, raised and/or rotated. In an embodiment, the first support is capable of being manually lowered, pivoted, raised and/or rotated.

In an embodiment, the drilling mud screen system further comprises a second support having a first end and a second end. In an embodiment, the first end of the second support is attached to the base and wherein the second end of the second support is attached to the first assembly.

In an embodiment, the drilling mud screen system further comprises a third support having a first end and a second end. In an embodiment, the first end of the third support is attached to the base and wherein the second end of the third support is attached to the second assembly.

In an embodiment, one or more of the second support and the third support is capable of being lowered, pivoted, raised, rotated or any combination thereof. In an embodiment, one or more of the second support and the third support is capable of being lowered, pivoted, raised, rotated or any combination thereof via a connection, coupling and/or extension. In an embodiment, one or more of the second support and the third support is capable of being automatically lowered, pivoted, raised and/or rotated. In an embodiment, one or more of the second support and the third support is capable of being manually lowered, pivoted, raised and/or rotated.

In an embodiment, one or more of the first assembly, the second assembly, the first body, the second body, the third body and the fourth body are constructed from AISI 4140/120k or equivalent material, AISI 4145 or equivalent, or combinations thereof. In an embodiment, one or more of the assembly body and the drilling mud screen are constructed from AISI 4145 or equivalent, stainless steel or combinations thereof. In an embodiment, one or more of the assembly body and the drilling mud screen has a hardened coating. In an embodiment, one or more of the first assembly, the second assembly, the first body. The second body. The third body and the fourth body has a Carbide coating with about 6% Cobalt binder or equivalent material.

In an aspect of the invention, a method of installing a multi-screen drilling mud screen system comprises a) providing the multi-screen drilling mud screen system, b) stopping a drilling mud pump to fluidly connect the multi-screen drilling mud screen to the drilling mud pump, c) fluidly connecting the multi-screen drilling mud screen system in line with and immediately upstream or downstream of the drilling mud pump and d) operating the drilling mud pump to produce flow of drilling mud or completion fluid through the multi-screen drilling mud screen system.

In an embodiment, step c) comprises fluidly connecting a drilling mud or completion fluid inlet of the multi-screen drilling mud screen system to a high-pressure outlet of the drilling mud pump and fluidly connecting a drilling mud or completion fluid outlet of the multi-screen drilling mud screen system to a vibrator hose or a standpipe.

In an embodiment, step c) comprises fluidly connecting a drilling mud or completion fluid inlet of the multi-screen drilling mud screen system to a high-pressure inlet of the drilling mud pump and fluidly connecting a drilling mud or completion fluid outlet of the multi-screen drilling mud screen system to an inlet of a vibrator hose.

In an embodiment, step c) comprises fluidly connecting a drilling mud or completion fluid inlet of the multi-screen drilling mud screen system to an outlet of a vibrator hose and a drilling mud or completion fluid outlet of the multi-screen drilling mud screen system to an inlet of a standpipe.

In an embodiment, step c) comprises fluidly connecting a drilling mud or completion fluid inlet of the multi-screen drilling mud screen system to an outlet of a first portion of a standpipe and a drilling mud or completion fluid outlet of the multi-screen drilling mud screen system to an inlet of a second portion of the standpipe.

In an embodiment, the method further comprises step e) filtering or screening debris from drilling mud. In an embodiment, the method further comprises step e) filtering or screening particles from drilling mud or completion fluid.

In an aspect of the invention, a method of removing and replacing a drilling mud screen in a multi-screen drilling mud screen system comprises a) providing the multi-screen drilling mud screen system, b) stopping a drilling mud pump connected to the multi-screen drilling mud screen system, c) opening the first drilling mud or completion fluid outlet of the first subassembly and/or the second drilling mud or completion fluid inlet of the second subassembly in the multi-screen drilling mud screen system to remove and replace one or more drilling mud screen, d) accessing the interior of the multi-screen drilling mud screen system to pull the one or more drilling mud screen from the multi-screen drilling mud screen system and to install one or more replacement drilling mud screen into the multi-screen drilling mud screen system, e) closing the first drilling mud or completion fluid outlet of the first subassembly and/or the second drilling mud or completion fluid inlet of the second subassembly in the multi-screen drilling mud screen system and f) operating the drilling mud pump to produce flow of drilling mud or completion fluid through the multi-screen drilling mud screen system.

In an embodiment, step c) comprises: (c-1) rotating the first body to disengage the first assembly and/or rotating the second body to disengage the second assembly and (c-2) sliding the first body further into the union system to fully disengage the first assembly and/or sliding the second body into the union system to fully disengage the second assembly.

In an embodiment, step c) further comprises (c-3) lifting, lowering, pivoting, rotating, sliding or otherwise moving one or more of the first assembly, the second assembly, the union system and any combination thereof to open the multi-screen drilling mud screen system to remove the one or more drilling mud screen.

In an embodiment, step d) further comprises using a puller/installer plate of a puller/installer tool to engage and pull the one or more drilling mud screen from the multi-screen drilling mud screen system.

In an embodiment, step d) further comprises using a puller/installer plate and/or a rounded end of a puller/installer tool to install the one or more replacement drilling mud screen into the multi-screen drilling mud screen system.

In an embodiment, step d) further comprises using a stop plate, groove or painted line of the puller/installer tool to determine when the one or more replacement drilling mud screen is installed into the multi-screen drilling mud screen system.

In an embodiment, step e) comprises (e-1) lifting, lowering, pivoting, rotating, sliding or otherwise moving one or more of a first assembly, a second assembly, the union system and any combination thereof to close the multi-screen drilling mud screen system, (e-2) sliding the first body to engage the first assembly and/or sliding the second body to engage the second body and (e-3) rotating the first body to fully engage the first assembly and/or rotating the second body to fully engage the second assembly.

In an aspect of the invention, a flow loop configuration comprises a first drilling mud manifold having a first drilling mud or completion fluid inlet and a plurality of first drilling mud or completion fluid outlets, a plurality of the drilling mud screen systems, a second drilling mud manifold having a plurality of second drilling mud or completion fluid inlets and a second drilling mud or completion fluid outlet. In an embodiment, one of the plurality of first drilling mud or completion fluid outlets are fluidly connected to each of the first drilling mud or completion fluid inlets of the plurality of drilling mud screen systems. In an embodiment, each the first drilling mud or completion fluid outlets of the plurality of drilling mud screen systems are fluidly connected to one of the plurality of second drilling mud or completion fluid inlets of the second drilling mud manifold.

In an embodiment, the flow loop configuration further comprises a first plurality of gate valves. In an embodiment, each of the plurality of first drilling mud or completion fluid outlets of the first manifold are fluidly connected to one of the first plurality of gate valves. In an embodiment, each of the first plurality of gate valves is fluidly connected to one of the first drilling mud or completion fluid inlets of the plurality of drilling mud screen systems.

In an embodiment, the flow loop configuration further comprises a second plurality of gate valves. In an embodiment, each of the first drilling mud or completion fluid outlets of the plurality of drilling mud screen systems is fluidly connected to one of the second plurality of gate valves. In an embodiment, each of the second plurality of gate valves is fluidly connected to one of second drilling mud or completion fluid inlets of the second manifold.

In an embodiment, the flow loop configuration further comprises a third gate valve. In an embodiment, one of the plurality of first drilling mud or completion fluid outlets of the first manifold is fluidly connected to a third drilling mud or completion fluid inlet of the third gate valve. In an embodiment, a third drilling mud or completion fluid outlet of the third gate valve is fluidly connected to one of the plurality of drilling mud or completion fluid inlets of the second manifold. In an embodiment, the third gate valve is a bypass valve.

In an embodiment, a method of installing a flow loop configuration comprises a) providing the flow loop configuration, b) stopping a drilling mud pump to fluidly connect the flow loop configuration to the drilling mud pump, c) fluidly connecting the flow loop configuration in line with and immediately upstream or downstream of the drilling mud pump; and d) operating the drilling mud pump to produce flow of drilling mud or completion fluid through the flow loop configuration.

In an embodiment, step c) comprises fluidly connecting a drilling mud or completion fluid inlet of the flow loop configuration to a high-pressure outlet of the drilling mud pump and fluidly connecting a drilling mud or completion fluid outlet of the flow loop configuration to a vibrator hose or a standpipe.

In an embodiment, step c) comprises fluidly connecting a drilling mud or completion fluid inlet of the flow loop configuration to a high-pressure inlet of the drilling mud pump and fluidly connecting a drilling mud or completion fluid outlet of the flow loop configuration to an inlet of a vibrator hose.

In an embodiment, step c) comprises fluidly connecting a drilling mud or completion fluid inlet of the flow loop configuration to an outlet of a vibrator hose and a drilling mud or completion fluid outlet of the flow loop configuration to an inlet of a standpipe.

In an embodiment, step c) comprises fluidly connecting a drilling mud or a completion fluid inlet of the flow loop configuration to an outlet of a first portion of a standpipe and a drilling mud or completion fluid outlet of the flow loop configuration to an inlet of a second portion of the standpipe.

In an embodiment, the method further comprises step e) filtering or screening particles from drilling mud or completion fluid.

In an embodiment, at least one of the plurality of drilling mud screen systems is structured to filter particles from drilling mud and wherein at least one of the plurality of drilling mud screen systems is structured to filter particles from completion fluid. In an embodiment, at least one of the plurality of drilling mud screen systems is structured to filter particles sizes from about 3/16-inches and larger from drilling mud. In an embodiment, at least one of the plurality of drilling mud screen systems is structured to filter particles sizes from about 200 microns to about 2500 microns from completion fluid.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1A illustrates a cut-away, side view of a multi-screen drilling mud screen system, showing a drilling mud screen assembly with four drilling mud screens;

FIG. 1B illustrates a left-side perspective view of the multi-screen drilling mud screen system of FIG. 1A;

FIG. 1C illustrates a right-side perspective view of the multi-screen drilling mud screen system of FIG. 1A;

FIG. 1D illustrates a side view of the drilling mud screen assembly of FIGS. 1A-1C;

FIG. 1E illustrates a left-side perspective view of the drilling mud screen assembly of FIGS. 1A-1D, showing four drilling mud screens;

FIG. 2A illustrates a cut away, side view of the multi-screen drilling mud screen system, showing a first subassembly and a second subassembly;

FIG. 2B-1 illustrates a cut-away, side view of a multi-screen drilling mud screen system of FIG. 2A, showing a drilling mud screen assembly with four drilling mud screens;

FIG. 2B-2 illustrates a cut-away, side view of a multi-screen drilling mud screen system of FIG. 2A, showing a drilling mud screen assembly with four drilling mud screens;

FIG. 2B-3 illustrates a cut-away, side view of a multi-screen drilling mud screen system of FIG. 2A, showing a drilling mud screen assembly with four drilling mud screens;

FIG. 2C illustrates a cut-away, left-side perspective view of the multi-screen drilling mud screen system of FIGS. 2A-2B, showing the drilling mud screen assembly with four drilling mud screens;

FIG. 3A illustrates a left-side perspective view of the drilling mud screen assembly, showing four drilling mud screens;

FIG. 3B illustrates a side view of one of the drilling mud screens of FIG. 3A, showing a perforated outer shell;

FIG. 3C illustrates a cut-away, side view of the drilling mud screen of FIG. 3B, showing a wire wrap screen disposed inside the perforated shell;

FIG. 3D illustrates a side view of the wire wrap screen of FIG. 3C, showing the wire wrap wrapped around a frame;

FIG. 3E illustrates a cross-section view of the wire wrap screen of FIG. 3D, showing the wire wrap wrapped around the frame;

FIG. 4A illustrates an upper, left perspective view of a multi-screen drilling mud screen system in a flow loop configuration, showing a pair multi-screen drilling mud screen systems;

FIG. 4B illustrates a front view of the flow loop configuration of FIG. 4A;

FIG. 4C illustrates a right-side view of the flow loop configuration of FIGS. 4A-4B;

FIG. 4D illustrates a top view of the flow loop configuration of FIGS. 4A-4C;

FIG. 5A illustrates an upper, left perspective view of a multi-screen drilling mud screen systems in an alternative flow loop configuration, showing a pair of multi-screen drilling mud screen systems;

FIG. 5B illustrates a front view of the alternative flow loop configuration of FIG. 5A;

FIG. 5C illustrates a right-side view of the alternative flow loop configuration of FIGS. 5A-5B;

FIG. 5D illustrates a top view of the alternative flow loop configuration of FIGS. 5A-5C, showing the multi-screen drilling mud screen systems in the closed position;

FIG. 5E illustrates a top view of the alternative flow loop configuration of FIGS. 5A-5D, showing the multi-screen drilling mud screen system in the open position;

FIG. 6 illustrates a flow diagram for a method of using the multi-screen drilling mud screen system;

FIG. 7 illustrates a flow diagram for a method of installing and removing one or more drilling mud screens for the multi-screen drilling mud screen system;

FIG. 8A illustrates a cut away, side view of a multi-screen drilling mud screen system, showing a first subassembly and a second subassembly;

FIG. 8B illustrates a detail view of a first body and a second body of the multi-screen drilling mud screen of FIG. 8A;

FIG. 8C illustrates a detail view of a first body of a first union and a second body of a second union of the multi-screen drilling mud screen system of FIG. 8A;

FIG. 9A illustrates a cut away side view of a multi-screen drilling mud screen system, showing a reversed drilling mud screen assembly; and

FIG. 9B illustrates a detail view of the reversed drilling mud screen assembly of FIG. 9A, showing four reversed drilling mud screens.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

Exemplary Drilling Mud Screen System

Multi-Screen Drilling Mud Screen System

In an embodiment, a multi-screen drilling mud screen system may be used to provide easier access to the drilling mud screens, and to reduce the foot-print and the pressure-drop of the drilling mud screen system. The multi-screen drilling mud screen system also may be used to create a redundancy and/or to increase through put.

FIG. 1A illustrates a cut-away, side view of a multi-screen drilling mud screen system 100, showing a drilling mud screen assembly 140 with four drilling mud screens 140a; FIG. 1B illustrates a left-side perspective view of the multi-screen drilling mud screen system 100 of FIG. 1A, showing the drilling mud screen assembly 140 with four drilling mud screens 140a; FIG. 1C illustrates a right-side perspective view of the multi-screen drilling mud screen system 100 of FIG. 1A; FIG. 1D illustrates a side view of the drilling mud screen assembly 140 of FIGS. 1A-1C; and FIG. 1E illustrates a left-side perspective view of the drilling mud screen assembly 140 of FIGS. 1A-1D.

FIG. 2A illustrates a cut away, side view of the multi-screen drilling mud screen system 200, showing a first subassembly 2100a and a second subassembly 2100b; FIGS. 2B-1 to 2B-3 illustrate a cut-away, side view of a multi-screen drilling mud screen system 200 of FIG. 2A, showing a drilling mud screen assembly 240 with four drilling mud screens 240a; and FIG. 2C illustrates a cut-away, left-side perspective view of the multi-screen drilling mud screen system 200 of FIGS. 2A-2C, showing the drilling mud screen assembly 240 with four drilling mud screens 240a.

FIG. 8A illustrates a cut away, side view of a multi-screen drilling mud screen system 800, showing a first subassembly 8100a and a second subassembly 8100b; FIG. 8B illustrates a detail view of a first body 805a and a second body 805b of the multi-screen drilling mud screen 800 of FIG. 8A; and FIG. 8C illustrates a detail view of a first body 8208a of a first union 8202a and a second body 8208b of a second union 8202b of the multi-screen drilling mud screen system 800 of FIG. 8A.

FIG. 9A illustrates a cut away side view of a multi-screen drilling mud screen system 900, showing a reversed drilling mud screen assembly 940; and FIG. 9B illustrates a detail view of the reversed drilling mud screen assembly 940 of FIG. 9A, showing four reversed drilling mud screens 940a.

As shown in FIGS. 1A-1E, 2A-2C, 8A-8C and 9A-9B, the multi-screen drilling mud screen system 100, 200, 800, 900 comprises a first subassembly 2100a, 4350, 4355, 5235, 5245, 8100a, 9100a, a first body 105a, 205a, 805a, 905a, a drilling mud screen assembly 140, 240, 840, 940 (discussed below), a union system 1202, 2202, 8202, 9202 (discussed below), a second body 105b, 205b, 805b, 905b and a second subassembly 2100b, 4360, 4365, 5240, 5250, 8100b, 9100b. See also FIGS. 4A-4D & 5A-5E. The multi-screen drilling mud screen system 100, 200, 800, 900 has a first subassembly 2100a, 4350, 4355, 5235, 5245, 8100a, 9100a having a first end 2110a, 8110a, 9110a and a second end 2115a, 8115a, 9115a, a first drilling mud or completion fluid inlet 2120a, 8120a, 8120a, 9120a of the first subassembly 2100a, 4350, 4355, 5235, 5245, 8100a and a first drilling mud outlet 2125a, 8125a, 9125a of the first subassembly 2100a, 4350, 4355, 5235, 5245, 8100a, 9100a. See e.g., FIGS. 2A, 4A-4D, 5A-5E, 8A-8C & 9A-9B. The multi-screen drilling mud screen system 100, 200, 800, 900 has a first body 105a, 205a, 805a, 905a having a first end 110a, 210a, 810a, 910a and a second end 115a, 215a, 815a, 915a, a first drilling mud or completion fluid inlet 120a, 220a, 820a, 920a of the first body 105a, 205a, 805a, 905a and a first drilling mud or completion fluid outlet 125a, 225a, 825a, 925a of the first body 105a, 205a, 805a, 905a (and a first drilling mud screen access port 130a, 230a, 830a, 930a of the first body 105a, 205a, 805a, 905a). The multi-screen drilling mud screen system 100, 200, 800, 900 has a second body 105b, 205b, 805b, 905b having a first end 110b, 210b, 810b, 910b, a mid-portion 112b, 212b, 812b, 912b and a second end 115b, 215b, 815b, 915b, a second drilling mud or completion fluid inlet 120b, 220b, 820b, 920b of the second body 105b, 205b, 805b, 905b (and a second drilling mud screen access port 130b, 230b, 830b, 930b of the second body 105b, 205b, 805b, 905b) and a second drilling mud or completion fluid outlet 125b, 225b, 825b, 925b of the second body 105b, 205b, 805b, 905b. The multi-screen drilling mud screen system 100, 200, 800, 900 has a second subassembly 2100b, 4355, 4365, 5340, 5250, 8100b, 9100b having a first end 2110b, 8110b, 9110b and a second end 2115b, 8115b, 9115b, a second drilling mud or completion fluid inlet 2120b, 8120b, 9120b of the second subassembly 2100b, 4355, 4365, 5340, 5350, 8100b, 9100b and a second drilling mud or completion fluid outlet 2125b, 8125b, 9125b of the second subassembly 2100b, 4355, 4365, 4340, 4350, 8100b, 9100b. See e.g., FIGS. 2A, 4A-4D, 5A-5E, 8A-8C & 9A-9B.

In an embodiment, the second end 115a, 215a, 815a, 915a of the first body 105a, 205a, 805a, 905a may be modified to reduce inside surface exit angle to transition a first inner diameter 265a of the first drilling mud outlet 125a, 225a, 825a, 925a of the first body 105a, 205a, 805a, 905a to a third inner diameter 2285c of a third body 1208c, 2208c, 8208c, 9208c of a union system 1202, 2202, 8202, 9202, as discussed below. In an embodiment, the exit angle may be from about 10-degrees to about 90-degrees, and any range or value there between, with respect to the first centerline 245a, 845a, 945a of the first body 105a, 205a, 805a, 905a. In an embodiment, the exit angle may be about 40-degrees. See e.g., FIGS. 2A, 8A-8C & 9A-9B.

In an embodiment, the first end 110b, 210b, 810b of the second body 105b, 205b, 805b, 905b may be modified to reduce inside surface entry angle to transition the third inner diameter 2285c of a third body 1208c, 2208c, 8208c, 9208c of a union system 1202, 2202, 8202, 9202 to the second inner diameter 2265b of the second outlet of the second body 1208b, 2208b, 8208b, 9208b of the union system 1202, 2202, 8202, 9202 and/or a second inner diameter 265b of the second drilling mud or completion fluid inlet 120b, 220b, 820b, 920b of the second body 105b, 205b, 805b, 905b, as discussed below. In an embodiment, the entry angle may be from about 10-degrees to about 90-degrees, and any range or value there between, with respect to the second centerline 245b, 845b, 945b of the second body 105b, 205b, 805b, 905b. In an embodiment, the entry angle may be about 30-degrees. See e.g., FIGS. 2A, 8A-8C & 9A-9B.

In an embodiment, the mid-portion 112b, 212b, 812b, 912b of the second body 105b, 205b, 805b, 905b may be modified to reduce inside surface entry angle to transition the third inner diameter 2285c of a third body 1208c, 2208c, 8208c, 9208c of a union system 1202, 2202, 8202, 9202 and/or the second inner diameter 2265b of the second outlet of the second body 1208b, 2208b, 8208b, 9208b of the union system 1202, 2202, 8202, 9202 to the to a second inner diameter 265b of the second drilling mud or completion fluid inlet 120b, 220b, 820b, 920b of the second body 105b, 205b, 805b, 905b, as discussed below. In an embodiment, the entry angle may be from about 10-degrees to about 90-degrees, and any range or value there between, with respect to the second centerline 245b, 845b, 945b of the second body 105b, 205b, 805b, 905b. In an embodiment, the entry angle may be about 10-degrees or about 15-degrees. See e.g., FIGS. 2A, 8A-8C & 9A-9B.

In an embodiment, the first drilling mud or completion fluid inlet 2120a, 8120a, 9120a of the first subassembly 2100a, 4350, 4360, 5235, 5245, 8100a, 9100a may be fluidly connected to, for example, an outlet of a drilling mud pump via a connection; and the second drilling mud or completion fluid outlet 2125b, 8125b, 9125b of the second subassembly 2100b, 4355, 4365, 5240, 5250, 8100b, 9100b may be fluidly connected to an inlet of a vibrator hose via a connection. Any suitable connection may be used for the first drilling mud or completion fluid inlet 2120a, 8120a, 9120a of the first subassembly 2100a, 4350, 4360, 5235, 5245, 8100a, 9100a and the second drilling mud or completion fluid outlet 2125b, 8125b, 9125b of the second subassembly 2100b, 4355, 4365, 5240, 5259, 8100b, 9100b. For example, suitable connections include, but are not limited to, pipe fittings and welds. Connections are well known in the art. In an embodiment, the first drilling mud or completion fluid inlet 2120a, 8120a, 9120a of the first subassembly 2100a, 4350, 4360, 5235, 5245, 8100a, 9100a may be fluidly connected to, for example, an outlet of a drilling mud pump via a weld; and the second drilling mud or completion fluid outlet 2125b, 8125b, 9125b of the second subassembly 2100b, 4355, 4365, 5240, 5250, 8100b, 9100b may be fluidly connected to an inlet of a vibrator hose via a weld.

In an embodiment, the first drilling mud or completion fluid inlet 120a, 220a, 820a, 920a of the first body 105a, 205a, 805a, 905a may be fluidly connected to the first drilling mud or completion fluid outlet 2125a, 8125a, 9125a of the first subassembly 2100a, 4350, 4360, 5235, 5345, 8100a, 9100a via a connection; and the second drilling mud or completion fluid outlet 125b, 225b, 825b, 925b of the second body 105b, 205b, 805b, 905b may be fluidly connected to the second drilling mud or completion fluid inlet 2120b, 8120b, 9120b of the second subassembly 2100b, 4355, 4365, 5240, 5250, 8100b, 9100b via a connection. Any suitable connection may be used for the first drilling mud or completion fluid inlet 120a, 220a, 820a, 920a of the first body 105a, 205a, 805a, 905a and second drilling mud or completion fluid outlet 125b, 225b, 825b, 925b of the second body 105b, 205b, 805b, 905b. For example, suitable connections include, but are not limited to, pipe fittings and other connections. In an embodiment, the first drilling mud or completion fluid inlet 120a, 220a, 820a, 920a of the first body 105a, 205a, 805a, 905a may be fluidly connected to, for example, a first drilling mud or completion fluid outlet 2125a, 8125a, 9125a of a first subassembly 2100a, 4350, 4360, 5235, 5245, 8100a, 9100a via a pipe fitting; and the second drilling mud or completion fluid outlet 125b, 225b, 825b, 925b of the second body 105b, 205b, 805b, 905b may be fluidly connected to a second drilling mud or completion fluid inlet 2120b, 8120b, 9120b of the second subassembly 2100b, 4355, 4365, 5240, 5250, 8100b, 9100b via a pipe fitting.

In an embodiment, the first drilling mud or completion fluid outlet 125a, 225a, 825a, 925a of the first body 105a, 205a, 805a, 905a may be fluidly connected to the second drilling mud or completion fluid inlet 120b, 220b, 820b, 920b of the second body 105b, 205b, 805b, 905b via a union. In an embodiment, the union may be a union system 1202, 2202, 8202, 9202. In an embodiment, the first body 105a, 205a, 805a, 905a and/or the second body 105b, 205b, 805b, 905b may be sealed with the union system 1202, 2202, 8202, 9202 via an O-ring. Any suitable O-ring may be used. For example, suitable O-rings include, but are not limited to, 300 Series O-rings. O-rings are well known in the art.

In an embodiment, the first drilling mud or completion fluid outlet 125a, 225a, 825a, 925a of the first body 105a, 205a, 805a, 905a may be fluidly connected to a first inlet 1225a, 2225a, 8225a, 9225a of a first body 1208a, 2208a, 8208a, 9208a of the union system 1202, 2202, 8202, 9202. In an embodiment, the first body 105a, 205a, 805a, 905a may be sealed with the union system 1202, 2202, 8202, 9202 via an O-ring. Any suitable O-ring may be used. For example, suitable O-rings include, but are not limited to, 300 Series O-rings. O-rings are well known in the art.

In an embodiment, a first outlet 1225a, 2225a, 8225a, 9225a of the first body 1208a, 2208a, 8208a, 9208a of the union system 1202, 2202, 8202, 9202 may be fluidly connected to a third inlet 1220c, 2220c, 8220c, 9220c of a third body 1208c, 2208c, 8208c, 9208c of the union system 1202, 2202, 8202, 9202. In an embodiment, the first body 1208a, 2208a, 8208a, 9208a of the union system 1202, 2202, 8202 may be sealed with the third body 1208c, 2208c, 8208c, 9208c of the union system 1202, 2202, 8202, 9202 via an O-ring. Any suitable O-ring may be used. For example, suitable O-rings include, but are not limited to, 300 Series O-rings. O-rings are well known in the art.

In an embodiment, the second outlet 1225b, 2225b, 8225b, 9225b of the second body 1208b, 2208b, 8208b, 9208b of the union system 1202, 2202, 8202, 9202 may be fluidly connected to the second drilling mud or completion fluid inlet 120b, 220b, 820b, 920b of the second body 105b, 205b, 805b, 905b. In an embodiment, the second body 105b, 205b, 805b may be sealed with the union system 1202, 2202, 8202, 9202 via an O-ring. Any suitable O-ring may be used. For example, suitable O-rings include, but are not limited to, 300 Series O-rings. O-rings are well known in the art.

In an embodiment, the first subassembly 2100a, 4350, 4360, 5235, 5245, 8100a, 9100a and the second subassembly 2100b, 4355, 4365, 5240, 5250, 8100b, 9100b of the drilling mud screen system 100, 200, 800, 900 may be constructed of any suitable material. For example, suitable materials include, but are not limited to, any alloy steel suitable for a drilling or completion application. In an embodiment, the first subassembly 2100a, 4350, 4360, 5235, 5245, 8100a, 9100a and the second subassembly 2100b, 4355, 4365, 5240, 5250, 8100b, 9100b may be constructed of an AISI 4140/120k yield or equivalent material. In an embodiment, the inner surface of the first subassembly 2100a, 4350, 4360, 5235, 5245, 8100a, 9100a and the inner surface of the second subassembly 2100b, 4355, 4365, 5240, 5250, 8100b, 9100b may be unpainted. In an embodiment, the outer surface of the first subassembly 2100a, 4350, 4360, 5235, 5245, 8100a, 9100a and the outer surface of the second assembly 2100b, 4355, 4365, 5240, 5250, 8100b, 9100b may be painted.

In an embodiment, the first body 105a, 205a, 805a, 905a and the second body 105b, 205b, 805b, 905b of the drilling mud screen system 100, 200, 800, 900 may be constructed of any suitable material. For example, suitable materials include, but are not limited to, any alloy steel suitable for a drilling or completion application. In an embodiment, the first body 105a, 205a, 805a, 905a and the second body 105b, 205b, 805b, 905b may be constructed of an AISI 4140/120k yield or equivalent material. In an embodiment, the inner surface of the first body 105a, 205a, 805a, 905a and the inner surface of the second body 105b, 205a, 805b, 905b may be unpainted. In an embodiment, the outer surface of the first body 105a, 205a, 805a, 905a and the outer surface of the second body 105b, 205b, 805b, 905b may be painted.

In an embodiment, the drilling mud screen system 100, 200, 800, 900 has a length 250. The length 250 may be any suitable length. In an embodiment, the length 250 may be from about 40-inches to about 120-inches, and any range or value there between. In an embodiment, the length 250 may be about 64.5-inches or about 66.5-inches.

In an embodiment, the drilling mud screen system 100, 200, 800, 900, including a first subassembly 2100a, 4350, 4360, 5235, 5245, 8100a, 9100a and a second subassembly 2100b, 4355, 4365, 5240, 5250, 8100b, 9100b, has a length 2150. The length 2150 may be any suitable length. In an embodiment, the length 2150 may be from about 50-inches to about 150-inches, and any range or value there between. In an embodiment, the length 2150 may be about 92-inches or about 93-inches.

In an embodiment, the first subassembly 2100a, 4350, 4360, 5235, 5245, 8100a, 9100a has a first centerline 2145a and a first length 2150a. In an embodiment, the first centerline 2145a extends through the center of the first drilling mud or completion fluid inlet 2120a, 8120a, 9120a of the first subassembly 2100a, 4350, 4360, 5235, 5245, 8100a, 9100a to the first drilling mud or completion fluid outlet 2125a, 8125a, 9125a of the first subassembly 2100a, 4350, 4360, 5235, 5245, 8100a, 9100a (and the first drilling mud or completion fluid inlet 220a, 820a, 920a of the first body 205a, 805a, 905a). The first length 2150a of the first subassembly 2100a, 4350, 4360, 5235, 5245, 8100a, 9100a may be any suitable length. In an embodiment, the first length 2150a of the first subassembly 2100a, 4350, 4360, 5235, 5245, 8100a, 9100a may be from about 10-inches to about 30-inches, and any range or value there between. In an embodiment, the first length 2150a of the first subassembly 2100a, 4350, 4360, 5235, 5245, 8100a, 9100a may be about 17-inches.

In an embodiment, the first drilling mud or completion fluid inlet 2120a, 8120a, 8120a of the first subassembly 2100a, 4350, 4360, 5235, 5245, 8100a, 9100a may have any suitable first inner diameter 2165a; and the first drilling mud or completion fluid inlet 2120a, 8120a, 9120a of the first subassembly 2100a, 4350, 4360, 5235, 5245, 8100a, 9100a may have any suitable first outer diameter 2170a. In an embodiment, the first inner diameter 2165a of the first drilling mud or completion fluid inlet 2120a, 8120a, 9120a may be from about 10-inches to about 25-inches, and any range or value there between. In an embodiment, the first inner diameter 2165a of the first drilling mud or completion fluid inlet 2120a, 8120a, 9102a may be about 16-inches.

In an embodiment, the first outer diameter 2170a of the first drilling mud or completion fluid inlet 2120a, 8120a, 9120a may be from about 10-inches to about 25-inches, and any range or value there between. In an embodiment, the first outer diameter 2170a of the first drilling mud or completion fluid inlet 2120a, 8120a, 9120a may be about 18-inches or about 19-inches.

In an embodiment, the first drilling mud or completion fluid outlet 2125a, 8125a, 9125a of the first subassembly 2100a, 4350, 4360, 5235, 5245, 8100a, 9100a may have any suitable first inner diameter 2167a; and the first drilling mud or completion fluid outlet 2125a, 8125a, 9125a of the first subassembly 2100a, 4350, 4360, 5235, 5245, 8100a, 9100a may have any suitable first outer diameter 2172a. In an embodiment, the first inner diameter 2167a of the first drilling mud or completion fluid outlet 2125a, 8125a, 9125a may be from about 10-inches to about 25-inches, and any range or value there between. In an embodiment, the first inner diameter 2167a of the first drilling mud or completion fluid outlet 2125a, 8125a, 9125a may be about 16-inches or about 17-inches.

In an embodiment, the first outer diameter 2172a of the first drilling mud or completion fluid outlet 2125a, 8125a, 9125a may be from about 10-inches to about 30-inches, and any range or value there between. In an embodiment, the first outer diameter 2172a of the first drilling mud or completion fluid outlet 2125a, 8125a, 9125a may be about 20-inches.

In an embodiment, the second subassembly 2100b, 4355, 4365, 5240, 5250, 8100b, 9100b has a second centerline 2145b and a second length 2150b. In an embodiment, the second centerline 2145b extends through the center of the second drilling mud or completion fluid inlet 2120b, 8120b, 9120b of the second subassembly 2100b, 4355, 4365, 5240, 5250, 8100b, 9100b (and the second drilling mud or completion fluid outlet 225b, 825b, 925b of the second body 205b, 805b, 905b) to the second drilling mud or completion fluid outlet 2120b, 8120b, 9120b of the second subassembly 2100b, 4355, 4365, 5240, 5250, 8100b, 9100b. The second length 2150b of the second subassembly 2100b, 4355, 4365, 5240, 5250, 8100b, 9100b may be any suitable length. In an embodiment, the second length 2150b of the second subassembly 2100b, 4355, 4365, 5240, 5250, 8100b, 9100b may be from about 10-inches to about 30-inches, and any range or value there between. In an embodiment, the second length 2150b of the second subassembly 2100b, 4355, 4365, 5240, 5250, 8100b, 9100b may be about 17-inches.

In an embodiment, the second drilling mud or completion fluid inlet 2120b, 8120b, 9120b of the second subassembly 2100b, 4355, 4365, 5240, 5250, 8100b, 9100b may have any suitable second inner diameter 2165b; and the second drilling mud or completion fluid inlet 2120b, 8120b, 9120b of the second subassembly 2100b, 4355, 4365, 5240, 5250, 8100b, 9100b may have any suitable second outer diameter 2170b. In an embodiment, the second inner diameter 2165b of the second drilling mud or completion fluid inlet 2120b, 8120b, 9120b may be from about 10-inches to about 25-inches, and any range or value there between. In an embodiment, the second inner diameter 2165b of the second drilling mud or completion fluid inlet 2120b, 8120b, 9102b may be about 16-inches.

In an embodiment, the second outer diameter 2170b of the second drilling mud or completion fluid inlet 2120b, 8120b, 9120b may be from about 10-inches to about 25-inches, and any range or value there between. In an embodiment, the second outer diameter 2170b of the second drilling mud or completion fluid inlet 2120b, 8120b, 9120b may be about 18-inches or about 19-inches.

In an embodiment, the second drilling mud or completion fluid outlet 2125b, 8125b, 9125b of the second subassembly 2100b, 4355, 4365, 5240, 5250, 8100b, 9100b may have any suitable second inner diameter 2167b; and the second drilling mud or completion fluid outlet 2125b, 8125b, 9125b of the second subassembly 2100b, 4355, 4365, 5240, 5250, 8100b, 9100b may have any suitable second outer diameter 2172b. In an embodiment, the second inner diameter 2167b of the second drilling mud or completion fluid outlet 2125b, 8125b, 9251b may be from about 5-inches to about 20-inches, and any range or value there between. In an embodiment, the second inner diameter 2167b of the second drilling mud or completion fluid outlet 2125b, 8125b, 9125b may be about 11-inches or 12-inches.

In an embodiment, the second outer diameter 2172b of the second drilling mud or completion fluid outlet 2125b, 8125b, 9125b may be from about 10-inches to about 30-inches, and any range or value there between. In an embodiment, the second outer diameter 2172b of the second drilling mud or completion fluid outlet 2125b, 8125b, 9125b may be about 20-inches.

In an embodiment, the first body 105a, 205a, 805a, 905a has a first centerline 245a, 845a, 945a and a first length 250a. In an embodiment, the first centerline 245a, 845a, 945a extends through the center of the first drilling mud or completion fluid inlet 120a, 220a, 820a, 920a to the first drilling mud or completion fluid outlet 125a, 225a, 825a, 925a (and the first drilling mud screen access port 130a, 230a, 830a, 930a). The first length 250a of the first body 105a, 205a, 805a, 905a may be any suitable length. In an embodiment, the first length 250a of the first body 105a, 205a, 805a, 905a may be from about 10-inches to about 25-inches, and any range or value there between. In an embodiment, the first length 250a may be about 16-inches or 17-inches.

In an embodiment, the first drilling mud or completion fluid inlet 120a, 220a, 820a, 920a may have any suitable first inner diameter 265a; and the first drilling mud or completion fluid inlet 120a, 220a, 820a, 920a may have any suitable first outer diameter 270a. In an embodiment, the first inner diameter 265a of the first drilling mud or completion fluid inlet 120a, 220a, 820a, 920a may be from about 10-inches to about 25-inches, and any range or value there between. In an embodiment, the first inner diameter 265a of the first drilling mud or completion fluid inlet 120a, 220a, 820a, 920a may be about 16-inches or about 17-inches.

In an embodiment, the first outer diameter 270a of the first drilling mud or completion fluid inlet 120a, 220a, 820a, 920a may be from about 10-inches to about 25-inches, and any range or value there between. In an embodiment, the first outer diameter 270a of the first drilling mud or completion fluid inlet 120a, 220a, 820a, 920a may be about 18-inches or about 19-inches.

In an embodiment, the first drilling mud or completion fluid outlet 125a, 225a, 825a, 925a may have any suitable first inner diameter 265a; and the first drilling mud or completion fluid outlet 125a, 225a, 825a, 925a may have any suitable first outer diameter 270a. In an embodiment, the first inner diameter 265a of the first drilling mud or completion fluid outlet 125a, 225a, 825a, 925a may be from about 10-inches to about 25-inches, and any range or value there between. In an embodiment, the first inner diameter 265a of the first drilling mud or completion fluid outlet 125a, 225a, 825a, 925a may be about 16-inches or about 17-inches.

In an embodiment, the first outer diameter 270a of the first drilling mud or completion fluid outlet 125a, 225a, 825a, 925a may be from about 10-inches to about 25-inches, and any range or value there between. In an embodiment, the first outer diameter 270a of the first drilling mud or completion fluid outlet 125a, 225a, 825a, 925a may be about 18-inches or about 19-inches.

In an embodiment, the second body 105b, 205b, 805b, 905b has a second centerline 245b, 845b, 945b and a second length 250b. In an embodiment, the second centerline 245b, 845b, 945b extends through the center of the second drilling mud screen access port 130b, 230b, 830b, 930b (and the second drilling mud or completion fluid inlet 120b, 220b, 820b, 920b) to the second drilling mud or completion fluid outlet 125b, 225b, 825b, 925b. The second length 250b of the second body 105b, 205b, 805b, 905b may be any suitable length. In an embodiment, the second length 250b of the second body 105b, 205b, 805b, 905b may be from about 10-inches to about 30-inches, and any range or value there between. In an embodiment, the second length 250b may be about 19-inches or about 20-inches.

In an embodiment, the second drilling mud or completion fluid inlet 120b, 220b, 820b, 920b may have any suitable second inner diameter 265b; and the second drilling mud or completion fluid inlet 120b, 220b, 820b, 920b may have any suitable second outer diameter 270b. In an embodiment, the second inner diameter 265b of the second drilling mud or completion fluid inlet 120b, 220b, 820b, 920b may be from about 10-inches to about 25-inches, and any range or value there between. In an embodiment, the second inner diameter 265b of the second drilling mud or completion fluid inlet 120b, 220b, 820b, 920b may be about 16-inches or about 17-inches.

In an embodiment, the second outer diameter 270b of the second drilling mud or completion fluid inlet 120b, 220b, 820b, 920b may be from about 10-inches to about 25-inches, and any range or value there between. In an embodiment, the second outer diameter 270b of the second drilling mud or completion fluid inlet 120b, 220b, 820b, 920b may be about 18-inches or about 19-inches.

In an embodiment, the second drilling mud outlet 125b, 225b, 825b, 925b may have any suitable second inner diameter 265b; and the second drilling mud outlet 125b, 225b, 825b, 925b may have any suitable second outer diameter 270b. In an embodiment, the second inner diameter 265b of the second drilling mud outlet 125b, 225b, 825b, 925b may be from about 10-inches to about 25-inches, and any range or value there between. In an embodiment, the second inner diameter 265b of the second drilling mud outlet 125b, 225b, 825b, 925b may be about 16-inches or about 17-inches.

In an embodiment, the second outer diameter 270b of the second drilling mud or completion fluid outlet 125b, 225b, 825b, 925b may be from about 10-inches to about 25-inches, and any range or value there between. In an embodiment, the second outer diameter 270b of the second drilling mud or completion fluid outlet 125b, 225b, 825b, 925b may be about 18-inches or about 19-inches.

Union System

The multi-screen drilling mud screen system 100, 200, 800, 900 has a union system 1202, 2202, 8202, 9202. The union system 1202, 2202, 8202, 9202 has a first body 1208a, 1208a, 8208a, 9208a of the union system 1202, 1202, 8202, 9202 having a first end 1212a, 2212a, 8212a, 9212a and a second end 1215a, 2215a, 8215a, 9215a, a second body 1208b, 2208b, 8208b, 9208b of the union system 1202, 2202, 8202, 9202 having a first end 1212b, 2212b, 8212b, 9212b and a second end 1215b, 2215b, 8215b, 9215b, and a third body 1208c, 2208c, 8208c, 9208c of the union system 1202, 2202, 8202, 9202 having a first end 1212c, 2212c, 8212c, 9212c and a second end 1215c, 2215c, 8215c, 9215c. See e.g., FIGS. 1A-1C, 2A-2C, 8A-8C & 9A-9B.

In an embodiment, the second end 115a, 215a, 815a, 915a of the first body 105a, 205a, 805a, 905a may be disposed through the first end 1212c, 2212c, 8212c, 9212c of the third body 1208c, 2208c, 8208c, 9208c of the union system 1202, 2202, 8202, 9202 such that the second end 1215a, 2215a, 8215a, 9215a of the first body 1208a, 2208a, 8208a, 9208a of the union system 1202, 2202, 8202, 9202 is disposed between the second end 115a, 215a, 815a, 915a of the first body 105a, 205a, 805a, 905a and the first end 1212c, 2212c, 8212c, 9212c of the third body 1208c, 2208c, 8208c, 9208c of the union system 1202, 2202, 8202, 9202. See e.g., FIGS. 1A-1C, 2A-2C, 8A-8C & 9A-9B.

In an embodiment, the union system 1202, 2202, 8202, 9202 may have a first union 1202a, 2202a, 8202a, 9202a and a second union 1202b, 2202b, 8202b, 9202b.

In an embodiment, the first union 1202a, 2202a, 8202a, 9202a may comprise the first body 1208a, 2208a, 8208a, 9208a of the union system 1202, 2202, 8202, 9202 and a portion of the first end 1212c, 2212c, 8212c, 9212c of the third body 1208c, 2208c, 8208c, 9208c of the union system 1202, 2202, 8202, 9202.

In an embodiment, the second union 1202b, 2202b, 8202b, 9202b may comprise the second body 1208b, 2208b, 8208b, 9208b of the union system 1202, 2202, 8202, 9202 and a portion of the second end 1215c, 2215c, 8215c, 9215c of the third body 1208c, 2208c, 8208c, 9208c of the union system 1202, 2202, 8202, 9202.

In an embodiment, the second end 115a, 215a, 815a, 915a of the first body 105a, 205a, 805a, 905a and the first end 1212a, 2212a, 8212a, 9212a and/or the second end 1215a, 2215a, 8215a, 9215a of the first body 1208a, 2208a, 8208a, 9208a of the union system 1202, 2202, 8202, 9202 may be sealed via an O-ring. Any suitable O-ring may be used. For example, suitable O-rings include, but are not limited to, 300 Series O-rings. O-rings are well known in the art.

In an embodiment, the first end 110b, 210b, 810b, 910b of the second body 105b, 205b, 805b, 905b may be disposed through the second end 1215c, 2215c, 8215c, 9215c of the third body 1208c, 2208c, 8208c, 9208c of the union system 1202, 2202, 8202, 9202 such that the first end 1212b, 2212b, 8212b, 9212b of the second body 1208b, 2208b, 8208b, 9208b of the union system 1202, 2202, 8202, 9202 is disposed between the second end 1215c, 2215c, 8215c, 9215c of the third body 1208c, 2208c, 8208c, 9208c of the union system 1202, 2202, 8202, 9202 and the first end 110b, 210b, 810b, 910b of the second body 105b, 205b, 805b, 905b. See e.g., FIGS. 1A-1C, 2A-2C, 8A-8C & 9A-9B.

In an embodiment, the first end 110b, 210b, 810b, 910b of the second body 105b, 205b, 805b, 905b and the first end 1212b, 2212b, 8212b, 9212b and/or the second end 1215b, 2215b, 8215b, 9215b of the second body 1208b, 2208b, 8208b, 9208b of the union system 1202, 2202, 8202, 9202 may be sealed via an O-ring. Any suitable O-ring may be used. For example, suitable O-rings include, but are not limited to, 300 Series O-rings. O-rings are well known in the art.

In an embodiment, the second end 1215a, 2215a, 8215a, 9215a of the first body 1208a, 2208a, 8208a, 9208a of the union system 1202, 2202, 8202, 9202 (and the second end 115a, 215a, 815a, 915a of the first body 105a, 205a, 805a, 905a) and the first end 1212c, 2212c, 8212c, 9212c of the third body 1208c, 2208c, 8208c, 9208c of the union system 1202, 2202, 8202, 9202 may be attached by a connection. Any suitable connection may be used for the second end 1215a, 2215a, 8215a, 9215a of the first body 1208a, 2208a, 8208a, 9208a of the union system 1202, 2202, 8202, 9202 (and the second end 115a, 215a, 815a, 915a of the first body 105a, 205a, 805a, 905a) and the first end 1212c, 2212c, 8212c, 9212c of the third body 1208c, 2208c, 8208c, 9208c of the union system 1202, 2202, 8202, 9202. For example, suitable connections include, but are not limited to, pipe fittings and threads. Connections are well known in the art. In an embodiment, the first end 1212c, 2212c, 8212c, 9212c of the third body 1208c, 2208c, 8208c, 9208c of the union system 1202, 2202, 8202, 9202 may be threaded into the second end 1215a, 2215a, 8215a, 9215a of the first body 1208a, 2208a, 8208a, 9208a of the union system 1202, 2202, 8202, 9202. In an embodiment, the second end 1215a, 2215a, 8215a, 9215a of the first body 1208a, 2208a, 8208a, 9208a of the union system 1202, 2202, 8202, 9202 may be threaded into the first end 1212c, 2212c, 8212c, 9212c of the third body 1208c, 2208c, 8208c, 9208c of the union system 1202, 2202, 8202, 9202.

In an embodiment, the second end 1215a, 2215a, 8215a, 9215a of the first body 1208a, 2208a, 8208a, 9208a of the union system 1202, 2202, 8202, 9202 (and the second end 115a, 215a, 815a, 915a of the first body 105a, 205a, 805a, 905a) and the first end 1212c, 2212c, 8212c, 9212c of the third body 1208c, 2208c, 8208c, 9208c of the union system 1202, 2202, 8202, 9202 may be attached by a first shoulder connection 8305a. See e.g., 1A-1C, 2A-2C, 8A-8C & 9A-9B.

In an embodiment, the first shoulder connection 8305a, 9305a comprises a first box shoulder 8310a (on the first body 105a, 205a, 805a, 905a and/or the third body 1208c, 2208c, 8208c, 9208c of the union system 1202, 2202, 8202, 9202) and a first pin shoulder 8320a (on the second end 1215a, 2215a, 8215a, 9215a of the first body 1208a, 2208a, 8208a, 9208a of the union system 1202, 2202, 8202, 9202). See e.g., 1A-1C, 2A-2C, 8A-8C & 9A-9B.

In an embodiment, the first shoulder connection 8305a, 9305a comprises a first box shoulder 8310a at a first box angle 8315a with respect to a first perpendicular 8330a to the first centerline 845a of the first body 805a at a first end point 8335a of the first body 805a, 905a; and a first pin shoulder 8320a at a first pin angle 858 with respect to the first perpendicular 8340a to the first centerline 845a, 945a of the first body 805a, 905a at a first end point 8345a of the first body 8208a, 9208a of the union system 8202, 9202. See also FIGS. 2A & 8A (showing box and pin made-up).

In an embodiment, the first box shoulder 8310a may be any suitable profile. For example, suitable profiles include, but are not limited to, angled profiles. In an embodiment, the first box shoulder 8310a may be an angled profile defined by a first box angle 8315a.

In an embodiment, the first box angle 8310a may be from about 0 degrees to about 30 degrees, and any range or value there between. In an embodiment, the first box angle 8310a may be from about 0 degrees to about 20 degrees. See e.g., FIGS. 2A & 8A-8C.

In an embodiment, the first box angle 8310a may be about 0 degrees. See e.g., FIG. 2A.

In an embodiment, the first box angle 8310 may be about 15 degrees. See e.g., FIGS. 8A-8C.

In an embodiment, the first pin shoulder 8320a may be any suitable profile. For example, suitable profiles include, but are not limited to, angled profiles. In an embodiment, the first pin shoulder 8320a may be an angled profile defined by a first pin angle 8325a.

In an embodiment, the first pin angle 8325a may be from about 0 degrees to about 30 degrees, and any range or value there between. In an embodiment, the first pin angle 8325a may be from about 0 degrees to about 20 degrees. See e.g., FIGS. 2A & 8A-8C.

In an embodiment, the first pin angle 8325a may be about 0 degrees. See e.g., FIG. 2A.

In an embodiment, the first pin angle 8325a may be about 15 degrees. See e.g., FIGS. 8A-8C.

In an embodiment, the second end 1215a, 2215a, 8125a, 9125a of the first body 1208a, 2208a, 8208a, 9208a of the union system 1202, 2202, 8202, 9202 and the first end 1212c, 2212c, 8212c, 9212c of the third body 1208c, 2208c, 8208c, 9208c of the union system 1202, 2202, 8202, 9202 may be sealed via an O-ring. Any suitable O-ring may be used. For example, suitable O-rings include, but are not limited to, 300 Series O-rings. O-rings are well known in the art.

In an embodiment, the second end 1215c, 2215c, 8215c, 9215c of the third body 1208c, 2208c, 8208c, 9208c of the union system 1202, 2202, 8202, 9202 (and the first end 110b, 210b, 810b, 910b of the second body 105, 205b, 805b, 905b) and the first end 1212b, 2212b, 8212b, 9212b of the second body 1208b, 2208b, 8208b, 9208b of the union system 1202, 2202, 8202, 9202 may be attached by a connection. Any suitable connection may be used for the second end 1215c, 2215c, 8215c, 9215c of the third body 1208c, 2208c, 8208c, 9208c of the union system 1202, 2202, 8202, 9202 (and the first end 110b, 210b, 810b, 910b of the second body 105b, 205b, 805b, 905b) and the first end 1212b, 2212b, 8212b, 9212b of the second body 1208b, 2208b, 8208b, 9208b of the union system 1202, 2202, 8202, 9202. For example, suitable connections include, but are not limited to, pipe fittings and threads. Connections are well known in the art. In an embodiment, the first end 1212b, 2212b, 8212b, 9212b of the second body 1208b, 2208b, 8208b, 9208b of the union system 1202, 2202, 8202, 9202 may be threaded into the second end 1215c, 2215c, 8215c, 9215c of the third body 1208c, 2208c, 8208c, 9208c of the union system 1202, 2202, 8202, 9202. In an embodiment, the second end 1215c, 2215c, 8215c, 9215c of the third body 1208c, 2208c, 8208c, 9208c of the union system 1202, 2202, 8202, 9202 may be threaded into the first end 1212b, 2212b, 8212b, 9212b of the second body 1208b, 2208b, 8208b, 9208b of the union system 1202, 2202, 8202, 9202.

In an embodiment, the second end 1215c, 2215c, 8215c, 9215c of the third body 1208c, 2208c, 8208c, 9208c of the union system 1202, 2202, 8202, 9202 (and the first end 110b, 210b, 810b, 910b of the second body 105b, 205b, 805b, 905b) and the first end 1212b, 2212b, 8212b, 9212b of the second body 1208b, 2208b, 8208b, 9208b of the union system 1202, 2202, 8202, 9202 may be attached by a second shoulder connection 8305b, 9305b. See e.g., 1A-1C, 2A-2C, 8A-8C & 9A-9B.

In an embodiment, the second shoulder connection 8305b, 9305b comprises a second box shoulder 8310b (on the second body 105b, 205b, 805b, 905b and/or the third body 1208, 1208c, 8208c, 9208c of the union system 1202, 2202, 8202, 9202) and a second pin shoulder 8320b (on first end 1212b, 2212b, 8212b, 9212b of the second body 1208b, 2208b, 8208b, 9208b of the union system 1202, 2202, 8202, 9202). See e.g., 1A-1C, 2A-2C, 8A-8C & 9A-9B.

In an embodiment, the second shoulder connection 8305b, 9305b comprises a second box shoulder 8310b at a second box angle 8315b with respect to a second perpendicular 8330b to the second centerline 845b, 945b of the second body 805b, 905b at a second end point 8335b of the second body 805b, 905b; and a second pin shoulder 8320b at a second pin angle 8325b with respect to the second perpendicular 8340b to the second centerline 845b, 945b of the second body 805b, 905b at the second end point 8345b of the second body 8208b, 9208b of the union system 8202, 9202. See also FIGS. 2A & 8A (showing box and pin made-up).

In an embodiment, the second box shoulder 8310b may be any suitable profile. For example, suitable profiles include, but are not limited to, angled profiles. In an embodiment, the second box shoulder 8310b may be an angled profile defined by a second box angle 8315b.

In an embodiment, the second box angle 8315b may be from about 0 degrees to about 30 degrees, and any range or value there between. In an embodiment, the second box angle 8315b may be from about 0 degrees to about 20 degrees. See e.g., FIGS. 2A & 8A-8C.

In an embodiment, the second box angle 8315b may be about 0 degrees. See e.g., FIG. 2A.

In an embodiment, the second box angle 8315b may be about 15 degrees. See e.g., FIGS. 8A-8C.

In an embodiment, the second pin shoulder 8320b may be any suitable profile. For example, suitable profiles include, but are not limited to, angled profiles. In an embodiment, the second pin shoulder 8320b may be an angled profile defined by a second pin angle 8325b.

In an embodiment, the second pin angle 8325b may be from about 0 degrees to about 30 degrees, and any range or value there between. In an embodiment, the second pin angle 8325b may be from about 0 degrees to about 20 degrees. See e.g., FIGS. 2A & 8A-8C.

In an embodiment, the second pin angle 8325b may be about 0 degrees. See e.g., FIG. 2A.

In an embodiment, the second pin angle 8325b may be about 15 degrees. See e.g., FIGS. 8A-8C.

In an embodiment, the second end 1215c, 2215c, 8215c, 9215c of the third body 1208c, 2208c, 8208c, 9208c of the union system 1202, 2202, 8202, 9202 and the first end 1212b, 2212b, 8212b, 9212b of the second body 1208b, 2208b, 8208b, 9208b of the union system 1202, 2202, 8202, 9202 may be sealed via an O-ring. Any suitable O-ring may be used. For example, suitable O-rings include, but are not limited to, 300 Series O-rings. O-rings are well known in the art.

In an embodiment, the first body 1208a, 2208a, 8208a, 9208a, the second body 1208b, 2208b, 8208b, 9208b, and the third body 1208c, 2208c, 8208c, 9208c of the union system 1202, 2202, 8202, 9202 may be constructed of any suitable material. For example, suitable materials include, but are not limited to, any alloy steel suitable for a drilling or completion application. In an embodiment, the first body 1208a, 2208a, 8208a, 9208a, the second body 1208b, 2208b, 8208b, 9208b, and the third body 1208c, 2208c, 8208c, 9208c may be constructed of an AISI 4140/120k yield or equivalent material. In an embodiment, the inner surface of the first body 1208a, 2208a, 8208a, 9208a, the second body 1208b, 2208b, 8208b, 9208b, and the third body 1208c, 2208c, 8208c, 9208c may be unpainted. In an embodiment, the outer surface of the first body 1208a, 2208a, 8208a, 9208a, the second body 1208b, 2208b, 8208b, 9208b, and the third body 1208c, 2208c, 8208c, 9208c may be painted.

In an embodiment, the union system 1202, 2202, 8202, 9202 has a length 2250. The length 2250 may be any suitable length. In an embodiment, the length 2250 may be from about 20-inches to about 60-inches, and any range or value there between. In an embodiment, the length 2250 may be about 43-inches or about 45-inches.

In an embodiment, the first body 1208a, 2208a, 8208a, 9208a has a first centerline 2245a and a first length 2250a. In an embodiment, the first centerline 2245a extends through the center of the first inlet 1220a, 2220a, 8220a, 9220a to the first outlet 1225a, 2225a, 8225a, 9225a. The first length 2250a of the first body 1208a, 2208a, 8208a, 9208a may be any suitable length. In an embodiment, the first length 2250a of the first body 1208a, 2208a, 8208a, 9208a may be from about 4-inches to about 8-inches, and any range or value there between. In an embodiment, the first length 2250a may be about 5-inches or about 6-inches.

In an embodiment, the first inlet 1220a, 2220a, 8220a, 9220a of the first body 1208a, 2208a, 8208a, 9208a may have any suitable first inner diameter 2265a; and the first inlet 1220a, 2220a, 8220a, 9220a of the first body 1208a, 2208a, 8208a, 9208a may have any suitable first outer diameter 2270a. In an embodiment, the first inner diameter 2265a of the first inlet 1220a, 2220a, 8220a, 9220a may be from about 10-inches to about 25-inches, and any range or value there between. In an embodiment, the first inner diameter 2265a of the first inlet 1220a, 2220a, 8220a, 9220a may be about 16-inches or about 17-inches.

In an embodiment, the first outer diameter 2270a of the first inlet 1220a, 2220a, 8220a, 9220a may be from about 10-inches to about 30-inches, and any range or value there between. In an embodiment, the first outer diameter 2270a of the first inlet 1220a, 2220a, 8220a, 9220a may be about 21-inches or about 22-inches.

In an embodiment, the first body 1208a, 2208a, 8208a, 9208a may have any suitable first inner diameter 2285a; and the first body 1208a, 2208a, 8208a, 9208a may have any suitable first outer diameter 2290a. In an embodiment, the first inner diameter 2270a of the first body 1208a, 2208a, 8208a, 9208a may be from about 10-inches to about 25-inches, and any range or value there between. In an embodiment, the first inner diameter 2270a of the first body 1208a, 2208a, 8208a, 9208a may be about 18-inches or about 19-inches.

In an embodiment, the first outer diameter 2290a of the first body 1208a, 2208a, 8208a, 9208a may be from about 10-inches to about 30-inches, and any range or value there between. In an embodiment, the first outer diameter 2290a of the first body 1208a, 2208a, 8208a, 9208a may be about 21-inches or about 22-inches.

In an embodiment, the first outlet 1225a, 2225a, 8225a, 9225a of the first body 1208a, 2208a, 8208a, 9208a may have any suitable first inner diameter 2300a; and the first outlet 1225a, 2225a, 8225a, 9225a of the first body 1208a, 2208a, 8208a, 9208a may have any suitable first outer diameter 2295a. In an embodiment, the first inner diameter 2300a of the first outlet 1225a, 2225a, 8225a, 9225a may be from about 10-inches to about 30-inches (e.g., outer diameter of first body 105a, 205a, 805a, 905a), and any range or value there between. In an embodiment, the first inner diameter 2300a of the first outlet 1225a, 2225a, 8225a, 9225a may be about 20-inches or about 21-inches.

In an embodiment, the second body 1208b, 2208b, 8208b, 9208b has a second centerline 2245b and a second length 2250b. In an embodiment, the second centerline 2245b extends through the center of the second inlet 1220b, 2220b, 8220b, 9220b to the second outlet 1225b, 2225b, 8225b, 9225b. The second length 2250b of the second body 1208b, 2208b, 8208b, 9208b may be any suitable length. In an embodiment, the second length 2250b of the second body 1208b, 2208b, 8208b, 9208b may be from about 4-inches to about 8-inches, and any range or value there between. In an embodiment, the second length 2250b may be about 5-inches or about 6-inches.

In an embodiment, the second inlet 1220b, 2220b, 8220b, 9220b of the second body 1208b, 2208b, 8208b, 9208b may have any suitable second inner diameter 2300b; and the second inlet 1220b, 2220b, 8220b, 9220b of the second body 1208b, 2208b, 8208b, 9208b may have any suitable second outer diameter 2295b. In an embodiment, the second inner diameter 2300b of the second inlet 1220b, 2220b, 8220b, 9220b may be from about 10-inches to about 30-inches (e.g., outer diameter of second body 105b, 205b, 805b, 905b), and any range or value there between. In an embodiment, the second inner diameter 2300b of the second inlet 1220b, 2220b, 8220b, 9220b may be about 20-inches or about 21-inches.

In an embodiment, the second body 1208b, 2208b, 8208b, 9208b may have any suitable second inner diameter 2285b; and the second body 1208b, 2208b, 8208b, 9208b may have any suitable second outer diameter 2290b. In an embodiment, the second inner diameter 2285b of the second body 1208b, 2208b, 8208b, 9208b may be from about 10-inches to about 25-inches, and any range or value there between. In an embodiment, the second inner diameter 2285b of the second body 1108b, 2108b, 8208b, 9208b may be about 18-inches or about 19-inches.

In an embodiment, the second outer diameter 2290b of the second body 1208b, 2208b, 8208b, 9208b may be from about 10-inches to about 30-inches, and any range or value there between. In an embodiment, the second outer diameter 2290b of the second body 1208b, 2208b, 8208b, 9208b may be about 21-inches or about 22-inches.

In an embodiment, the second outlet 1225b, 2225b, 8225b, 9225b of the second body 1208b, 2208b, 8208b, 9208b may have any suitable second inner diameter 2265b; and the second outlet 1225b, 2225b, 8225b, 9225b of the second body 1208b, 2208b, 8208b, 9208b may have any suitable second outer diameter 2270b. In an embodiment, the second inner diameter 2265b of the second outlet 1225b, 2225b, 8225b, 9225b may be from about 10-inches to about 25-inches, and any range or value there between. In an embodiment, the second inner diameter 2265b of the second outlet 1225b, 2225b, 8225b, 9225b may be about 17-inches or about 18-inches.

In an embodiment, the second outer diameter 2270b of the second outlet 1225b, 2225b, 8225b, 9225b may be from about 10-inches to about 30-inches, and any range or value there between. In an embodiment, the second outer diameter 2270b of the second outlet 1225b, 2225b, 8225b, 9225b may be about 21-inches or 22-inches.

In an embodiment, the third body 1208c, 2208c, 8208c, 9208c has a third centerline 2245c and a third length 2250c. In an embodiment, the third centerline 2245c extends through the center of the third inlet 1220c, 2220c, 8220c, 9220c to the third outlet 1225c, 2225c, 8225c, 9225c. The third length 2250c of the third body 1208c, 2208c, 8208c, 9208c may be any suitable length. In an embodiment, the third length 2250c of the third body 1208c, 2208c, 8208c, 9208c may be from about 20-inches to about 60-inches, and any range or value there between. In an embodiment, the third length 2250c may be about 41-inches or about 42-inches.

In an embodiment, the third inlet 1220c, 2220c, 8220c, 9220c of the third body 1208c, 2208c, 8208c, 9208c may have any suitable third inner diameter 2300c; and the third inlet 1220c, 2220c, 8220c, 9220c of the third body 1208c, 2208c, 8208c, 9208c may have any suitable third outer diameter 2295c. In an embodiment, the third inner diameter 2300c of the third inlet 1220c, 2220c, 8220c, 9220c may be from about 10-inches to about 30-inches, and any range or value there between. In an embodiment, the third inner diameter 2300c of the third inlet 1220c, 2220c, 8220c, 9220c may be about 20-inches or about 21-inches.

In an embodiment, the third body 1208c, 2208c, 8208c, 9208c may have any suitable third inner diameter 2285c; and the third body 1208c, 2208c, 8208c, 9208c may have any suitable third outer diameter 2290c. In an embodiment, the third inner diameter 2285c of the third body 1208c, 2208c, 8208c, 9208c may be from about 10-inches to about 30-inches, and any range or value there between. In an embodiment, the third inner diameter 2285c of the third body 1208c, 2208c, 8208c, 9208c may be about 20-inches or about 21-inches.

In an embodiment, the third outer diameter 2290c of the third body 1208c, 2208c, 8208c, 9208c may be from about 15-inches to about 35-inches, and any range or value there between. In an embodiment, the third outer diameter 2290c of the third body 1208c, 2208c, 8208c, 9208c may be about 25-inches.

In an embodiment, the third outlet 1225c, 2225c, 8225c, 9225c of the third body 1208c, 2208c, 8208c, 9208c may have any suitable third inner diameter 2265c; and the third outlet 1225c, 2225c, 8225c, 9225c of the third body 1208c, 2208c, 8208c, 9208c may have any suitable third outer diameter 2270c. In an embodiment, the third inner diameter 2265c of the third outlet 1225c, 2225c, 8225c, 9225c may be from about 10-inches to about 30-inches, and any range or value there between. In an embodiment, the third inner diameter 2265c of the third outlet 1225c, 2225c, 8225c, 9225c may be about 20-inches or about 21-inches.

In an embodiment, the third outer diameter 2270c of the third outlet 1225c, 2225c, 8225c, 9225c may be from about 15-inches to about 35-inches, and any range or value there between. In an embodiment, the third outer diameter 2270c of the third outlet 1225c, 2225c, 8225c, 9225c may be about 25-inches.

Optional Skid

In an embodiment, the multi-screen drilling mud screen system 100, 200, 800, 900 may be mounted on a skid. The skid may have a first support, a second support, a third support and a base.

In an embodiment, an upper end of the first support may be mechanically coupled to a lower surface of the first subassembly 2100a, 4350, 4360, 5235, 5245, 8100a, 9100a via a connection and/or a coupling; and the lower end of the first support may be mechanically coupled to an upper surface of the base via a connection and/or a coupling.

In an embodiment, the first support may be stationary when the third support is pivotable and/or rotatable, raisable and/or lowerable, and any combination thereof.

In an embodiment, the first support may be pivotable and/or rotatable. In an embodiment, an upper end of the first support may be pivotable and/or rotatable. In an embodiment, a lower end of the first support may be rotatable.

In an embodiment, the first support may be raisable and/or lowerable. In an embodiment, an upper end of the first support may be raisable and/or lowerable. In an embodiment, a lower end of the first support may be raisable and/or lowerable.

Any suitable connection may be used for the first support. For example, suitable connections include, but are not limited to, bands, clamps, fittings and welds.

In an embodiment, an upper end of the first support may be attached to an outer surface of the first subassembly 2100a, 4350, 4360, 5235, 5245, 8100a, 9100a by a connection. For example, suitable connections include, but are not limited to, bands, clamps, fittings and welds. In an embodiment, an upper end of the first support may be attached to an outer surface of the first subassembly 2100a, 4350, 4360, 5235, 5245, 8100a, 9100a by a band or a clamp.

In an embodiment, the lower end of the first support may be attached to the upper surface of the skid (e.g., base) by a connection. For example, suitable connections include, but are not limited to, bands, clamps, fittings and welds. In an embodiment, the lower end of the first support may be attached to the upper surface of the skid (e.g., base) by a connection. In an embodiment, the lower end of the first support may be attached to the upper surface of the skid (e.g., base) by fittings or welds.

Any suitable coupling may be used for the first support. For example, suitable couplings include, but are not limited to bearings, hinges, pivots, sockets, and combinations thereof. In an embodiment, the coupling for the first support may be a bearing. In an embodiment, the coupling for the first support may be a box channel with a pivot pin.

In an embodiment, the first support may have a coupling at or near an upper end. For example, suitable couplings include, but are not limited to bearings, hinges, pivots, sockets, and combinations thereof. In an embodiment, the first support may have a bearing or a socket at or near an upper end. In an embodiment, the first support may have a hinge or a pivot at or near an upper end.

In an embodiment, the first support may have a coupling at or near a lower end. For example, suitable couplings include, but are not limited to bearings, hinges, pivots, sockets, and combinations thereof. In an embodiment, the first support may have a bearing or a socket at or near a lower end. In an embodiment, the first support may have a hinge or a pivot at or near a lower end.

In an embodiment, the first support may pivot and/or rotate automatically and/or manually. In an embodiment, the first support may pivot and/or rotate electro-mechanically, hydraulically, mechanically (e.g., geared) or pneumatically. In an embodiment, the first support may pivot and/or rotate manually.

Any suitable extension may be used for the first support. For example, suitable extensions include, but are not limited to articulated arms, extendable pistons, telescoping pipes, and combinations thereof. In an embodiment, the extension for the first support may be an extendable piston. In an embodiment, the extension for the first support may be a telescoping pipe with a clevis pin.

In an embodiment, the first support may have an extension at or near an upper end. For example, suitable extensions include, but are not limited to articulated arms, extendable pistons, telescoping pipes, and combinations thereof. In an embodiment, the first support may have an extendable arm at or near an upper end. In an embodiment, the first support may have a telescoping pipe with a clevis pin at or near an upper end.

In an embodiment, the first support may have an extension at or near a lower end. For example, suitable extensions include, but are not limited to articulated arms, extendable pistons, telescoping pipes, and combinations thereof. In an embodiment, the first support may have an extendable piston at or near a lower end. In an embodiment, the first support may have a telescoping pipe with a clevis pin at or near a lower end.

In an embodiment, the first support may raise and/or lower automatically and/or manually. In an embodiment, the first support may raise and/or lower electro-mechanically, hydraulically, mechanically (e.g., geared) or pneumatically. In an embodiment, the first support may raise and/or lower manually.

In an embodiment, an upper end of the second stationary support may be mechanically coupled to a lower surface of the second subassembly 2100b, 4355, 4365, 5240, 5250, 8100a, 9100a; and the lower end of the second stationary support may be mechanically coupled to an upper surface of the base.

In an embodiment, the second support may be stationary when the third support is pivotable and/or rotatable, raisable and/or lowerable, and any combination thereof.

In an embodiment, the second support may be pivotable and/or rotatable. In an embodiment, an upper end of the second support may be pivotable and/or rotatable. In an embodiment, a lower end of the second support may be rotatable.

In an embodiment, the second support may be raisable and/or lowerable. In an embodiment, an upper end of the second support may be raisable and/or lowerable. In an embodiment, a lower end of the second support may be raisable and/or lowerable.

Any suitable connection may be used for the second support. For example, suitable connections include, but are not limited to, fittings and welds. Connections are well known in the art.

In an embodiment, an upper end of the second support may be attached to an outer surface of the second subassembly 2100b, 4355, 4365, 5240, 5250, 8100b, 9100b by a connection. For example, suitable connections include, but are not limited to, bands, clamps, fittings and welds. In an embodiment, an upper end of the second support may be attached to an outer surface of the second subassembly 2100b, 4355, 4365, 5240, 5250, 8100b, 9100b by a band or a clamp.

In an embodiment, the lower end of the second support may be attached to the upper surface of the skid (e.g., base) by a connection. For example, suitable connections include, but are not limited to, bands, clamps, fittings and welds. In an embodiment, the lower end of the second support may be attached to the upper surface of the skid (e.g., base) by a connection. In an embodiment, the lower end of the second support may be attached to the upper surface of the skid (e.g., base) by fittings or welds.

Any suitable coupling may be used for the second support. For example, suitable couplings include, but are not limited to bearings, hinges, pivots, sockets, and combinations thereof. In an embodiment, the coupling for the second support may be a bearing. In an embodiment, the coupling for the second support may be a box channel with a pivot pin.

In an embodiment, the second support may have a coupling at or near an upper end. For example, suitable couplings include, but are not limited to bearings, hinges, pivots, sockets, and combinations thereof. In an embodiment, the second support may have a bearing or a socket at or near an upper end. In an embodiment, the second support may have a hinge or a pivot at or near an upper end.

In an embodiment, the second support may have a coupling at or near a lower end. For example, suitable couplings include, but are not limited to bearings, hinges, pivots, sockets, and combinations thereof. In an embodiment, the second support may have a bearing or a socket at or near a lower end. In an embodiment, the second support may have a hinge or a pivot at or near a lower end.

In an embodiment, the second support may pivot and/or rotate automatically and/or manually. In an embodiment, the second support may pivot and/or rotate electro-mechanically, hydraulically, mechanically (e.g., geared) or pneumatically. In an embodiment, the second support may pivot and/or rotate manually.

Any suitable extension may be used for the second support. For example, suitable extensions include, but are not limited to articulated arms, extendable pistons, telescoping pipes, and combinations thereof. In an embodiment, the extension for the second support may be an extendable piston. In an embodiment, the coupling for the second support may be a telescoping pipe with a clevis pin.

In an embodiment, the second support may have an extension at or near an upper end. For example, suitable extensions include, but are not limited to articulated arms, extendable pistons, telescoping pipes, and combinations thereof. In an embodiment, the second support may have an extendable arm at or near an upper end. In an embodiment, the second support may have a telescoping pipe with a clevis pin at or near an upper end.

In an embodiment, the second support may have an extension at or near a lower end. For example, suitable extensions include, but are not limited to articulated arms, extendable pistons, telescoping pipes, and combinations thereof. In an embodiment, the second support may have an extendable piston at or near a lower end. In an embodiment, the second support may have a telescoping pipe with a clevis pin at or near a lower end.

In an embodiment, the second support may raise and/or lower automatically and/or manually. In an embodiment, the second support may raise and/or lower electro-mechanically, hydraulically, mechanically (e.g., geared) or pneumatically. In an embodiment, the second support may raise and/or lower manually.

In an embodiment, an upper end of the third support may be mechanically coupled to a lower surface of the union system 1202, 2202, 8202, 9202 (e.g., a third body 1208c, 2208c, 8208c, 9208c of the union system 1202, 2202, 8202, 9202); and the lower end of the third support may be mechanically coupled to an upper surface of the base.

In an embodiment, the third support may be stationary when the first support and/or the second support are pivotable and/or rotatable, raisable and/or lowerable, and any combination thereof.

In an embodiment, the third support may be pivotable and/or rotatable. In an embodiment, an upper end of the third support may be pivotable and/or rotatable. In an embodiment, the lower end of the third support may be rotatable or stationary.

In an embodiment, the third support may be raisable and/or lowerable. In an embodiment, an upper end of the third support may be raisable and/or lowerable. In an embodiment, a lower end of the third support may be raisable and/or lowerable.

Any suitable connection may be used for the third support. For example, suitable connections include, but are not limited to, fittings and welds. Connections are well known in the art.

In an embodiment, an upper end of the third support may be attached to an outer surface of the union system 1202, 2202, 8202, 9202 by a connection. For example, suitable connections include, but are not limited to, bands, clamps, fittings and welds. In an embodiment, an upper end of the third support may be attached to an outer surface of the union system 1202, 2202, 8202, 9202 by a band or a clamp.

In an embodiment, the lower end of the third support may be attached to the upper surface of the skid (e.g., base) by a connection. For example, suitable connections include, but are not limited to, bands, clamps, fittings and welds. In an embodiment, the lower end of the third support may be attached to the upper surface of the skid (e.g., base) by a connection. In an embodiment, the lower end of the third support may be attached to the upper surface of the skid (e.g., base) by fittings or welds.

Any suitable coupling may be used for the third support. For example, suitable couplings include, but are not limited to bearings, hinges, pivots, sockets, and combinations thereof. In an embodiment, the coupling for the third support may be a bearing. In an embodiment, the coupling for the third support may be a box channel with a pivot pin.

In an embodiment, the third support may have a coupling at or near an upper end. For example, suitable couplings include, but are not limited to bearings, hinges, pivots, sockets, and combinations thereof. In an embodiment, the third support may have a bearing or a socket at or near an upper end. In an embodiment, the third support may have a hinge or a pivot at or near an upper end.

In an embodiment, the third support may have a coupling at or near a lower end. For example, suitable couplings include, but are not limited to bearings, hinges, pivots, sockets, and combinations thereof. In an embodiment, the third support may have a bearing or a socket at or near a lower end. In an embodiment, the third support may have a hinge or a pivot at or near a lower end.

In an embodiment, the third support may pivot and/or rotate automatically and/or manually. In an embodiment, the third support may pivot and/or rotate electro-mechanically, hydraulically, mechanically (e.g., geared) or pneumatically. In an embodiment, the third support may pivot and/or rotate manually.

Any suitable extension may be used for the third support. For example, suitable extensions include, but are not limited to articulated arms, extendable pistons, telescoping pipes, and combinations thereof. In an embodiment, the extension for the third support may be an extendable piston. In an embodiment, the extension for the third support may be a telescoping pipe with a clevis pin.

In an embodiment, the third support may have an extension at or near an upper end. For example, suitable extensions include, but are not limited to articulated arms, extendable pistons, telescoping pipes, and combinations thereof. In an embodiment, the third support may have an extendable arm at or near an upper end. In an embodiment, the third support may have a telescoping pipe with a clevis pin at or near an upper end.

In an embodiment, the third support may have an extension at or near a lower end. For example, suitable extensions include, but are not limited to articulated arms, extendable pistons, telescoping pipes, and combinations thereof. In an embodiment, the third support may have an extendable piston at or near a lower end. In an embodiment, the third support may have a telescoping pipe with a clevis pin at or near a lower end.

In an embodiment, the third support may raise and/or lower automatically and/or manually. In an embodiment, the third support may raise and/or lower electro-mechanically, hydraulically, mechanically (e.g., geared) or pneumatically. In an embodiment, the third support may raise and/or lower manually.

In an embodiment, the first support, the second support and/or the third support of the skid of the drilling mud screen system 100, 200, 800, 900 may be constructed of any suitable material. For example, suitable materials include, but are not limited to, any alloy steel suitable for a drilling or completion application. In an embodiment, the first support, the second support, and/or the third support of the skid may be constructed of an alloy steel or equivalent material. In an embodiment, the first support, the second support, and/or the third support of the skid may be constructed of a 304 stainless steel material. In an embodiment, the first support, the second support, and/or the third support of the skid may be unpainted. In an embodiment, the first support, the second support, and/or the third support of the skid may be painted.

In an embodiment, the base of the skid of the drilling mud screen system 100, 200, 800, 900 may be constructed of any suitable material. For example, suitable materials include, but are not limited to, a concrete, a polymer, and any alloy steel suitable for a drilling or completion application. In an embodiment, the base may be constructed of a concrete. In an embodiment, the base may be constructed of a polymer. In an embodiment, the base of the skid may be constructed of an alloy steel or equivalent material. In an embodiment, the base of the skid may be constructed of a 304 stainless steel material. In an embodiment, the base of the skid may be unpainted. In an embodiment, the base of the skid may be painted.

Drilling Mud Screen Assembly

FIG. 1A illustrates a cut-away, side view of a multi-screen drilling mud screen system 100, showing a drilling mud screen assembly 140 with four drilling mud screens 140a; FIG. 1B illustrates a left-side perspective view of the multi-screen drilling mud screen system 100 of FIG. 1A, showing the drilling mud screen assembly 140 with four drilling mud screens 140a; FIG. 1C illustrates a right-side perspective view of the multi-screen drilling mud screen system 100 of FIG. 1A; FIG. 1D illustrates a side view of the drilling mud screen assembly 140 of FIGS. 1A-1C; and FIG. 1E illustrates a left-side perspective view of the drilling mud screen assembly 140 of FIGS. 1A-1D.

FIG. 2A illustrates a cut-away, side view of a multi-screen drilling mud screen system 200, showing a drilling mud screen assembly 240 with four drilling mud screens 240a; and FIGS. 2B-1 to 2B-3 illustrate a cut-away, left-side perspective view of the multi-screen drilling mud screen system 200 of FIG. 2A.

FIG. 3A illustrates a left-side perspective view of the drilling mud screen assembly 300, showing four drilling mud screens 330; FIG. 3B illustrates a side view of one of the drilling mud screens 330 of FIG. 3A, showing a perforated outer shell; FIG. 3C illustrates a cut-away, side view of the drilling mud screen 330 of FIG. 3B, showing a wire wrap screen disposed inside the perforated shell; FIG. 3D illustrates a side view of the wire wrap screen of FIG. 3C, showing the wire wrap wrapped around a frame; and FIG. 3E illustrates a cross-section view of the wire wrap screen of FIG. 3D, showing the wire wrap wrapped around the frame.

FIG. 8A illustrates a cut away, side view of a multi-screen drilling mud screen system 800, showing a drilling mud screen assembly 840 with four drilling mud screens 840a.

As shown in FIGS. 1A-1E, 2A-2C, 3A-3E and 8A-8C, the drilling mud screen assembly 140, 240, 300, 840 comprises an assembly body 305, 5265, 5270 having a first end 310 and a second end 315, a drilling mud or completion fluid inlet 320, a drilling mud or completion fluid outlet 325, and a drilling mud screen 140a, 240a, 330, 840a having an end cap 335. See e.g., FIG. 5E.

In an embodiment, the drilling mud screen assembly 140, 240, 300, 840 may comprises one or more drilling mud screens 140a, 240a, 330, 840a. In an embodiment, the drilling mud screen assembly 140, 240, 300, 840 may comprise from about 1 to about 20 drilling mud screens 140a, 240a, 330, 840a, and any range or value there between. In an embodiment, the drilling mud screen assembly 140, 240, 300, 840 may comprise about 4 drilling mud screens 140a, 240a, 330, 840a.

In an embodiment, the drilling mud or completion fluid inlet 320 of the drilling mud screen assembly 140, 240, 300, 840 may be fluidly connected to, for example, an outlet of a drilling mud pump via a connection; and the drilling mud or completion fluid outlet 325 of the drilling mud screen assembly 140, 240, 300, 840 may be fluidly connected to an inlet of a vibrator hose via a connection. Any suitable connection may be used for the drilling mud or completion fluid inlet 320 of the drilling mud screen assembly 140, 240, 300, 840 and the drilling mud or completion fluid outlet 325 of the drilling mud screen assembly 140, 240, 300, 840. For example, suitable connections include, but are not limited to, pipe fittings and welds. Connections are well known in the art. In an embodiment, the drilling mud or completion fluid inlet 320 of the drilling mud screen assembly 140, 240, 300, 840 may be fluidly connected to, for example, an outlet of a drilling mud pump via a weld; and the drilling mud or completion fluid outlet 325 of the drilling mud screen assembly 140, 240, 300, 840 may be fluidly connected to an inlet of a vibrator hose via a weld.

In an embodiment, the assembly body 305, 5265, 5270 of the drilling mud screen assembly 140, 240, 300, 840 may be constructed of any suitable material. For example, suitable materials include, but are not limited to, any alloy steel or tool steel. In an embodiment, the assembly body 305, 5265, 5270 may be constructed of an AISI 4145 or equivalent material. See e.g., FIGS. 3A & 5E. In an embodiment, the assembly body 305, 5265, 5270 may be constructed of tool steel or equivalent material.

In an embodiment, the assembly body 305, 5265, 5270 of the drilling mud screen assembly 140, 240, 300, 840 may have a hardened coating to reduce washing (i.e., erosion) of the screen assembly 140, 240, 300, 840. For example, suitable hardened coatings include, but are not limited to, any Carbide coating or equivalent. In an embodiment, the assembly body 305, 5265, 5270 may have a Carbide coating with about 6% Cobalt binder or equivalent material.

In an embodiment, the assembly body 305, 5265, 5270 has a means to engage a puller/installer tool 340. In an embodiment, the assembly body 305, 5265, 5270 may be shaped to accept the puller/installer plate of a drilling mud screen puller/installer tool. In an embodiment, the first end 310 of the assembly body 305, 5265, 5270 may be shaped to accept a puller/installer plate of a drilling mud screen puller/installer tool.

In an embodiment, the assembly body 305, 5265, 5270 of the drilling mud screen assembly 140, 240, 300, 840 has a centerline 345 and a length 350. In an embodiment, a plurality of drilling mud or completion fluid inlets 320 are disposed radially around the centerline 345 of the assembly body 305, 5265, 5270; and a plurality of drilling mud or completion fluid outlets 325 are disposed radially around the center line 345 of the assembly body 305, 5265, 5270 such that one of the drilling mud or completion fluid inlets 320 is fluidly connected to one of the drilling mud or completion fluid outlets 325. The length 350 of the assembly body 305, 5265, 5270 may be any suitable length. In an embodiment, the length 350 of the assembly body 305, 5265, 5270 may be from about 10-inches to about 20-inches, and any range or value there between. In an embodiment, the length 350 may be about 15-inches.

In an embodiment, the centerline 345 of the assembly body 305, 5265, 5270 of the drilling mud screen assembly 140, 240, 300, 840 and an outer surface 355 of the assembly body 305, 5265, 5270 form an angle 360. In an embodiment, the angle 360 may be from about 30-degrees to about 60-degrees, and any range or value there between. In an embodiment, the angle 360 may be from about 35-degrees to about 45-degrees.

In an embodiment, the drilling mud or completion fluid inlet 320 of the drilling mud screen assembly 140, 240, 300, 840 may have any suitable inner diameter 365. In an embodiment, the inner diameter 365 of each drilling mud or completion fluid inlet 320 may be from about 3-inches to about 5-inches, and any range or value there between. In an embodiment, the inner diameter 365 of the drilling mud or completion fluid inlet 320 may be about 4-inches.

In an embodiment, the assembly body 305, 5265, 5270 may have any suitable outer diameter 370. In an embodiment, the outer diameter 370 of the assembly body 305, 5265, 5270 may be from about 10-inches to about 25-inches, and any range or value there between. In an embodiment, the outer diameter 370 of the assembly body 305, 5265, 5270 may be about 16-inches or about 17-inches.

In an embodiment, the assembly body 305, 5265, 5270 of the drilling mud screen assembly 140, 240, 300, 840 has a first portion 375 and a second portion 380. In an embodiment, the first portion 375 of the assembly body 305, 5265, 5270 has a first length 385; and the second portion 380 of the assembly body 305, 5265, 5270 has a second length 390. The first portion 375 and the second portion 380 may be any suitable length. In an embodiment, the first portion 375 may have a first length 385 from about 4-inches to about 8-inches, and any range or value there between; and the second portion 380 may have a second length 390 from about 5-inches to about 15-inches, and any range or value there between. In an embodiment, the first portion 375 may have a first length 385 of about 5-inches or about 6-inches; and the second portion 380 may have a second length 390 of about 9-inches or about 10-inches.

In an embodiment, the assembly body 305, 5265, 5270 of the drilling mud screen assembly 140, 240, 300, 840 has a centerline 345 and a length 350. In an embodiment, a plurality of drilling mud or completion fluid inlets 320 are disposed radially around the centerline 345 of the assembly body 305, 5265, 5270; and a plurality of drilling mud or completion fluid outlets 325 are disposed radially around the center line 345 of the assembly body 305, 5265, 5270 such that one of the drilling mud or completion fluid inlets 320 is fluidly connected to one of the drilling mud or completion fluid outlets 325. The first length 350 of the assembly body 305, 5265, 5270 may be any suitable length. In an embodiment, the first length 350 of the assembly body 305, 5265, 5270 may be from about 10-inches to about 25-inches, and any range or value there between. In an embodiment, the first length 350 may be about 15-inches.

In an embodiment, the end cap 335 of the drilling mud screen 140a, 240a, 330, 840a may be any suitable shape. A suitable shape of the end cap 335 includes, but is not limited to, a disc shape, a cone shape, a hemispherical shape, an inverted cone shape, in inverted hemispherical shape, and combinations thereof.

In an embodiment, the end cap 335 of the drilling mud screen 140a, 240a, 330, 840a may be constructed of any suitable material. For example, suitable materials include, but are not limited to, any alloy steel or tool steel. In an embodiment, the end cap 335 may be constructed of 304 stainless steel material or equivalent material. In an embodiment, the end cap 335 may be constructed of AISI 4155 or equivalent material. In an embodiment, the end cap 335 may be constructed of tool steel or equivalent material.

In an embodiment, the end cap 335 of the drilling mud screen 140a, 240a, 330, 840a may have a hardened coating to reduce washing (i.e., erosion) of the screen 140a, 240a, 330, 840a. For example, suitable hardened coatings include, but are not limited to, any Carbide coating or equivalent. In an embodiment, the end cap 335 may have a Carbide coating with about 6% Cobalt binder or equivalent material.

Drilling Mud Screen

The drilling mud screen 140a, 240a, 330, 840a may be any suitable filter or screen capable of filtering or screening debris from drilling muds and completion fluids. For example, suitable drilling mud screens include, but are not limited to, drill screens and rod screens.

In an embodiment, the drilling mud screen 140a, 240a, 330, 840a comprises a body 3105 having a first end 3110 and a second end 3115, a drilling mud or completion fluid inlet 3120, a drilling mud or completion fluid outlet 3125, a filter 3130 and an end cap 335.

In an embodiment, the drilling mud or completion fluid inlet 3120 may be fluidly connected to, for example, an outlet of a drilling mud pump via a connection; and the drilling mud or completion fluid outlet 3125 may be fluidly connected to an inlet of a vibrator hose via a connection. Any suitable connection may be used for the drilling mud or completion fluid inlet 3120 and the drilling mud or completion fluid outlet 3125. For example, suitable connections include, but are not limited to, pipe fittings and welds. Connections are well known in the art. In an embodiment, the drilling mud or completion fluid inlet 3120 may be fluidly connected to, for example, an outlet of a drilling mud pump via a weld; and the drilling mud or completion fluid outlet 3125 may be fluidly connected to an inlet of a vibrator hose via a weld.

In an embodiment, the body 3105 of the drilling mud screen 140a, 240a, 330, 840a may be constructed of any suitable material. For example, suitable materials include, but are not limited to, any alloy steel or tool steel. In an embodiment, the body 3105 may be constructed of an AISI 4145 or equivalent material. See e.g., FIGS. 5A-5E. In an embodiment, the body 3105 may be constructed of tool steel or equivalent material.

In an embodiment, the body 3105 of the drilling mud screen 140a, 240a, 330, 840a may have a hardened coating to reduce washing (i.e., erosion) of the screen 140a, 240a, 330, 840a. For example, suitable hardened coatings include, but are not limited to, any Carbide coating or equivalent. In an embodiment, the body 3105 may have a Carbide coating with about 6% Cobalt binder or equivalent material.

In an embodiment, the body 3105 has a means to engage a puller/installer tool (not shown) at the first end 3110 of the body 3105. In an embodiment, the first end 3110 of the body 3105 may be shaped to accept a puller/installer plate of a drilling mud screen puller/installer tool.

In an embodiment, the body 3105 of the drilling mud screen 140a, 240a, 330, 840a has a centerline 3140 and a length 3145. In an embodiment, the centerline 3140 extends through the center of the drilling mud or completion fluid inlet 3120 to the end cap 335. The length 3145 of the body 3105 may be any suitable length. In an embodiment, the length 3145 of the body 3105 may be from about 25-inches to about 65-inches, and any range or value there between. In an embodiment, the length 3145 may be about 44-inches or about 45-inches.

In an embodiment, the drilling mud or completion fluid inlet 3120 of the drilling mud screen 140a, 240a, 330, 840a may have any suitable inner diameter 3150; and the drilling mud or completion fluid inlet 3120 may have any suitable outer diameter 3155. In an embodiment, the inner diameter 3150 of the drilling mud or completion fluid inlet 3120 may be from about 3-inches to about 5-inches, and any range or value there between. In an embodiment, the inner diameter 3150 of the drilling mud or completion fluid inlet 3120 may be about 4-inches.

In an embodiment, the outer diameter 3155 of the drilling mud or completion fluid inlet 3120 may be from about 4-inches to about 6-inches, and any range or value there between. In an embodiment, the outer diameter 3155 of the drilling mud or completion fluid inlet 3120 may be about 5-inches.

In an embodiment, the filter 3130 may comprise a plurality of rods spaced a distance apart to form a filter. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 may comprise a formed sheet having drilled holes spaced a distance apart to form a filter. In an embodiment, the size of the holes (e.g., diameter) may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 comprises a wire wrap filter 3160 and a perforated shell 3165. In an embodiment, the filter 3130 may comprise a plurality of rods spaced a distance apart to form a frame, and a wire wrap wrapped around the frame and spaced a distance apart to form the wire wrap filter 3160. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 may comprise a formed sheet having drilled holes spaced a distance apart to form the perforated shell 3165. In an embodiment, the filter 3130 may comprise the wire wrap filter 3160 disposed inside the perforated shell 3165.

In an embodiment, the first end 3110 of the body 3105 of the drilling mud screen 140a, 240a, 330, 840a may have a drilling mud or completion fluid inlet 3120.

In an embodiment, the second end 3115 of the body 3105 of the drilling mud screen 140a, 240a, 330, 840a may have a drilling mud or completion fluid outlet 3125. In an embodiment, the drilling mud or completion fluid outlet 3125 may comprise a plurality of spaces (i.e., flow passages) between the plurality of rods. In an embodiment, the drilling mud or completion fluid outlet 3125 may comprises a plurality of spaces (i.e., flow passages) between the wire wrap. In an embodiment, the drilling mud or completion fluid outlet 3125 may comprise a plurality of holes (i.e., flow passages) drilled in a formed sheet. For example, the particle size desired to be filtered from drilling mud may be from about 3/16-inches and larger. For example, the particle size desired to be filtered from the completion fluids may be from about 200 microns to about 2500 microns.

In an embodiment, the body 3105 of the drilling mud screen 140a, 240a, 330, 840a has a first portion 3170 and a second portion 3175. In an embodiment, the first portion 3170 of the body 3105 has a first length 3180; and the second portion 3175 of the body 3105 has a second length 3185. The first portion 3170 and the second portion 3175 may be any suitable length. In an embodiment, the first portion 3170 may have a first length 3180 from about 6-inches to about 12-inches, and any range or value there between; and the second portion 3175 may have a second length 3185 from about 20-inches to about 60-inches, and any range or value there between. In an embodiment, the first portion 3170 may have a first length 3180 of about 8.5-inches; and the second portion 3175 may have a second length 3185 of about 34.5-inches.

In an embodiment, a second portion 3170 of the body 3105 of the drilling mud screen 140a, 240a, 330, 840a may have a filter 3130. In an embodiment, the filter 3130 may comprise a plurality of rods spaced a distance apart to form a filter. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 may comprise a formed sheet having drilled holes spaced a distance apart to form a filter. In an embodiment, the size of the holes (e.g., diameter) may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 may comprise a plurality of rods spaced a distance apart to form a frame, and a wire wrap wrapped around the frame and spaced a distance apart to form the wire wrap filter 3160. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130 may comprise a formed sheet having drilled holes spaced a distance apart to form the perforated shell 3165. In an embodiment, the filter 3130 may comprise the wire wrap filter 3160 disposed inside the perforated shell 3165.

In an embodiment, a second portion 3175 of the body 3105 of the drilling mud screen 140a, 240a, 330, 840a may have a drilling mud or completion fluid outlet 3125. In an embodiment, the drilling mud or completion fluid outlet 3125 may comprise a plurality of spaces (i.e., flow passages) between the plurality of rods. In an embodiment, the drilling mud or completion fluid outlet 3125 may comprise a plurality of spaces (i.e., flow passages) between the wire wrap. In an embodiment, the drilling mud or completion fluid outlet 3125 may comprise a plurality of holes (i.e., flow passages) drilled in a formed sheet. For example, the particle size desired to be filtered from drilling mud may be from about 3/16-inches and larger. For example, the particle size desired to be filtered from the completion fluids may be from about 200 microns to about 2500 microns.

In an embodiment, a first end 3110 of a first portion 3170 of the body 3105 of the drilling mud screen 140a, 240a, 330, 840a may have a first inner diameter 3190; and a second end 3115 of a second portion 3175 of the body 3105 may have a second inner diameter 3195.

In an embodiment, the body 3105 has a means to engage a puller/installer tool 340. In an embodiment, the body 3105 may be shaped to accept the puller/installer plate of a drilling mud screen puller/installer tool. In an embodiment, the first end 3110 of the first portion 3170 and/or the second end of the first portion 3170 may be shaped to accept the puller/installer plate of a drilling mud screen puller/installer tool. In an embodiment, a first end of the second portion 3175 may also be shaped to accept the puller/installer plate of a drilling mud screen puller/installer tool.

In an embodiment, the body 3105 and/or a filter 3130 of the drilling mud screen 140a, 240a, 330, 840a may have a tapered drilling mud flow path from a larger inner diameter to a smaller inner diameter to reduce washing (i.e., erosion) of the screen 140a, 240a, 330, 840a.

In an embodiment, the first inner diameter 3190 of the first end 3110 of the body 3105 of the drilling mud screen 140a, 240a, 330, 840a may be from about 3-inches to about 5-inches, and any range or value there between. In an embodiment, the first inner diameter 3190 of the first end 3110 of the body 3105 may be about 4-inches.

In an embodiment, an inner diameter of an outlet of the first portion 3170 and an inlet of the second portion 3175 of the body 3105 may be from about 3-inches to about 5-inches, and any range or value there between. In an embodiment, the inner diameter of the outlet of the first portion 3170 of the body 3105 and the inlet of the second portion 3175 of the body 3105 may be about 4-inches.

In an embodiment, the outlet of the first portion 3170 and/or the inlet of the second portion 3175 of the body 3105 may be shaped to accept a puller/installer plate of a drilling mud screen puller/installer tool. In an embodiment, the inlet of the second portion 3175 of the body 3105 may have an inner shoulder to provide a pushing surface for the puller/installer plate of the drilling mud screen puller/installer tool.

In an embodiment, the body 3105 has a means to engage a puller/installer tool 340. In an embodiment, the body 3105 may be shaped to accept the puller/installer plate of a drilling mud screen puller/installer tool. In an embodiment, the outlet of the first portion 3170 and/or the inlet of the second portion 3175 of the body 3105 may have a means to engage (not shown) a drilling mud screen puller/installer tool. The means to engage (not shown) may be any suitable means to accept, and provide a pulling surface for, the drilling mud screen puller/installer tool. For example, a suitable means to engage (not shown) includes, but is not limited to, a “key” opening to rotationally engage an inner shoulder. In an embodiment, the outlet of the first portion 3170 and/or the inlet of the second portion 3175 of the body 3105 may be shaped to accept a puller/installer plate of a drilling mud screen puller/installer tool. In an embodiment, the inlet of the second portion 3170 of the body 3105 may have an inner shoulder to provide a pulling surface for the puller/installer plate of the drilling mud screen puller/installer tool.

In an embodiment, the second inner diameter 3195 of the second end 3115 of the body 3105 of the drilling mud screen 140a, 240a, 330, 840a may be from about 3-inches to about 5-inches, and any range or value there between. In an embodiment, the second inner diameter 3195 of the second end 3115 of the body 3105 may be about 3.5-inches or about 4-inches.

In an embodiment, the outer surface 3200 of the body 3105 of the drilling mud screen 140a, 240a, 330, 840a may be sealed against an inner surface of the assembly body 305, 5365, 5270 via an O-ring. Any suitable O-ring may be used. For example, suitable O-rings include, but are not limited to, 300 Series O-rings. O-rings are well known in the art.

In an embodiment, the filter 3130 may have a plurality of rods spaced a distance apart to form a filter, a plurality of rods spaced apart to form a frame, and a wire wrap wrapped around the frame and spaced a distance apart to form a wire wrap filter 3160, a formed sheet having drilled holes spaced a distance apart to form a filter and/or a formed sheet having drilled holes spaced a distance apart to form a perforated shell 3165. In an embodiment, the plurality of rods may be tapered from a larger outer diameter to a smaller outer diameter to encourage drilling mud flow to exit in straight lines through the drilling mud outlet 3125 (i.e., through flow passages between the plurality rods) to reduce washing (i.e., erosion) of the screen 140a, 240a, 330, 840a. In an embodiment, the filter 3130 of the drilling mud screen 140a, 240a, 330, 840a may have a plurality of straight rows of holes drilled in a formed sheet to encourage drilling mud flow to exit in straight rows of strings through the drilling mud outlet 3125 (i.e., through straight flow passages of the drilled holes) to reduce washing (i.e., erosion) of the screen 140a, 240a, 330, 840a.

In an embodiment, a first end of a filter 3130 may be connected to a second end 3115 of the body 3105 via a connection; and a second end of a filter 3130 may be connected to a first end of the end cap 335 via a connection. Any suitable connections may be used for the end cap 335, body 3105 and filter 3130. For example, suitable connections include, but are not limited to, welds. Connections are well known in the art. In an embodiment, the first end of the filter 3130 may be connected to the second end 3115 of the body 3105 via a weld; and the second end of the filter 3130 may be connected to the first end of the end cap 335 via a weld.

In an embodiment, the filter 3130 of the drilling mud screen 140a, 240a, 330, 840a may be constructed of any suitable material. For example, suitable materials include, but are not limited to, any alloy steel or tool steel. In an embodiment, the filter 3130 may be constructed of 304 stainless steel material. In an embodiment, the filter 3130 may be constructed of AISI 4145 or equivalent material. In an embodiment, the filter 3130 may be constructed of D2 tool steel or equivalent material.

In an embodiment, the filter 3130 of the drilling mud screen 140a, 240a, 330, 840a may have a hardened coating to reduce washing (i.e., erosion) of the screen 140a, 240a, 330, 840a. For example, suitable hardened coatings include, but are not limited to, any Carbide coating or equivalent. In an embodiment, the filter 3130 may have a Carbide coating with about 6% Cobalt binder or equivalent material.

In an embodiment, the end cap 335 of the drilling mud screen 140a, 240a, 330, 840a has an inner surface. In an embodiment, the inner surface of the end cap 335 of the drilling mud screen 140a, 240a, 330, 840a may redirect the flow to reduce washing (i.e., erosion) of the screen 140a, 240a, 330, 840a. In an embodiment, the inner surface of the end cap 335 of the drilling mud screen 140a, 240a, 330, 840a forms an inverted cone relative to the second end 3115 of the body 3105 of the drilling mud screen 140a, 240a, 330, 840a (i.e., an upstream pointing cone) to redirect the flow. In an embodiment, the tip of the inverted cone may have a rounded or squared shape.

In an embodiment, the body 3105 of the drilling mud screen 140a, 240a, 330, 840a has a centerline 3140 and a length 3145. In an embodiment, the centerline 3140 extends through the center of the drilling mud screen inlet 3120 to the end cap 335. In an embodiment, the centerline 3140 of the body 3105 of the drilling mud screen 140a, 240a, 330, 840a and the inner surface of the end cap 335 form an angle. In an embodiment, the angle may be from about 30-degrees to about 160-degrees, and any range or value there between. In an embodiment, the angle may be about 120-degrees. In an embodiment, the angle may be about 90-degrees.

In an embodiment, the end cap 335 of the drilling mud screen 140a, 240a, 330, 840a may be constructed of any suitable material. For example, suitable materials include, but are not limited to, any alloy steel or tool steel. In an embodiment, the end cap 335 may be constructed of 304 stainless steel material or equivalent material. In an embodiment, the end cap 335 may be constructed of AISI 4155 or equivalent material. In an embodiment, the end cap 335 may be constructed of tool steel or equivalent material.

In an embodiment, the end cap 335 of the drilling mud screen 140a, 240a, 330, 840a may have a hardened coating to reduce washing (i.e., erosion) of the screen 140a, 240a, 330, 840a. For example, suitable hardened coatings include, but are not limited to, any Carbide coating or equivalent. In an embodiment, the end cap 335 may have a Carbide coating with about 6% Cobalt binder or equivalent material.

Alternative Reversed Drilling Mud Screen Assembly

FIG. 9A illustrates a cut away side view of a multi-screen drilling mud screen system 900, showing a reversed drilling mud screen assembly 940; and FIG. 9B illustrates a detail view of the reversed drilling mud screen assembly 940 of FIG. 9A, showing four reversed drilling mud screens 940a.

As shown in FIGS. 9A-9B, the reversed drilling mud screen assembly 940 comprises a drilling mud or completion fluid inlet 920, a drilling mud or completion fluid outlet 925, and a drilling mud screen 940a having an end cap 935.

In an embodiment, the reversed drilling mud screen assembly 940 may comprise an assembly body 805 having a first end 810 and a second end 815, a drilling mud or completion fluid inlet 920, a drilling mud or completion fluid outlet 925, and a drilling mud screen 940a having an end cap 935. See e.g., FIGS. 8A-8C & 9A-9B.

In an embodiment, the drilling mud screen assembly 940 may comprises one or more drilling mud screens 940a. In an embodiment, the drilling mud screen assembly 940 may comprise from about 1 to about 20 drilling mud screens 940a, and any range or value there between. In an embodiment, the drilling mud screen assembly 940 may comprise about 4 drilling mud screens 940a.

In an embodiment, the drilling mud or completion fluid inlet 920 of the drilling mud screen assembly 940 may be fluidly connected to, for example, an outlet of a drilling mud pump via a connection; and the drilling mud or completion fluid outlet 925 of the drilling mud screen assembly 940 may be fluidly connected to an inlet of a vibrator hose via a connection. Any suitable connection may be used for the drilling mud or completion fluid inlet 920 of the drilling mud screen assembly 940 and the drilling mud or completion fluid outlet 925 of the drilling mud screen assembly 940. For example, suitable connections include, but are not limited to, pipe fittings and welds. Connections are well known in the art. In an embodiment, the drilling mud or completion fluid inlet 920 of the drilling mud screen assembly 940 may be fluidly connected to, for example, an outlet of a drilling mud pump via a weld; and the drilling mud or completion fluid outlet 925 of the drilling mud screen assembly 940 may be fluidly connected to an inlet of a vibrator hose via a weld.

In an embodiment, the assembly body 805 of the drilling mud screen assembly 940 may be constructed of any suitable material. For example, suitable materials include, but are not limited to, any alloy steel or tool steel. In an embodiment, the assembly body 805 may be constructed of an AISI 4145 or equivalent material. In an embodiment, the assembly body 805 may be constructed of tool steel or equivalent material.

In an embodiment, the assembly body 805 of the drilling mud screen assembly 940 may have a hardened coating to reduce washing (i.e., erosion) of the drilling mud screen assembly 940. For example, suitable hardened coatings include, but are not limited to, any Carbide coating or equivalent. In an embodiment, the assembly body 805 may have a Carbide coating with about 6% Cobalt binder or equivalent material.

In an embodiment, the drilling mud screen assembly 940 has a centerline 345 and an outer surface of the drilling mud screen assembly 940. See e.g., FIGS. 3A, 8A-8C & 9A-9B. In an embodiment, the drilling mud or completion fluid inlet 920 is disposed radially around the centerline 345 of the drilling mud screen assembly 940 at or near the outer surface of the drilling mud screen assembly 940; and a plurality of drilling mud or completion fluid outlets 925 are disposed radially around the centerline 345 of the drilling mud screen assembly 940.

In an embodiment, the assembly body 805 of the drilling mud screen assembly 940 has a centerline 345, a length 350 and an outer surface of the drilling mud screen assembly 940. See e.g., FIGS. 3A, 8A-8C & 9A-9B. In an embodiment, the drilling mud or completion fluid inlet 920 is disposed radially around the centerline 345 of the drilling mud screen assembly 940 at or near the outer surface of the drilling mud screen assembly 940; and a plurality of drilling mud or completion fluid outlets 925 are disposed radially around the centerline 345 of the assembly body 805. The length 350 of the assembly body 805 may be any suitable length. In an embodiment, the length 350 of the assembly body 805 may be from about 10-inches to about 20-inches, and any range or value there between. In an embodiment, the length 350 may be about 15-inches.

In an embodiment, the centerline 345 of the assembly body 805 of the drilling mud screen assembly 940 and an outer surface 355 of the assembly body 805 may form an angle 360. See e.g., FIGS. 3A, 8A-8C & 9A-9B. In an embodiment, the angle 360 may be from about 30-degrees to about 60-degrees, and any range or value there between. In an embodiment, the angle 360 may be from about 35-degrees to about 45-degrees.

In an embodiment, the assembly body 805 of the drilling mud screen assembly 940 may have any suitable outer diameter 370. See e.g., FIGS. 3A, 8A-8C & 9A-9B. In an embodiment, the outer diameter 370 of the assembly body 805 may be from about 10-inches to about 25-inches, and any range or value there between. In an embodiment, the outer diameter 370 of the assembly body 805 may be about 16-inches or about 17-inches.

In an embodiment, the assembly body 805 of the drilling mud screen assembly 940 may have a first portion 375 and a second portion 380. See e.g., FIGS. 3A, 8A-8C & 9A-9B. In an embodiment, the first portion 375 of the assembly body 805 has a first length 385; and the second portion 380 of the assembly body 805 has a second length 390. The first portion 375 and the second portion 380 may be any suitable length. In an embodiment, the first portion 375 may have a first length 385 from about 4-inches to about 8-inches, and any range or value there between; and the second portion 380 may have a second length 390 from about 5-inches to about 15-inches, and any range or value there between. In an embodiment, the first portion 375 may have a first length 385 of about 5-inches or about 6-inches; and the second portion 380 may have a second length 390 of about 9-inches or about 10-inches.

In an embodiment, the drilling mud screen assembly 940 has a centerline 345 and an outer surface of the drilling mud screen assembly 940. See e.g., FIGS. 3A & 9A-9B. In an embodiment, the drilling mud or completion fluid inlet 920 is disposed radially around the centerline 345 of the drilling mud screen assembly 940 at or near the outer surface of the drilling mud screen assembly 940; and a plurality of drilling mud or completion fluid outlets 925 are disposed radially around the centerline 345 of the drilling mud screen assembly 940.

In an embodiment, the assembly body 805 of the drilling mud screen assembly 940 has a centerline 345, a length 350 and an outer surface of the drilling mud screen assembly 940. See e.g., FIGS. 3A, 8A-8C & 9A-9B. In an embodiment, the drilling mud or completion fluid inlet 920 is disposed radially around the centerline 345 of the drilling mud screen assembly 940 at or near the outer surface of the drilling mud screen assembly 940; and a plurality of drilling mud or completion fluid outlets 925 are disposed radially around the centerline 345 of the assembly body 805. The length 350 of the assembly body 805 may be any suitable length. In an embodiment, the length 350 of the assembly body 805 may be from about 10-inches to about 20-inches, and any range or value there between. In an embodiment, the length 350 may be about 15-inches.

In an embodiment, the end cap 935 of the drilling mud screen 940a may be any suitable shape. A suitable shape of the end cap 935 includes, but is not limited to, a disc shape, a cone shape, a hemispherical shape, an inverted cone shape, in inverted hemispherical shape, and combinations thereof.

In an embodiment, the end cap 935 of the drilling mud screen 940a may be constructed of any suitable material. For example, suitable materials include, but are not limited to, any alloy steel or tool steel. In an embodiment, the end cap 935 may be constructed of 304 stainless steel material or equivalent material. In an embodiment, the end cap 935 may be constructed of AISI 4155 or equivalent material. In an embodiment, the end cap 935 may be constructed of tool steel or equivalent material.

In an embodiment, the end cap 935 of the drilling mud screen 940a may have a hardened coating to reduce washing (i.e., erosion) of the drilling mud screen 940a. For example, suitable hardened coatings include, but are not limited to, any Carbide coating or equivalent. In an embodiment, the end cap 935 may have a Carbide coating with about 6% Cobalt binder or equivalent material.

Alternative Reversed Drilling Mud Screen

The drilling mud screen 330, 940a may be any suitable filter or screen capable of filtering or screening debris from drilling muds and completion fluids. For example, suitable drilling mud screens include, but are not limited to, drill screens and rod screens.

FIG. 9A illustrates a cut away side view of a multi-screen drilling mud screen system 900, showing a reversed drilling mud screen assembly 940; and FIG. 9B illustrates a detail view of the reversed drilling mud screen assembly 940 of FIG. 9A, showing four reversed drilling mud screens 940a.

In an embodiment, the drilling mud screen 330, 940a comprises a body 3105, 9105 having a first end 9110 and a second end 9115, a drilling mud or completion fluid inlet 9120, a drilling mud or completion fluid outlet 9125, a filter 3130, 9130 and an end cap 935. See e.g., FIGS. 3A & 9A-9B.

In an embodiment, the drilling mud or completion fluid inlet 9120 may be fluidly connected to, for example, an outlet of a drilling mud pump via a connection; and the drilling mud or completion fluid outlet 9125 may be fluidly connected to an inlet of a vibrator hose via a connection. Any suitable connection may be used for the drilling mud or completion fluid inlet 9120 and the drilling mud or completion fluid outlet 9125. For example, suitable connections include, but are not limited to, pipe fittings and welds. Connections are well known in the art. In an embodiment, the drilling mud or completion fluid inlet 9120 may be fluidly connected to, for example, an outlet of a drilling mud pump via a weld; and the drilling mud or completion fluid outlet 9125 may be fluidly connected to an inlet of a vibrator hose via a weld.

In an embodiment, the body 9105 of the drilling mud screen 940a may be constructed of any suitable material. For example, suitable materials include, but are not limited to, any alloy steel or tool steel. In an embodiment, the body 9105 may be constructed of an AISI 4145 or equivalent material. In an embodiment, the body 9105 may be constructed of tool steel or equivalent material.

In an embodiment, the body 9105 of the drilling mud screen 940a may have a hardened coating to reduce washing (i.e., erosion) of the drilling mud screen 940a. For example, suitable hardened coatings include, but are not limited to, any Carbide coating or equivalent. In an embodiment, the body 9105 may have a Carbide coating with about 6% Cobalt binder or equivalent material.

In an embodiment, the body 3105, 9105 of the drilling mud screen 330, 940a has a centerline 3140 and a length 3145. In an embodiment, the centerline 3140 extends through the center of the drilling mud outlet 9125 of the body 9105 to the end cap 935. The length 3145 of the body 9105 may be any suitable length. In an embodiment, the length 3145 of the body 9105 may be from about 25-inches to about 65-inches, and any range or value there between. In an embodiment, the length 3145 may be about 44-inches or about 45-inches. See e.g., FIGS. 3B & 9A-9B.

In an embodiment, the drilling mud outlet 9125 of the body 9105 may have any suitable inner diameter 3150; and the drilling mud outlet 9125 may have any suitable outer diameter 3155. In an embodiment, the inner diameter 3150 of the drilling mud outlet 9125 of the body 9105 may be from about 3-inches to about 5-inches, and any range or value there between. In an embodiment, the inner diameter 3150 of the drilling mud outlet 9125 of the body 9105 may be about 4-inches. See e.g., FIGS. 3B & 9A-9B.

In an embodiment, the outer diameter 3155 of the drilling mud outlet 9125 of the body 9105 may be from about 4-inches to about 6-inches, and any range or value there between. In an embodiment, the outer diameter 3155 of the drilling mud outlet 9125 of the body 9105 may be about 5-inches.

In an embodiment, the filter 3130, 9130 may comprise a plurality of rods spaced a distance apart to form a filter. See e.g., FIGS. 3B-3E & 9A-9B. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 may comprise a formed sheet having drilled holes spaced a distance apart to form a filter. See e.g., FIGS. 3B-3E & 9A-9B. In an embodiment, the size of the holes (e.g., diameter) may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 comprises a wire wrap filter 3160 and a perforated shell 3165. See e.g., FIGS. 3B-3E & 9A-9B. In an embodiment, the filter 3130, 9130 may comprise a plurality of rods spaced a distance apart to form a frame, and a wire wrap wrapped around the frame and spaced a distance apart to form the wire wrap filter 3160. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 may comprise a formed sheet having drilled holes spaced a distance apart to form the perforated shell 3165. In an embodiment, the filter 3130, 9130 may comprise the wire wrap filter 3160 disposed inside the perforated shell 3165. See e.g., FIGS. 3B-3E & 9A-9B.

In an embodiment, the first end 9110 of the body 9105 of the drilling mud screen 940a may have a drilling mud or completion fluid inlet 9120. In an embodiment, the drilling mud or completion fluid inlet 9120 may comprise a plurality of spaces (i.e., flow passages) between the plurality of rods. In an embodiment, the drilling mud or completion fluid inlet 9120 may comprises a plurality of spaces (i.e., flow passages) between the wire wrap. In an embodiment, the drilling mud or completion fluid inlet 9120 may comprise a plurality of holes (i.e., flow passages) drilled in a formed sheet. For example, the particle size desired to be filtered from drilling mud may be from about 3/16-inches and larger. For example, the particle size desired to be filtered from the completion fluids may be from about 200 microns to about 2500 microns.

In an embodiment, the second end 9115 of the body 9105 of the drilling mud screen 940a may have a drilling mud or completion fluid outlet 9125.

In an embodiment, the body 9105 of the drilling mud screen 940a has a first portion 9175 and a second portion 9170. In an embodiment, the first portion 9175 of the body 9105 has a first length 3185; and the second portion 9170 of the body 9105 has a second length 3180. The first portion 9175 and the second portion 9170 may be any suitable length. In an embodiment, the first portion 9175 may have a first length 3185 from about 6-inches to about 12-inches, and any range or value there between; and the second portion 9170 may have a second length 3180 from about 20-inches to about 60-inches, and any range or value there between. In an embodiment, the first portion 9175 may have a first length 3185 of about 8.5-inches; and the second portion 9170 may have a second length 3180 of about 34.5-inches. See e.g., FIGS. 3B & 9A-9B.

In an embodiment, a first portion 9175 of the body 9105 of the drilling mud screen 330, 940a may have a filter 3130, 9130. See e.g., FIGS. 3B-3E & 9A-9B. In an embodiment, the filter 3130, 9130 may comprise a plurality of rods spaced a distance apart to form a filter. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 may comprise a formed sheet having drilled holes spaced a distance apart to form a filter. See e.g., 3B & 9A-9B. In an embodiment, the size of the holes (e.g., diameter) may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 may comprise a plurality of rods spaced a distance apart to form a frame, and a wire wrap wrapped around the frame and spaced a distance apart to form the wire wrap filter 3160. See e.g., FIGS. 3B-3E & 9A-9B. In an embodiment, the distance may be less than a particle size (e.g., diameter) desired to be filtered from the drilling mud or completion fluid. For example, the particle size desired to be filtered from drilling mud may be from about 3/16-inches and larger. For example, the particle size desired to be filtered from the completion fluids may be from about 200 microns to about 2500 microns.

In an embodiment, the filter 3130, 9130 may comprise a formed sheet having drilled holes spaced a distance apart to form the perforated shell 3165. In an embodiment, the filter 3130, 9130 may comprise the wire wrap filter 3160 disposed inside the perforated shell 3165. See e.g., FIGS. 3B-3E & 9A-9B.

In an embodiment, a first portion 9175 of the body 9105 of the drilling mud screen 940a may have a drilling mud or completion fluid inlet 9120. In an embodiment, the drilling mud or completion fluid inlet 9120 may comprise a plurality of spaces (i.e., flow passages) between the plurality of rods. In an embodiment, the drilling mud or completion fluid inlet 9120 may comprise a plurality of spaces (i.e., flow passages) between the wire wrap. In an embodiment, the drilling mud or completion fluid inlet 9120 may comprise a plurality of holes (i.e., flow passages) drilled in a formed sheet. For example, the particle size desired to be filtered from drilling mud may be from about 3/16-inches and larger. For example, the particle size desired to be filtered from the completion fluids may be from about 200 microns to about 2500 microns.

In an embodiment, a first end 9110 of a first portion 9175 of the body 3105, 9105 of the drilling mud screen 330, 940a may have a first inner diameter 3195; and a second end 9115 of a second portion 9170 of the body 3105, 9105 may have a second inner diameter 3190. See e.g., FIGS. 3B & 9A-9B.

In an embodiment, the body 9105 and/or a filter 3130, 9130 of the drilling mud screen 330, 940a may have a tapered drilling mud flow path from a larger inner diameter to a smaller inner diameter to reduce washing (i.e., erosion) of the drilling mud screen 330, 940a.

In an embodiment, the first inner diameter 3195 of the first end 9110 of the body 3105, 9105 of the drilling mud screen 330, 940a may be from about 3-inches to about 5-inches, and any range or value there between. In an embodiment, the first inner diameter 3195 of the first end 9110 of the body 3105, 9105 may be about 3.5-inches or about 4-inches. See e.g., FIGS. 3B & 9A-9B.

In an embodiment, an inner diameter of an outlet of the first portion 9170 and an inlet of the second portion 9175 of the body 9105 may be from about 3-inches to about 5-inches, and any range or value there between. In an embodiment, the inner diameter of the outlet of the first portion 9175 of the body 9105 and the inlet of the second portion 9170 of the body 9105 may be about 3.5-inches or about 4-inches.

In an embodiment, the second inner diameter 3190 of the second end 9115 of the body 3105, 9105 of the drilling mud screen 330, 940a may be from about 3-inches to about 5-inches, and any range or value there between. In an embodiment, the second inner diameter 3190 of the second end 3115 of the body 3105, 9105 may be about 4-inches. See e.g., FIGS. 3B & 9A-9B.

In an embodiment, the outer surface 3200 of the body 3105, 9105 of the drilling mud screen 330, 940a may be sealed against an inner surface of the assembly body 305, 905 via an O-ring. See e.g., FIGS. 3B & 9A-9B. Any suitable O-ring may be used. For example, suitable O-rings include, but are not limited to, 300 Series O-rings. O-rings are well known in the art.

In an embodiment, the filter 3130, 9130 may have a plurality of rods spaced a distance apart to form a filter, a plurality of rods spaced apart to form a frame, and a wire wrap wrapped around the frame and spaced a distance apart to form a wire wrap filter 3160, a formed sheet having drilled holes spaced a distance apart to form a filter and/or a formed sheet having drilled holes spaced a distance apart to form a perforated shell 3165. In an embodiment, the plurality of rods may be tapered from a larger outer diameter to a smaller outer diameter to encourage drilling mud flow to enter in straight lines through the drilling mud inlet 9120 (i.e., through flow passages between the plurality rods) to reduce washing (i.e., erosion) of the drilling mud screen 330, 940a. In an embodiment, the filter 3130, 9130 may have a plurality of straight rows of holes drilled in a formed sheet to encourage drilling mud flow to enter in straight rows of strings through the drilling mud inlet 9120 (i.e., through straight flow passages of the drilled holes) to reduce washing (i.e., erosion) of the drilling mud screen 330, 940a. See e.g., FIGS. 3B-3E & 9A-9B.

In an embodiment, a first end of a filter 9130 may be connected to a second end of the end cap 935 via a connection; and a second end of a filter 9130 may be connected to a first end 9110 of the body 9105 via a connection. Any suitable connections may be used for the end cap 935, body 9105 and filter 9130. For example, suitable connections include, but are not limited to, welds. Connections are well known in the art. In an embodiment, the first end of the filter 9130 may be connected to the second end of the end cap 935 via a weld; and a second end of the filter 9130 may be connected to a first end 9110 of the body 9105 via a weld.

In an embodiment, the end cap 935 of the drilling mud screen 940a has an outer surface. In an embodiment, the outer surface of the end cap 935 of the drilling mud screen 940a may redirect the flow to reduce washing (i.e., erosion) of the drilling mud screen 940a. In an embodiment, the outer surface of the end cap 935 of the drilling mud screen 940a forms an inverted cone relative to the first end 9110 of the body 9105 of the drilling mud screen 940a (i.e., an upstream pointing cone) to redirect the flow. In an embodiment, the tip of the inverted cone may have a rounded or squared shape.

In an embodiment, the body 3105, 9105 of the drilling mud screen 330, 940a has a centerline 3140 and a length 3145. In an embodiment, the centerline 3140 extends through the center of the drilling mud screen outlet 9125 to the end cap 935. In an embodiment, the centerline 3140 of the body 3105, 9105 of the drilling mud screen 330, 940a and the outer surface of the end cap 935 form an angle. In an embodiment, the angle may be from about 30-degrees to about 90-degrees, and any range or value there between. In an embodiment, the angle may be about 45-degrees.

In an embodiment, the end cap 935 of the drilling mud screen 940a may be constructed of any suitable material. For example, suitable materials include, but are not limited to, any alloy steel or tool steel. In an embodiment, the end cap 935 may be constructed of 304 stainless steel material or equivalent material. In an embodiment, the end cap 935 may be constructed of AISI 4155 or equivalent material. In an embodiment, the end cap 935 may be constructed of tool steel or equivalent material.

In an embodiment, the end cap 935 of the drilling mud screen 940a may have a hardened coating to reduce washing (i.e., erosion) of the drilling mud screen 940a. For example, suitable hardened coatings include, but are not limited to, any Carbide coating or equivalent. In an embodiment, the end cap 935 may have a Carbide coating with about 6% Cobalt binder or equivalent material.

In an embodiment, the filter 9130 of the drilling mud screen 940a may be constructed of any suitable material. For example, suitable materials include, but are not limited to, any alloy steel or tool steel. In an embodiment, the filter 9130 may be constructed of 304 stainless steel material. In an embodiment, the filter 9130 may be constructed of AISI 4145 or equivalent material. In an embodiment, the filter 9130 may be constructed of D2 tool steel or equivalent material.

In an embodiment, the filter 9130 may have a hardened coating to reduce washing (i.e., erosion) of the drilling mud screen 940a. For example, suitable hardened coatings include, but are not limited to, any Carbide coating or equivalent. In an embodiment, the filter 9130 may have a Carbide coating with about 6% Cobalt binder or equivalent material.

Optional Flow Loop Configuration

In an embodiment, two or more multi-screen drilling mud screen systems may be used in an optional flow loop configuration to create a redundancy, reduce number of gate valves, and/or to increase through put.

In an embodiment, the flow loop configuration may have a first side and a second side. In an embodiment, the first side may be set up for drilling operations; and the second side may be set up for completion operations.

In an embodiment, the flow loop configuration may have a by-pass. In an embodiment, the by-pass bypasses all of the multi-screen drilling mud screen system.

In an embodiment, a first transducer may be fluidly connected to a drilling mud or completion fluid inlet of the flow loop configuration; and a second transducer may be fluidly connected to a drilling mud or completion fluid outlet of the flow loop configuration to monitor a pressure drop across one or more multi-screen drilling mud screen systems. In an embodiment, the pressure drop indicates when one or more drilling mud screens may need to be replaced in the one or more multi-screen drilling mud screen system.

FIG. 4A illustrates an upper, left perspective view of a multi-screen drilling mud screen system 100, 200, 800, 900 in a flow loop configuration 400, showing two multi-screen drilling mud screen systems 100, 200, 800, 900; FIG. 4B illustrates a front view of the flow loop configuration 400 of FIG. 4A; FIG. 4C illustrates a right-side view of the flow loop configuration 400 of FIGS. 4A-4B; and FIG. 4D illustrates a top view of the flow loop configuration 400 of FIGS. 4A-4C.

As shown in FIGS. 4A-4D, the flow loop configuration 400 comprises a first drilling mud manifold 405 having a first drilling mud or completion fluid inlet 410, a first drilling mud or completion fluid outlet 415a, a second drilling mud or completion fluid outlet 415b and a third drilling mud or completion fluid outlet 415c, a first spool 420 having a first drilling mud or completion fluid inlet 425 and a first drilling mud or completion fluid outlet 430, a second drilling mud manifold 435 having a second drilling mud or completion fluid inlet 440, a second drilling mud or completion fluid outlet 445, a second spool 450 having a second drilling mud or completion fluid inlet 455 and a second drilling mud or completion fluid outlet 460, a third drilling mud manifold 465 having a third drilling mud or completion fluid inlet 470, a third drilling mud or completion fluid outlet 475, a first gate valve 480 having a first drilling mud or completion fluid inlet 485 and a first drilling mud or completion fluid outlet 490, a second gate valve 495 having a second drilling mud or completion fluid inlet 4100 and a second drilling mud or completion fluid outlet 4105, a fourth drilling mud manifold 4110 having a fourth drilling mud or completion fluid inlet 4115 and a fourth drilling mud completion fluid outlet 4120, a fifth drilling mud manifold 4125 having a fifth drilling mud or completion fluid inlet 4130 and a fifth drilling mud or completion fluid outlet 4135, a first drilling mud screen system 100, 200, 4140, 800, 900 having a first drilling mud or completion fluid inlet 120a, 220a, 4145, 820a, 920a and a first drilling mud or completion fluid outlet 125b, 225b, 4150, 825b, 925b, a second drilling mud screen system 100, 200, 4155, 800, 900 having a second drilling mud or completion fluid inlet 120a, 220a, 4160, 820a, 920a and a second drilling mud or completion fluid outlet 125b, 225b, 4165, 825b, 925b, a third spool 4170 having a third drilling mud or completion fluid inlet 4175 and a third drilling mud or completion fluid outlet 4180, a third gate valve 4185 having a third drilling mud or completion fluid inlet 4190 and a third drilling mud or completion fluid outlet 4195, a sixth drilling mud manifold 4200 having a sixth drilling mud or completion fluid inlet 4205 and a sixth drilling mud or completion fluid outlet 4210, a seventh drilling mud manifold 4215 having a seventh drilling mud or completion fluid inlet 4220 and a seventh drilling mud or completion fluid outlet 4225, a fourth gate valve 4230 having a fourth drilling mud or completion fluid inlet 4235 and a fourth drilling mud or completion fluid outlet 4240, a fifth gate valve 4245 having a fifth drilling mud or completion fluid inlet 4250 and a fifth drilling mud or completion fluid outlet 4255, an eighth drilling mud manifold 4260 having an eighth drilling mud or completion fluid inlet 4265 and an eighth drilling mud or completion fluid outlet 4270, a ninth drilling mud manifold 4275 having a ninth drilling mud or completion fluid inlet 4280 and a ninth drilling mud or completion fluid outlet 4285, a fourth spool 4290 having a fourth drilling mud or completion fluid inlet 4295 and a fourth drilling mud or completion fluid outlet 4300, a fifth spool 4305 having a fifth drilling mud or completion fluid inlet 4310 and a fifth drilling mud or completion fluid outlet 4315, a tenth drilling mud manifold 4320 having a first drilling mud or completion fluid inlet 4325a, a second drilling mud or completion fluid inlet 4325b, a third drilling mud or completion fluid inlet 3225c and a tenth drilling mud or completion fluid outlet 4330, a sixth spool 4335 having a sixth drilling mud or completion fluid inlet 4340 and a sixth drilling mud or completion fluid outlet 4345.

In an embodiment, the drilling mud or completion fluid inlet 410 may be fluidly connected to, for example, an outlet of a drilling mud pump via a connection; and the drilling mud or completion fluid outlet 4330 may be fluidly connected to an inlet of a vibrator hose via a connection. Any suitable connection may be used for the drilling mud or completion fluid inlet 410 and drilling mud or completion fluid outlet 4330. For example, suitable connections include, but are not limited to, pipe fittings and welds. Connections are well known in the art. In an embodiment, the drilling mud or completion fluid inlet 410 may be fluidly connected to, for example, an outlet of a drilling mud pump via a weld; and the drilling mud or completion fluid outlet 4330 may be fluidly connected to an inlet of a vibrator hose via a weld.

In an embodiment, the flow loop configuration 400 comprises a first stub connection 4370 from, for example, an outlet of a drilling mud pump to a first drilling mud or completion fluid inlet 410 of a first drilling mud manifold 405.

In an embodiment, the flow loop configuration 400 comprises a second stub connection 4375 from, for example, a tenth drilling mud or completion fluid outlet 4330 of a tenth drilling mud manifold 4320 to an inlet of a vibrator hose.

In an embodiment, the first stub connection 4370 may be fluidly connected to a first drilling mud or completion fluid inlet 410 of the first drilling mud manifold 405 by a connection. Any suitable connection may be used for the first stub connection 4370 and the first drilling mud or completion fluid inlet 410 of the first drilling mud manifold 405. For example, suitable connections include, but are not limited to, flanges and pipe fittings. Connections are well known in the art.

In an embodiment, the first stub connection 4370 may have an integral flange at the first drilling mud or completion fluid inlet and/or the first drilling mud or completion fluid outlet.

In an embodiment, the first drilling mud manifold 405 may have an integral flange at the first drilling mud or completion fluid inlet 410.

In an embodiment, the first drilling mud or completion fluid outlet 415a of the first drilling mud manifold 405 may be fluidly connected to the first spool 420 by a connection. Any suitable connection may be used for the first drilling mud or completion fluid outlet 415a of the first drilling mud manifold 405 and the first spool 420. For example, suitable connections include, but are not limited to, flanges and pipe fittings. Connections are well known in the art.

In an embodiment, the first drilling mud manifold 405 may have an integral flange at the first drilling mud or completion fluid outlet 415a.

In an embodiment, the first spool 420 may have an integral flange at the first drilling mud or completion fluid inlet 425 and/or the first drilling mud or completion fluid outlet 430.

In an embodiment, the first drilling mud or completion fluid outlet 430 of the first spool 420 may be fluidly connected to the second drilling mud or completion fluid inlet 440 of the second drilling mud manifold 435 by a connection. Any suitable connection may be used for the first drilling mud or completion fluid outlet 430 of the first spool 420 and the second drilling mud or completion fluid inlet 440 of the second manifold 435. For example, suitable connections include, but are not limited to, flanges and pipe fittings. Connections are well known in the art.

In an embodiment, the first spool 420 may have an integral flange at the first drilling mud or completion fluid inlet 425 and/or the first drilling mud or completion fluid outlet 430.

In an embodiment, the second drilling mud manifold 435 may have an integral flange at the second drilling mud or completion fluid inlet 440 and/or the second drilling mud or completion fluid outlet 445.

In an embodiment, the second drilling mud or completion fluid outlet 445 of the second drilling mud manifold 435 may be fluidly connected to the second spool 450 by a connection. Any suitable connection may be used for the second drilling mud or completion fluid outlet 445 of the second drilling mud manifold 435 and the second spool 450. For example, suitable connections include, but are not limited to, flanges and pipe fittings. Connections are well known in the art.

In an embodiment, the second drilling mud manifold 435 may have an integral flange at the second drilling mud or completion fluid inlet 440 and/or the second drilling mud or completion fluid outlet 445.

In an embodiment, the second spool 450 may have an integral flange at the second drilling mud or completion fluid inlet 455 and/or the second drilling mud or completion fluid outlet 460.

In an embodiment, the second drilling mud or completion fluid outlet 460 of the second spool 450 may be fluidly connected to the third drilling mud or completion fluid inlet 470 of the third drilling mud manifold 465 by a connection. Any suitable connection may be used for the second drilling mud or completion fluid outlet 460 of the second spool 450 and the third drilling mud or completion fluid inlet 470 of the third drilling mud manifold 465. For example, suitable connections include, but are not limited to, flanges and pipe fittings. Connections are well known in the art.

In an embodiment, the second spool 450 may have an integral flange at the second drilling mud or completion fluid inlet 455 and/or the second drilling mud or completion fluid outlet 460.

In an embodiment, the third drilling mud manifold 465 may have an integral flange at the third drilling mud or completion fluid inlet 470 and/or the third drilling mud or completion fluid outlet 475.

In an embodiment, the third drilling mud or completion fluid outlet 415c of the first drilling mud manifold 405 may be connected to the third spool 4170 by a connection. Any suitable connection may be used for the third drilling mud or completion fluid outlet 415c of the first drilling mud manifold 405 and the third spool 4170. For example, suitable connections include, but are not limited to, flanges and pipe fittings. Connections are well known in the art.

In an embodiment, the first drilling mud manifold 405 may have an integral flange at the third drilling mud or completion fluid outlet 415c.

In an embodiment, the third spool 4170 may have an integral flange at the third drilling mud or completion fluid inlet 4175 and/or the third drilling mud or completion fluid outlet 4180.

In an embodiment, the second drilling mud or completion fluid outlet 445 of the second drilling mud manifold 435 may be fluidly connected to the first gate valve 480 by a connection. Any suitable connection may be used for the second drilling mud or completion fluid outlet 445 of the second drilling mud manifold 435 and the first gate valve 480. For example, suitable connections include, but are not limited to, flanges and pipe fittings. Connections are well known in the art.

In an embodiment, the second drilling manifold 435 may have an integral flange at the second drilling mud or completion fluid inlet 440 and/or the second drilling mud or completion fluid outlet 445.

In an embodiment, the first gate valve 480 may have an integral flange at the first drilling mud or completion fluid inlet 485 and/or the first drilling mud or completion fluid outlet 490.

In an embodiment, the third drilling mud or completion fluid outlet 475 of the third drilling mud manifold 465 may be fluidly connected to the second gate valve 495 by a connection. Any suitable connection may be used for the third drilling mud or completion fluid outlet 475 of the third drilling mud manifold 465 and the second gate valve 495. For example, suitable connections include, but are not limited to, flanges and pipe fittings. Connections are well known in the art.

In an embodiment, the third drilling mud manifold 465 may have an integral flange at the third drilling mud or completion fluid inlet 470 and the third drilling mud or completion fluid outlet 475.

In an embodiment, the second gate valve 495 may have an integral flange at the second drilling mud or completion fluid inlet 4100 and/or the second drilling mud or completion fluid outlet 4105.

In an embodiment, the first gate valve 480 may be fluidly connected to the fourth drilling mud or completion fluid inlet 4115 of the fourth drilling mud manifold 4110 by a connection. Any suitable connection may be used for the first gate valve 480 and the fourth drilling mud or completion fluid inlet 4115 of the fourth drilling mud manifold 4110. For example, suitable connections include, but are not limited to, flanges and pipe fittings. Connections are well known in the art.

In an embodiment, the first gate valve 480 may have an integral flange at the first drilling mud or completion fluid inlet 485 and/or the first drilling mud or completion fluid outlet 490.

In an embodiment, the fourth drilling mud manifold 4110 may have an integral flange at the fourth drilling mud or completion fluid inlet 4115 and/or the fourth drilling mud or completion fluid outlet 4120.

In an embodiment, the second gate valve 495 may be fluidly connected to the fifth drilling mud or completion fluid inlet 4130 of the fifth drilling mud manifold 4125 by a connection. Any suitable connection may be used for the second gate valve 495 and the fifth drilling mud or completion fluid inlet 4130 of the fifth drilling mud manifold 4125. For example, suitable connections include, but are not limited to, flanges and pipe fittings. Connections are well known in the art.

In an embodiment, the second gate valve 495 may have an integral flange at the second drilling mud or completion fluid inlet 4100 and/or the second drilling mud or completion fluid outlet 4105.

In an embodiment, the fifth drilling mud manifold 4125 may have an integral flange at the fifth drilling mud or completion fluid inlet 4130 and/or the fifth drilling mud or completion fluid outlet 4135.

In an embodiment, the fourth drilling mud or completion fluid outlet 4120 of the fourth drilling mud manifold 4110 may be fluidly connected to the first drilling mud or completion fluid inlet 120a, 220a, 4145, 820a, 920a of the first drilling mud screen system 100, 200, 4140, 800, 900 by a connection. Any suitable connection may be used for the fourth drilling mud or completion fluid outlet 4120 of the fourth drilling mud manifold 4110 and the first drilling mud or completion fluid inlet 120a, 220a, 4145, 820a, 920a of the first drilling mud screen system 100, 200, 4140, 800, 900. For example, suitable connections include, but are not limited to, flanges and pipe fittings. Connections are well known in the art.

In an embodiment, the fourth drilling mud manifold 4110 may have an integral flange at the fourth drilling mud or completion fluid inlet 4115 and/or the fourth drilling mud or completion fluid outlet 4120.

In an embodiment, the flow loop configuration 400 comprises a first cross-over connection 4350 from a fourth drilling mud manifold 4110 to a first drilling mud screen system 100, 200, 4140, 800, 900.

In an embodiment, the first cross-over connection 4350 may have an integral flange at a first drilling mud or completion fluid inlet and/or a first drilling mud or completion fluid outlet.

In an embodiment, the fifth drilling mud or completion fluid outlet 4135 of the fifth drilling mud manifold 4125 may be fluidly connected to the second drilling mud or completion fluid inlet 120a, 220a, 4160, 820a, 920a of the second drilling mud screen system 100, 200, 4155, 800, 900 by a connection. Any suitable connection may be used for the fifth drilling mud or completion fluid outlet 4135 of the fifth drilling mud manifold 4125 and the second drilling mud or completion fluid inlet 120a, 220a, 4160, 820a, 920a of the second drilling mud screen system 100, 200, 4155, 800, 900. For example, suitable connections include, but are not limited to, flanges and pipe fittings. Connections are well known in the art.

In an embodiment, the fifth drilling mud manifold 4125 may have an integral flange at the fifth drilling mud or completion fluid inlet 4130 and/or the fifth drilling mud or completion fluid outlet 4135.

In an embodiment, the flow loop configuration 400 comprises a second cross-over connection 4355 from a fifth drilling mud manifold 4125 to a second drilling mud screen system 100, 200, 4155, 800, 900.

In an embodiment, the second cross-over connection 4355 may have an integral flange at the second drilling mud or completion fluid inlet and/or the second drilling mud or completion fluid outlet.

In an embodiment, the first drilling mud or completion fluid outlet 125b, 225b, 4150, 825b, 925b of the first drilling mud screen system 100, 200, 4140, 800, 900 may be fluidly connected to the sixth drilling mud or completion fluid inlet 4205 of the sixth drilling mud manifold 4200 by a connection. Any suitable connection may be used for the first drilling mud or completion fluid outlet 125b, 225b, 4150, 825b, 925b of the first drilling mud screen system 100, 200, 4140, 800, 900 and the sixth drilling mud or completion fluid inlet 4205 of the sixth drilling mud manifold 4200. For example, suitable connections include, but are not limited to, flanges and pipe fittings. Connections are well known in the art.

In an embodiment, the flow loop configuration 400 comprises a third cross-over connection 4360 from a first drilling mud screen system 100, 200, 4140, 800, 900 to a sixth drilling mud manifold 4200.

In an embodiment, the third cross-over connection 4360 may have an integral flange at the third drilling mud or completion fluid inlet and/or the third drilling mud or completion fluid outlet.

In an embodiment, the sixth drilling mud manifold 4200 may have an integral flange at the sixth drilling mud or completion fluid inlet 4205 and/or the sixth drilling mud or completion fluid outlet 4210.

In an embodiment, the second drilling mud or completion fluid outlet 125b, 225b, 4165, 825b, 925b of the second drilling mud screen system 100, 200, 4155, 800, 900 may be fluidly connected to the seventh drilling mud or completion fluid inlet 4220 of the seventh drilling mud manifold 4215 by a connection. Any suitable connection may be used for the second drilling mud or completion fluid outlet 125b, 225b, 4165, 825b, 925b of the second drilling mud screen system 100, 200, 4155, 800, 900 and the seventh drilling mud or completion fluid inlet 4220 of the seventh drilling mud manifold 4215. For example, suitable connections include, but are not limited to, flanges and pipe fittings. Connections are well known in the art.

In an embodiment, the flow loop configuration 400 comprises a fourth cross-over connection 4365 from a second drilling mud screen system 100, 200, 4155, 800, 900 to a seventh drilling mud manifold 4215.

In an embodiment, the fourth cross-over connection 4365 may have an integral flange at the fourth drilling mud or completion fluid outlet and/or the fourth drilling mud or completion fluid outlet.

In an embodiment, the seventh drilling mud manifold 4215 may have an integral flange at the seventh drilling mud or completion fluid inlet 4220 and/or the seventh drilling mud or completion fluid outlet 4225.

In an embodiment, the third spool 4170 is fluidly connected to the third gate valve 4185 by a connection. Any suitable connection may be used for the third spool 4170 and the third gate valve 4185. For example, suitable connections include, but are not limited to, flanges and pipe fittings. Connections are well known in the art.

In an embodiment, the third spool 4170 may have an integral flange at the third drilling mud or completion fluid inlet 4175 and/or the third drilling mud or completion fluid outlet 4180.

In an embodiment, the third gate valve 4185 may have an integral flange at the third drilling mud or completion fluid inlet 4190 and/or the third drilling mud or completion fluid outlet 4195.

In an embodiment, the sixth drilling mud or completion fluid outlet 4210 of the sixth drilling mud manifold 4200 may be fluidly connected to the fourth gate valve 4230 by a connection. Any suitable connection may be used for the sixth drilling mud or completion fluid outlet 4210 of the sixth drilling mud manifold 4200 and the fourth gate valve 4230. For example, suitable connections include, but are not limited to, flanges and pipe fittings. Connections are well known in the art.

In an embodiment, the sixth drilling mud manifold 4200 may have an integral flange at the sixth drilling mud or completion fluid inlet 4205 and/or the sixth drilling mud or completion fluid outlet 4210.

In an embodiment, the fourth gate valve 4230 may have an integral flange at the fourth drilling mud or completion fluid inlet 4235 and/or the fourth drilling mud or completion fluid outlet 4240.

In an embodiment, the seventh drilling mud or completion fluid outlet 4225 of the seventh drilling mud manifold 4215 may be fluidly connected to the fifth gate valve 4245 by a connection. Any suitable connection may be used for the seventh drilling mud or completion fluid outlet 4225 of the seventh drilling mud manifold 4215 and the fifth gate valve 4245. For example, suitable connections include, but are not limited to, flanges and pipe fittings. Connections are well known in the art.

In an embodiment, the seventh drilling mud manifold 4215 may have an integral flange at the seventh drilling mud or completion fluid inlet 4220 and/or the seventh drilling mud or completion fluid outlet 4225.

In an embodiment, the fifth gate valve 4245 may have an integral flange at the fifth drilling mud or completion fluid inlet 4250 and/or the fifth drilling mud or completion fluid outlet 4255.

In an embodiment, the fourth gate valve 4230 may be fluidly connected to the eighth drilling mud or completion fluid inlet 4265 of the eight drilling mud manifold 4260 by a connection. Any suitable connection may be used for the fourth gate valve 4230 and the eighth drilling mud or completion fluid inlet 4265 of the eighth drilling mud manifold 4260. For example, suitable connections include, but are not limited to, flanges and pipe fittings. Connections are well known in the art.

In an embodiment, the fourth gate valve 4230 may have an integral flange at the fourth drilling mud or completion fluid inlet 4235 and/or the fourth drilling mud or completion fluid outlet 4240.

In an embodiment, the eighth drilling mud manifold 4260 may have an integral flange at the eighth drilling mud or completion fluid inlet 4265 and/or the eight drilling mud or completion fluid outlet 4270.

In an embodiment, the fifth gate valve 4245 may be fluidly connected to the ninth drilling mud or completion fluid inlet 4280 of the ninth drilling mud manifold 4275 by a connection. Any suitable connection may be used for the fifth gate valve 4245 and the ninth drilling mud or completion fluid inlet 4280 of the ninth drilling mud manifold 4275. For example, suitable connections include, but are not limited to, flanges and pipe fittings. Connections are well known in the art.

In an embodiment, the fifth gate valve 4245 may have an integral flange at the fifth drilling mud or completion fluid inlet 4250 and/or the fifth drilling mud or completion fluid outlet 4255.

In an embodiment, the ninth drilling mud manifold 4275 may have an integral flange at the ninth drilling mud or completion fluid inlet 4280 and/or the ninth drilling mud or completion fluid outlet 4285.

In an embodiment, the eighth drilling mud or completion fluid outlet 4270 of the eighth drilling mud manifold 4260 may be fluidly connected to the fourth spool 4290 by a connection. Any suitable connection may be used for the eighth drilling mud or completion fluid outlet 4270 of the eighth drilling mud manifold 4260 and the fourth spool 4290. For example, suitable connections include, but are not limited to, flanges and pipe fittings. Connections are well known in the art.

In an embodiment, the eighth drilling mud manifold 4260 may have an integral flange at the eighth drilling mud or completion fluid inlet 4265 and/or the eighth drilling mud or completion fluid outlet 4270.

In an embodiment, the fourth spool 4290 may have an integral flange at the fourth drilling mud or completion fluid inlet 4295 and/or the fourth drilling mud or completion fluid outlet 4300.

In an embodiment, the ninth drilling mud or completion fluid outlet 4285 of the ninth drilling mud manifold 4275 may be fluidly connected to the fifth spool 4305 by a connection. Any suitable connection may be used for the ninth drilling mud or completion fluid outlet 4285 of the ninth drilling mud manifold 4275 and the fifth spool 4305. For example, suitable connections include, but are not limited to, flanges and pipe fittings. Connections are well known in the art.

In an embodiment, the ninth drilling mud manifold 4275 may have an integral flange at the ninth drilling mud or completion fluid inlet 4280 and/or the ninth drilling mud or completion fluid outlet 4285.

In an embodiment, the fifth spool 4305 may have an integral flange at the fifth drilling mud or completion fluid inlet 4310 and/or the fifth drilling mud or completion fluid outlet 4315.

In an embodiment, the fourth spool 4290 may be fluidly connected to the first drilling mud or completion fluid inlet 4325a of a tenth drilling mud manifold 4320 via a connection. Any suitable connection may be used for the fourth spool 4290 and the tenth drilling mud or completion fluid inlet 4325a of the tenth drilling mud manifold 4320. For example, suitable connections include, but are not limited to, flanges and pipe fittings. Connections are well known in the art.

In an embodiment, the fourth spool 4290 may have an integral flange at the fourth drilling mud or completion fluid inlet 4295 and/or the fourth drilling mud or completion fluid outlet 4300.

In an embodiment, the tenth drilling mud manifold 4320 may have an integral flange at the first drilling mud or completion fluid inlet 4325a.

In an embodiment, the fifth spool 4305 may be fluidly connected to the second drilling mud or completion fluid outlet 4325b of the tenth drilling mud manifold 4320 via a connection. Any suitable connection may be used for the fifth spool 4305 and the second drilling mud or completion fluid outlet 4325b of the tenth drilling mud manifold 4320. For example, suitable connections include, but are not limited to, flanges and pipe fittings. Connections are well known in the art.

In an embodiment, the fifth spool 4305 may have an integral flange at the fifth drilling mud or completion fluid inlet 4310 and/or the fifth drilling mud or completion fluid outlet 4315.

In an embodiment, the tenth drilling mud manifold 39380, 40380 may have an integral flange at the second drilling mud or completion fluid inlet 4325b.

In an embodiment, the third gate valve 4185 may be fluidly connected to the sixth spool 4335 by a connection. Any suitable connection may be used for the third gate valve 4185 and the sixth spool 4335. For example, suitable connections include, but are not limited to, flanges and pipe fittings. Connections are well known in the art.

In an embodiment, the third gate valve 4185 may have an integral flange at the third drilling mud or completion fluid inlet 4190 and/or the third drilling mud or completion fluid outlet 4195.

In an embodiment, the sixth spool 4335 may have an integral flange at the sixth drilling mud or completion fluid inlet 4340 and/or the sixth drilling mud or completion fluid outlet 4345.

In an embodiment, the sixth spool 4335 may be fluidly connected to the third drilling mud or completion fluid inlet 4325c of the tenth drilling mud manifold 4320 by a connection. Any suitable connection may be used for the sixth spool 4335 and the third drilling mud or completion fluid inlet 4225c of the tenth drilling mud manifold 4320. For example, suitable connections include, but are not limited to, flanges and pipe fittings. Connections are well known in the art.

In an embodiment, the sixth spool 4335 may have an integral flange at the sixth drilling mud or completion fluid inlet 4340 and/or the sixth drilling mud or completion fluid outlet 4345.

In an embodiment, the tenth drilling mud manifold 4320 may have an integral flange at the third drilling mud or completion fluid inlet 4325c.

In an embodiment, the second stub connection 4375 may be fluidly connected to the tenth drilling mud or completion fluid outlet 4330 of the tenth drilling mud manifold 4320 by a connection. Any suitable connection may be used for the second stub connection 4375 and the tenth drilling mud or completion fluid outlet 4330 of the tenth drilling mud manifold 4320. For example, suitable connections include, but are not limited to, flanges and pipe fittings. Connections are well known in the art.

In an embodiment, the second stub connection 4375 may have an integral flange at a second drilling mud or completion fluid inlet and/or a second drilling mud or completion fluid outlet.

In an embodiment, the tenth drilling mud manifold 4320 may have an integral flange at the tenth drilling mud or completion fluid outlet 4330.

Alternative Flow Loop Configuration

In an embodiment, two or more multi-screen drilling mud screen systems may be used in an alternative flow loop configuration to create a redundancy, further reduce number of gate valves, and/or to increase through put.

In an embodiment, the flow loop configuration may have a first side and a second side. In an embodiment, the first side may be set up for drilling operations; and the second side may be set up for completion operations.

In an embodiment, the flow loop configuration may have a by-pass. In an embodiment, the by-pass bypasses all of the multi-screen drilling mud screen system.

In an embodiment, a first transducer may be fluidly connected to a drilling mud or completion fluid inlet of the flow loop configuration; and a second transducer may be fluidly connected to a drilling mud or completion fluid outlet of the flow loop configuration to monitor a pressure drop across one or more multi-screen drilling mud screen systems. In an embodiment, the pressure drop indicates when one or more drilling mud screens may need to be replaced in the one or more multi-screen drilling mud screen system.

FIG. 5A illustrates an upper, left perspective view of a multi-screen drilling mud screen systems 100, 200, 800, 900 in an alternative flow loop configuration 500, showing a pair of multi-screen drilling mud screen systems 100, 200, 800, 900; FIG. 5B illustrates a front view of the alternative flow loop configuration 500 of FIG. 5A; FIG. 5C illustrates a right-side view of the alternative flow loop configuration 500 of FIGS. 5A-5B; FIG. 5D illustrates a top view of the alternative flow loop configuration 500 of FIGS. 5A-5C, showing the pair of multi-screen drilling mud screen systems 100, 200, 800, 900 in the closed position; and FIG. 5E illustrates a top view of the alternative flow loop configuration 500 of FIGS. 5A-5D, showing the pair of multi-screen drilling mud screen systems 100, 200, 800 in the open position.

As shown in FIGS. 5A-5E, the flow loop configuration 500 comprises a first drilling mud manifold 505 having a first drilling mud or completion fluid inlet 510 and a first drilling mud or completion fluid outlet 515a, a second drilling mud or completion fluid outlet 515b, a third drilling mud or completion fluid outlet 515c, a first gate valve 520 having a first drilling mud or completion fluid inlet 525 and a first drilling mud or completion fluid outlet 530, a second gate valve 535 having a second drilling mud or completion fluid inlet 540 and a second drilling mud or completion fluid outlet 545, a third gate valve 550 having a third drilling mud or completion fluid inlet 550 and a third drilling mud or completion fluid outlet 560, a first drilling mud union 565 having a first drilling mud or completion fluid inlet 570 and a first drilling mud or completion fluid outlet 575, a second drilling mud union 580 having a second drilling mud or completion fluid inlet 585 and a second drilling mud or completion fluid outlet 590, a first spool 595, having a first drilling mud or completion fluid inlet 5100 and a first drilling mud or completion fluid outlet 5105, a first multi-screen drilling mud screen system 100, 200, 5110, 800, 900 having a first drilling mud or completion fluid inlet 120a, 220a, 5115, 820a, 920a and a first drilling mud or completion fluid outlet 125b, 225b, 5120, 825b, 925b, a second drilling mud screen system 100, 200, 5125, 800, 900 having a second drilling mud or completion fluid inlet 120a, 220a, 5130, 820a, 920a and a second drilling mud or completion fluid outlet 125b, 225b, 5135, 825b, 925b, a third drilling mud union 5140 having a third drilling mud or completion fluid inlet 5145 and a third drilling mud or completion fluid outlet 5150, a fourth drilling mud union 5155 having a fourth drilling mud or completion fluid inlet 5160 and a fourth drilling mud or completion fluid outlet 5165, a fourth gate valve 5175 having a fourth drilling mud or completion fluid inlet 5180 and a fourth drilling mud or completion fluid outlet 5185, a fifth gate valve 5190 having a fifth drilling mud or completion fluid inlet 5195 and a fifth drilling mud or completion fluid outlet 5200, a second spool 5205 having a second drilling mud or completion fluid inlet 5210 and a second drilling mud or completion fluid outlet 5215, and a second drilling mud manifold 5220 having a first drilling mud or completion fluid inlet 5225a, a second drilling mud or completion fluid inlet 5225b, a third drilling mud or completion fluid inlet 5225c and a second drilling mud or completion fluid outlet 5230.

In an embodiment, the first drilling mud or completion fluid inlet 510 of the first drilling mud manifold 505 may be fluidly connected to, for example, an outlet of a drilling mud pump via a connection; and the second drilling mud or completion fluid outlet 5230 of the second drilling mud manifold 5220 may be fluidly connected to an inlet of a vibrator hose via a connection. Any suitable connection may be used for the first drilling mud or completion fluid inlet 510 and second drilling mud or completion fluid outlet 5230. For example, suitable connections include, but are not limited to, pipe fittings and welds. Connections are well known in the art. In an embodiment, the first drilling mud or completion fluid inlet 510 may be fluidly connected to, for example, an outlet of a drilling mud pump via a weld; and the second drilling mud or completion fluid outlet 5230 may be fluidly connected to an inlet of a vibrator hose via a weld.

In an embodiment, the flow loop configuration 500 comprises a first stub connection 5255 from, for example, an outlet of a drilling mud pump to a first drilling mud or completion fluid inlet 510 of a first drilling mud manifold 505.

In an embodiment, the flow loop configuration 500 comprises a second stub connection 5260 from, for example, a second drilling mud or completion fluid outlet 5230 of a second drilling mud manifold 5220 to an inlet of a vibrator hose.

In an embodiment, the first stub connection 5255 and the first drilling mud or completion fluid inlet 510 of the first drilling mud manifold 505 may be fluidly connected by a connection. Any suitable connection may be used for the first stub connection 5255 and the first drilling mud or completion fluid inlet 510 of the first drilling mud manifold 505. For example, suitable connections include, but are not limited to, flanges and pipe fittings. Connections are well known in the art.

In an embodiment, the first stub connection 5255 may have an integral flange at a first drilling mud or completion fluid inlet and/or a first drilling mud or completion fluid outlet.

In an embodiment, the first drilling mud manifold 505 may have an integral flange at the first drilling mud or completion fluid inlet 510.

In an embodiment, the first drilling mud or completion fluid outlet 515a of the first drilling mud manifold 505 and the first gate valve 520 may be fluidly connected by a connection. Any suitable connection may be used for the first drilling mud or completion fluid outlet 515a of the first drilling mud manifold 505 and the first gate valve 520. For example, suitable connections include, but are not limited to, flanges and pipe fittings. Connections are well known in the art.

In an embodiment, the first drilling mud manifold 505 may have an integral flange at the first drilling mud or completion fluid outlet 515a.

In an embodiment, the first gate valve 520 may have an integral flange at the first drilling mud or completion fluid inlet 525 and/or the first drilling mud or completion fluid outlet 530.

In an embodiment, the second drilling mud or completion fluid outlet 515b of the first drilling mud manifold 505 and the second gate valve 535 may be fluidly connected by a connection. Any suitable connection may be used for the second drilling mud or completion fluid outlet 515b of the first drilling mud manifold 505 and the second gate valve 535. For example, suitable connections include, but are not limited to, flanges and pipe fittings. Connections are well known in the art.

In an embodiment, the first drilling mud manifold 505 may have an integral flange at the second drilling mud or completion fluid outlet 515b.

In an embodiment, the second gate valve 535 may have an integral flange at the second drilling mud or completion fluid inlet 540 and/or the second drilling mud or completion fluid outlet 545.

In an embodiment, the third drilling mud or completion fluid outlet 515c of the first drilling mud manifold 505 and the third gate valve 550 may be fluidly connected by a connection. Any suitable connection may be used for the third drilling mud or completion fluid outlet 515c of the first drilling mud manifold 505 and the third gate valve 550. For example, suitable connections include, but are not limited to, flanges and pipe fittings. Connections are well known in the art.

In an embodiment, the first drilling mud manifold 505 may have an integral flange at the third drilling mud or completion fluid outlet 515c.

In an embodiment, the third gate valve 550 may have an integral flange at the third drilling mud or completion fluid inlet 555 and/or the third drilling mud or completion fluid outlet 560.

In an embodiment, the third drilling mud or completion fluid outlet 515c of the first drilling mud manifold 505, the first spool 595 and the third gate valve 550 may be fluidly connected by a connection. Any suitable connection may be used for the third drilling mud or completion fluid outlet 515c of the first drilling mud manifold 505, the first spool 595 and the third gate valve 550. For example, suitable connections include, but are not limited to, flanges and pipe fittings. Connections are well known in the art.

In an embodiment, the first drilling mud manifold 505 may have an integral flange at the third drilling mud or completion fluid outlet 515c.

In an embodiment, the first spool 595 may have an integral flange at the first drilling mud or completion fluid inlet 5100 and/or the first drilling mud or completion fluid outlet 5105.

In an embodiment, the third gate valve 550 may have an integral flange at the third drilling mud or completion fluid inlet 555 and/or the third drilling mud or completion fluid outlet 560.

In an embodiment, the first gate valve 520 and the first drilling mud union 565 may be fluidly connected by a connection. Any suitable connection may be used for the first gate valve 520 and the first drilling mud union 565. For example, suitable connections include, but are not limited to, flanges and pipe fittings. Connections are well known in the art.

In an embodiment, the first gate valve 520 may have an integral flange at the first drilling mud or completion fluid inlet 525 and/or the first drilling mud or completion fluid outlet 530.

In an embodiment, the first drilling mud union 565 may have an integral flange at the first drilling mud or completion fluid inlet 570 and/or the first drilling mud or completion fluid outlet 575.

In an embodiment, the second gate valve 535 and the second drilling mud union 580 may be fluidly connected by a connection. Any suitable connection may be used for the second gate valve 535 and the second drilling mud union 580. For example, suitable connections include, but are not limited to, flanges and pipe fittings. Connections are well known in the art.

In an embodiment, the second gate valve 535 may have an integral flange at the second drilling mud or completion fluid inlet 540 and/or the second drilling mud or completion fluid outlet 545.

In an embodiment, the second drilling mud union 580 may have an integral flange at the second drilling mud or completion fluid inlet 585 and/or the second drilling mud or completion fluid outlet 590.

In an embodiment, the third gate valve 550 and the second spool 5205 may be fluidly connected by a connection. Any suitable connection may be used for the third gate valve 550 and the second spool 5205. For example, suitable connections include, but are not limited to, flanges and pipe fittings. Connections are well known in the art.

In an embodiment, the third gate valve 550 may have an integral flange at the third drilling mud or completion fluid inlet 555 and/or the third drilling mud or completion fluid outlet 560.

In an embodiment, the second spool 5205 may have an integral flange at the second drilling mud or completion fluid inlet 5210 and/or the second drilling mud or completion fluid outlet 5215.

In an embodiment, the first drilling mud or completion fluid outlet 575 of the first drilling mud union 565 and the first drilling mud or completion fluid inlet 120a, 220a, 5115, 820a, 920a of the first drilling mud screen system 100, 200, 5110, 800, 900 may be fluidly connected by a connection. Any suitable connection may be used for the first drilling mud or completion fluid outlet 575 of the first drilling mud union 565 and the first drilling mud or completion fluid inlet 120a, 220a, 5115, 820a, 920a of the first drilling mud screen system 100, 200, 5110, 800, 900. For example, suitable connections include, but are not limited to, flanges and pipe fittings. Connections are well known in the art.

In an embodiment, the first drilling mud union 565 may have an integral flange at the first drilling mud or completion fluid inlet 570 and/or the first drilling mud or completion fluid outlet 575.

In an embodiment, the flow loop configuration 500 comprises a first cross-over connection 5235 from a first drilling mud union 565 to a first drilling mud screen system 100, 200, 5110, 800, 900.

In an embodiment, the first cross-over connection 5235 may have an integral flange at a first drilling mud or completion fluid inlet and/or a first drilling mud or completion fluid outlet.

In an embodiment, the second drilling mud or completion fluid outlet 590 of the second drilling mud union 580 and the second drilling mud or completion fluid inlet 120a, 220a, 5130, 820a, 920a of the second drilling mud screen system 100, 200, 5125, 800, 900 may be fluidly connected by a connection. Any suitable connection may be used for the second drilling mud or completion fluid outlet 590 of the second drilling mud union 580 and the second drilling mud or completion fluid inlet 120a, 220a 5130, 820a, 920a of the second drilling mud screen system 100, 200, 5125, 800, 900. For example, suitable connections include, but are not limited to, flanges and pipe fittings. Connections are well known in the art.

In an embodiment, the second drilling mud union 580 may have an integral flange at the second drilling mud or completion fluid inlet 585 and/or the second drilling mud or completion fluid outlet 590.

In an embodiment, the flow loop configuration 500 comprises a second cross-over connection 5240 from a second drilling mud union 580 to a second drilling mud screen system 100, 200, 5125, 800, 900.

In an embodiment, the second cross-over connection 5240 may have an integral flange at a second drilling mud or completion fluid inlet and/or a second drilling mud or completion fluid outlet.

In an embodiment, the first drilling mud or completion fluid outlet 125b, 225b, 5120, 825b, 925b of the first drilling mud screen system 100, 200, 5110, 800, 900 and the third drilling mud or completion fluid inlet 5145 of the third drilling mud union 5140 may be fluidly connected by a connection. Any suitable connection may be used for the first drilling mud or completion fluid outlet 125b, 225b, 5120, 825b, 925b of the first drilling mud screen system 100, 200, 5110, 800, 900 and the third drilling mud or completion fluid inlet 5145 of the third drilling mud union 5140. For example, suitable connections include, but are not limited to, flanges and pipe fittings. Connections are well known in the art.

In an embodiment, the flow loop configuration 500 comprises a third cross-over connection 5245 from a first drilling mud screen system 100, 200, 5110, 800, 900 to a third drilling mud union 5140.

In an embodiment, the third cross-over connection 5245 may have an integral flange at a third drilling mud or completion fluid inlet and/or a third drilling mud or completion fluid outlet.

In an embodiment, the third drilling mud union 5140 may have an integral flange at the third drilling mud or completion fluid inlet 5145 and/or the third drilling mud or completion fluid outlet 5150.

In an embodiment, the second drilling mud or completion fluid outlet 125b, 225b, 5135, 825b, 925b of the second drilling mud screen system 100, 200, 5125, 800, 900 and the fourth drilling mud or completion fluid inlet 5160 of the fourth drilling mud union 5155 may be fluidly connected by a connection. Any suitable connection may be used for the second drilling mud or completion fluid outlet 125b, 225b, 5135, 825b, 925b of the second drilling mud screen system 100, 200, 5125, 800, 900 and the fourth drilling mud or completion fluid inlet 5160 of the fourth drilling mud union 5155. For example, suitable connections include, but are not limited to, flanges and pipe fittings. Connections are well known in the art.

In an embodiment, the flow loop configuration 500 comprises a fourth cross-over connection 5250 from a second drilling mud screen system 100, 200, 5125, 800, 900 to a fourth drilling mud union 5155.

In an embodiment, the fourth cross-over connection 5250 may have an integral flange at a fourth drilling mud or completion fluid inlet and/or a fourth drilling mud or completion fluid outlet.

In an embodiment, the third drilling mud union 5140 and the fourth gate valve 5175 may be fluidly connected by a connection. Any suitable connection may be used for the third drilling mud union 5140 and the fourth gate valve 5175. For example, suitable connections include, but are not limited to, flanges and pipe fittings. Connections are well known in the art.

In an embodiment, the third drilling mud union 5140 may have an integral flange at the third drilling mud or completion fluid inlet 5145 and/or the third drilling mud or completion fluid outlet 5150.

In an embodiment, the fourth gate valve 5175 may have an integral flange at a fourth drilling mud or completion fluid inlet 5180 and/or a fourth drilling mud or completion fluid outlet 5185.

In an embodiment, the fourth drilling mud union 5155 and the fifth gate valve 5190 may be fluidly connected by a connection. Any suitable connection may be used for the fourth drilling mud union 5155 and the fifth gate valve 5190. For example, suitable connections include, but are not limited to, flanges and pipe fittings. Connections are well known in the art.

In an embodiment, the fourth drilling mud union 5155 may have an integral flange at the fourth drilling mud or completion fluid inlet 5160 and/or the fourth drilling mud or completion fluid outlet 5165.

In an embodiment, the fifth gate valve 5190 may have an integral flange at a fifth drilling mud or completion fluid inlet 5195 and/or a fifth drilling mud or completion fluid outlet 5200.

In an embodiment, the fourth gate valve 5175 and the first drilling mud or completion fluid inlet 5225a of the second drilling mud manifold 5220 may be fluidly connected by a connection. Any suitable connection may be used for the fourth gate valve 5175 and the first drilling mud or completion fluid inlet 5225a of the second drilling mud manifold 5220. For example, suitable connections include, but are not limited to, flanges and pipe fittings. Connections are well known in the art.

In an embodiment, the fourth gate valve 5175 may have an integral flange at a fourth drilling mud or completion fluid inlet 5180 and/or a fourth drilling mud or completion fluid outlet 5185.

In an embodiment, the second drilling mud manifold 5220 may have an integral flange at a first drilling mud or completion fluid inlet 5225a.

In an embodiment, the fifth gate valve 5190 and the second drilling mud or completion fluid inlet 5225b of the second drilling mud manifold 5220 may be fluidly connected by a connection. Any suitable connection may be used for the fifth gate valve 5190 and the second drilling mud or completion fluid inlet 5225b of the second drilling mud manifold 5220. For example, suitable connections include, but are not limited to, flanges and pipe fittings. Connections are well known in the art.

In an embodiment, the fifth gate valve 5190 may have an integral flange at a fifth drilling mud or completion fluid inlet 5195 and/or a fifth drilling mud or completion fluid outlet 5200.

In an embodiment, the second drilling mud manifold 5220 may have an integral flange at a second drilling mud or completion fluid inlet 5225b.

In an embodiment, the second spool 5205 and the third drilling mud or completion fluid inlet 5225c of the second drilling mud manifold 5220 may be fluidly connected by a connection. Any suitable connection may be used for the second spool 5205 and the third drilling mud or completion fluid inlet 5225c of the second drilling mud manifold 5220. For example, suitable connections include, but are not limited to, flanges and pipe fittings. Connections are well known in the art.

In an embodiment, the second spool 5205 may have an integral flange at the second drilling mud or completion fluid inlet 5210 and/or the second drilling mud or completion fluid outlet 5215.

In an embodiment, the second drilling mud manifold 5220 may have an integral flange at the third drilling mud or completion fluid inlet 5225c.

In an embodiment, the second drilling mud or completion fluid outlet 5230 of the second drilling mud manifold 5200 and the second stub connection 5260 may be fluidly connected by a connection. Any suitable connection may be used for the second drilling mud or completion fluid outlet 5230 of the second drilling mud manifold 5200 and the second stub connection 5260. For example, suitable connections include, but are not limited to, flanges and pipe fittings. Connections are well known in the art.

In an embodiment, the second drilling mud manifold 5200 may have an integral flange at the second drilling mud or completion fluid outlet 5230.

In an embodiment, the second stub connection 5260 may have an integral flange at a second drilling mud or completion fluid inlet and/or a second drilling mud or completion fluid outlet.

Method of Using Drilling Mud Screen System

In an embodiment, the multi-screen drilling mud screen 100, 200, 800, 900 may be used to filter and/or screen debris from drilling mud during drilling operations. In an embodiment, the multi-screen drilling mud screen 100, 200, 800, 900 may be used to filter and/or screen particles from drilling mud during drilling operations or to filter and/or screen particles from completion fluid during completion operations.

FIG. 6 illustrates a flow diagram for a method of using the multi-screen drilling mud screen system, as discussed above. As shown in FIG. 6, the method of using a drilling mud screen system 600 comprises providing a multi-screen drilling mud screen system 605, stopping a drilling mud pump to stop flow of drilling mud 610, fluidly connecting a drilling mud or completion fluid inlet of the multi-screen drilling mud screen system downstream of an outlet to the drilling mud pump 615, fluidly connecting a drilling mud or completion fluid outlet of the multi-screen drilling mud screen system upstream of an outlet of a stand pipe 620, and starting the drilling mud pump to flow drilling mud or completion fluid through the multi-screen drilling mud screen system 625.

In an embodiment, step 615 comprises fluidly connecting a drilling mud or completion fluid inlet of the multi-screen drilling mud screen system to a high-pressure outlet of the drilling mud pump and fluidly connecting a drilling mud or completion fluid outlet of the multi-screen drilling mud screen system to a vibrator hose or a standpipe.

In an embodiment, step 615 comprises fluidly connecting a drilling mud or completion fluid inlet of the multi-screen drilling mud screen system to a high-pressure inlet of the drilling mud pump and fluidly connecting a drilling mud or completion fluid outlet of the multi-screen drilling mud screen system to an inlet of a vibrator hose.

In an embodiment, step 615 comprises fluidly connecting a drilling mud or completion fluid inlet of the multi-screen drilling mud screen system to an outlet of a vibrator hose and a drilling mud or completion fluid outlet of the multi-screen drilling mud screen system to an inlet of a standpipe.

In an embodiment, step 615 comprises fluidly connecting a drilling mud or completion fluid inlet of the multi-screen drilling mud screen system to an outlet of a first portion of a standpipe and a drilling mud or completion fluid outlet of the multi-screen drilling mud screen system to an inlet of a second portion of the standpipe.

In an embodiment, step 625 comprises filtering or screening debris from drilling mud. In an embodiment, step 625 comprises filtering or screening particles from drilling mud or completion fluid.

In an embodiment, the first drilling mud or completion fluid inlet 120a, 220a, 820a, 920a of the multi-screen drilling mud screen system 100, 200, 800, 900 may be fluidly connected to a high pressure outlet of the drilling mud pump via a connection. The inlet pressure to the first drilling mud or completion fluid inlet 120a, 220a, 820a, 920a of the multi-screen drilling mud screen system 100, 200, 800, 900 may be any suitable pressure.

In an embodiment, the inlet test pressure may be up to 22,500 psi, and any range or value there between, for drilling and completion applications.

In an embodiment, the inlet pressure may be from about 7500 psi to about 10,000 psi, and any range or value there between, for a drilling application. In an embodiment, the flow rate of the drilling mud may be up to about 800 gallons per minute at about 25 psi pressure drop.

In an embodiment, the inlet pressure may be from about 7500 psi to about 15000 psi, and any range or value there between, for a completion application. In an embodiment, the flow rate of completion fluid may be up to about 1250 gallon per minute at about 300 psi pressure drop for the completion application.

In an embodiment, the second drilling mud or completion fluid outlet 125b, 225b, 825b, 925b of the multi-screen drilling mud screen system 100, 200, 800, 900 may be fluidly connected to an inlet of a vibrator hose to the standpipe via a connection.

In an embodiment, the first drilling mud or completion fluid inlet 120a, 220a, 820a, 920a of the multi-screen drilling mud screen system 100, 200, 800, 900 may be fluidly connected to an outlet of a vibrator hose to a standpipe via a connection. In an embodiment, the second drilling mud or completion fluid outlet 125b, 225b, 825b, 925b of the multi-screen drilling mud screen system 100, 200, 800, 900 may be fluidly connected to an inlet of the standpipe via a connection.

In an embodiment, the multi-screen drilling mud screen system 100, 200, 800, 900 may be fluidly connected at any point in the standpipe via a connection.

Method of Removing and Replacing One or More Drilling Mud Screen

FIG. 7 illustrates a flow diagram for a method of installing and removing one or more drilling mud screens for the multi-screen drilling mud screen system, as discussed above. As shown in FIG. 7, the method of removing and replacing a drilling mud screen 700 comprises providing a multi-screen drilling mud screen system 705, stopping a drilling mud pump connected to the multi-screen drilling mud screen system 710, opening a first drilling mud or completion fluid outlet of a first sub-assembly and/or a second drilling mud or completion fluid inlet of a second sub-assembly in the multi-screen drilling mud screen system to remove and replace one or more drilling mud screen 715, accessing the interior of the multi-screen drilling mud screen system to pull the one or more drilling mud screen from the multi-screen drilling mud screen system and to install one or more replacement drilling mud screen into the multi-screen drilling mud screen system 720, closing the first drilling mud or completion fluid outlet of the first subassembly and/or the second drilling mud or completion fluid inlet of the second subassembly in the multi-screen drilling mud screen system 725, and operating the drilling mud pump to produce flow of drilling mud or completion fluid through the multi-screen drilling mud screen system 730.

In an embodiment, step 715 comprises opening a first drilling mud or completion fluid outlet of a first subassembly 2100a, 4350, 4360, 5235, 5245, 8100a, 9100a and/or a second drilling mud or completion fluid inlet of a second subassembly 2100b, 4355, 4365, 5240, 5250, 8100b, 9100b of the multi-screen drilling mud screen system 100, 200, 800, 900. See e.g., FIGS. 1A-1E, 2A-2C, 4A-4D, 5A-5E, 8A-8C & 9A-9B. In an embodiment, step 715 comprises opening the first drilling mud or completion fluid outlet of the first subassembly 2100a, 4350, 4360, 5235, 5245, 8100a, 9100a and/or the second drilling mud or completion fluid inlet of the second subassembly 2100b, 4355, 4365, 5240, 5250, 8100b, 9100b of the multi-screen drilling mud screen system 100, 200, 800, 900 to remove and replace one or more drilling mud screen 140a, 240a, 300, 840a, 940a.

In an embodiment, step 715 comprises rotating a first body 105a, 205a, 805a, 905a to disengage the first assembly 4350, 4360, 5235, 5245 and/or rotating a second body 105b, 205b, 805b, 905b to disengage the second assembly 4355, 4365, 5240, 5250 in the multi-screen drilling mud screen system 100, 200, 800, 900. See e.g., FIGS. 1A-1E, 2A-2C, 4A-4D, 5A-5E, 8A-8C & 9A-9B.

In an embodiment, step 715 comprises sliding the first body 105a, 205a, 805a, 905a further into the union system 1202, 2202, 8202, 9202 to fully disengage the first assembly 4350, 4360, 5235, 5245 and/or sliding the second body 105b, 205b, 805b, 905b further into the union system 1202, 2202, 8202, 9202 to fully disengage the second assembly 4355, 4365, 5240, 5250 in the multi-screen drilling mud screen system 100, 200, 800, 900. See e.g., FIGS. 1A-1E, 2A-2C, 4A-4D, 5A-5E, 8A-8C & 9A-9B.

In an embodiment, step 715 comprises lifting, lowering, rotating, pivoting, sliding or otherwise moving one or more of the first assembly 4350, 4360, 5235, 5245, the second assembly 4355, 4365, 5240, 5250, the first body 105a, 205a, 805a, 905a, the second body 105b, 205b, 805b, 905b and the union system 1202, 2202, 8202, 9202 of the multi-screen drilling mud screen system 100, 200, 800, 900 to open the multi-screen drilling mud screen system 100, 200, 800, 900 and to remove the one or more drilling mud screen 140a, 240a, 300, 840a, 940a. See e.g., FIGS. 1A-1E, 2A-2C, 4A-4D, 5A-5E, 8A-8C & 9A-9B.

In an embodiment, step 720 comprises removing the one or more drilling mud screen 140a, 240a, 300, 840a, 940a from the multi-screen drilling mud screen system 100, 200, 800, 900. See e.g., FIGS. 1A-1E, 2A-2C, 8A-8C & 9A-9B.

In an embodiment, step 720 comprises installing the one or more replacement drilling mud screen 140a, 240a, 300, 840a, 940a into the multi-screen drilling mud screen system 100, 200, 800, 900. See e.g., FIGS. 1A-1E, 2A-2C, 8A-8C & 9A-9B.

In an embodiment, step 725 comprises lifting, lowering, rotating, pivoting, sliding or otherwise moving the one or more of the first assembly 4350, 4360, 5235, 5245, the second assembly 4355, 4365, 5240, 5250, the first body 105a, 205a, 805a, 905a, the second body 105b, 205b, 805b, 905b and the union system 1202, 1202, 8202, 9202 of the multi-screen drilling mud screen system 100, 200, 800, 900 to close the multi-screen drilling mud screen system 100, 200, 800, 900. See e.g., FIGS. 1A-1E, 2A-2C, 4A-4D, 5A-5E, 8A-8C & 9A-9B.

In an embodiment, step 725 comprises sliding the first body 105a, 205a, 805a, 905a to engage the first assembly 4350, 4360, 5235, 5245 and sliding the second body 105b, 205b, 805b, 905b to engage the second assembly 4355, 4365, 5240, 5250 of the multi-screen drilling mud screen system 100, 200, 800, 900. See e.g., FIGS. 1A-1E, 2A-2C, 4A-4D, 5A-5E, 8A-8C & 9A-9B.

In an embodiment, step 725 comprises rotating the first body 105a, 205a, 805a, 905a to fully engage the first assembly 4350, 4360, 5235, 5245 and rotating the second body 105b, 205b, 805b, 905b to fully engage the second assembly 4355, 4365, 5240, 5250 in the multi-screen drilling mud screen system 100, 200, 800, 900. See e.g., FIGS. 1A-1E, 2A-2C, 4A-4D, 5A-5E, 8A-8C & 9A-9B.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms (e.g., “outer” and “inner,” “upper” and “lower,” “first” and “second,” “internal” and “external,” “above” and “below” and the like) are used as words of convenience to provide reference points and, as such, are not to be construed as limiting terms.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### Definitions

As used herein, the terms “a,” “an,” “the,” and “said” mean one or more, unless the context dictates otherwise.

As used herein, the term “about” means the stated value plus or minus a margin of error plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

1. A multi-screen drilling mud screen system, comprising:
(a) a first body having a first end and a second end;
(b) a first drilling mud or completion fluid inlet at the first end of the first body;
(c) a first drilling mud or completion fluid outlet at the second end of the first body;
(d) a second body having a first end, a mid-portion and a second end;
(e) a second drilling mud or completion fluid inlet at the first end of the second body, wherein the first drilling mud or completion fluid outlet of the first body is fluidly connected to the second drilling mud or completion fluid inlet of the second body;
(f) a second drilling mud or completion fluid outlet at the second end of the second body;
(g) a union system, comprising:
i. a third body having a first inlet at a first end and a first outlet at second end;
ii. a fourth body having a second inlet at a first end and a second outlet at a second end; and
iii. a fifth body having a first and second end;
iv. wherein the second end of the first body is disposed through the first end of the fifth body such that a portion of the third body is disposed between the second end of the second body and a portion of the first end of the fifth body; and
v. wherein the first end of the second body is disposed through the second end of the fifth body such that a portion of the fourth body is disposed between the first end of the second body and a portion of the second end of the fifth body; and
(h) a drilling mud screen assembly disposed within the first body and the second body between the first drilling mud or completion fluid inlet and the second drilling mud or completion fluid outlet.

2. The drilling mud screen system of claim 1, wherein the drilling mud screen assembly comprises:
(a) an assembly body having a first end and a second end;
(b) one or more drilling mud or completion fluid inlets at the first end of the assembly body;
(c) one or more drilling mud or completion fluid outlets at the second end of the assembly body; and
(d) one or more drilling mud screens fluidly connected to the one or more drilling mud or completion fluid outlet at the second end of the assembly body.

3. The drilling mud screen system of claim 1 further comprising:
(a) a first assembly having a first end and a second end;
(b) a third drilling mud or completion fluid inlet at the first end of the first assembly;
(c) a third drilling mud or completion fluid outlet at the second end of the first assembly, wherein the third drilling mud or completion fluid outlet of the first assembly is fluidly connected to the first drilling mud or completion fluid inlet of the first body;
(d) a second assembly having a first end and a second end;
(e) a fourth drilling mud or completion fluid inlet at the first end of the second assembly, wherein the second drilling mud or completion fluid outlet of the second body is fluidly connected to the fourth drilling mud or completion fluid inlet of the second assembly; and
(f) a fourth drilling mud or completion fluid outlet at the second end of the second assembly.

4. The drilling mud screen system of claim 1, wherein the second end of the first body is modified to reduce an inside surface exit angle to transition from a first inner diameter of the first body to a second inner diameter of the fifth body.

5. The drilling mud screen system of claim 4, wherein the exit angle is from about 10-degrees to about 90-degrees.

6. The drilling mud screen system of claim 5, wherein the exit angle is about 40-degrees.

7. The drilling mud screen system of claim 1, wherein the first end of the second body is modified to reduce an inside surface entry angle to transition from a first inner diameter of the fifth body to a second inner diameter of the second body.

8. The drilling mud screen system of claim 7, wherein the entry angle is from about 10-degrees to about 90-degrees.

9. The drilling mud screen system of claim 8, wherein the entry angle is about 30-degrees.

10. The drilling mud screen system of claim 1, wherein a mid-portion of the second body is modified to reduce an inside surface entry angle to transition from a first inner diameter of the second body to a second inner diameter of the second body.

11. The drilling mud screen system of claim 10, wherein the entry angle is from about 10-degrees to about 90-degrees.

12. The drilling mud screen system of the claim 11, wherein the entry angle is about 10-degrees or about 15-degrees.

13. The drilling mud screen system of claim 1, wherein the second end of the third body and the first end of the fifth body form a first union; and the second end of the fifth body and the first end of the fourth body form a second union.

14. The drilling mud screen system of claim 3, wherein the third drilling mud or completion fluid outlet of the first assembly is fluidly connected to the first drilling mud or completion fluid inlet of the first body via a connection.

15. The drilling mud screen system of claim 3, wherein the second drilling mud or completion fluid outlet of the second body is fluidly connected to the fourth drilling mud or completion fluid inlet of the second assembly via a connection.

16. The drilling mud screen system of claim 1, wherein the fifth body is capable of receiving a portion of the first body when the first drilling mud or completion fluid outlet of the first subassembly is opened.

17. The drilling mud screen system of claim 1, wherein the fifth body is capable of receiving a portion of the second body when the second drilling mud or completion fluid inlet of the second subassembly is opened.

18. The drilling mud screen system of claim 2, wherein the first end of the assembly body has a means to engage a drilling mud screen puller/installer tool.

19. The drilling mud screen system of claim 2, wherein a first end of each of the one or more drilling mud screen has a means to engage a drilling mud screen puller/installer tool.

20. The drilling mud screen system of claim 1, further comprising:
(a) a skid comprising:
i. a base; and
ii. a first support having a first end and a second end, wherein the first end of the first support is attached to the base and wherein the second end of the first support is attached to the union system.

21. The drilling mud screen system of claim 20, wherein the first support is capable of being lowered, pivoted, raised, rotated or any combination thereof.

22. The drilling mud screen system of claim 20, wherein the first support is capable of being lowered, pivoted, raised, rotated or any combination thereof via a connection, coupling and/or extension.

23. The drilling mud screen system of claim 20, wherein the first support is capable of being automatically lowered, pivoted, raised and/or rotated.

24. The drilling mud screen system of claim 20, wherein the first support is capable of being manually lowered, pivoted, raised and/or rotated.

25. The drilling mud screen system of claim 3 further comprising:
i. a second support having a first end and a second end, wherein the first end of the second support is attached to the base and wherein the second end of the second support is attached to the first assembly; and
ii. a third support having a first end and a second end, wherein the first end of the third support is attached to the base and wherein the second end of the third support is attached to the second assembly.

26. The drilling mud screen system of claim 25, wherein one or more of the second support and the third support is capable of being lowered, pivoted, raised, rotated or any combination thereof.

27. The drilling mud screen system of claim 25, wherein one or more of the second support and the third support is capable of being lowered, pivoted, raised, rotated or any combination thereof via a connection, coupling and/or extension.

28. The drilling mud screen system of claim 25, wherein the one or more of the second support and the third support is capable of being automatically lowered, pivoted, raised and/or rotated.

29. The drilling mud screen system of claim 25, wherein the one or more of the second support and the third support is capable of being manually lowered, pivoted, raised and/or rotated.

30. The drilling mud screen system of claim 3, wherein one or more of the first assembly, the second assembly, the first body, the second body, the third body and the fourth body are constructed from AISI 4140/120k or equivalent material, AISI 4145 or equivalent, or combinations thereof.

31. The drilling mud screen system of claim 2, wherein one or more of the assembly body and the drilling mud screen are constructed from AISI 4145 or equivalent, stainless steel or combinations thereof.

32. The drilling mud screen system of claim 2, wherein one or more of the assembly body and the drilling mud screen has a hardened coating.

33. A method of installing a multi-screen drilling mud screen system comprising the steps of:
(a) stopping a drilling mud pump to fluidly connect the multi-screen drilling mud screen of claim 1 to the drilling mud pump;
(b) fluidly connecting the multi-screen drilling mud screen system in line with and immediately upstream or downstream of the drilling mud pump; and
(c) operating the drilling mud pump to produce flow of drilling mud or completion fluid through the multi-screen drilling mud screen system.

34. The method of claim 33, wherein step c) comprises fluidly connecting a drilling mud or completion fluid inlet of the multi-screen drilling mud screen system to a high-pressure outlet of the drilling mud pump and fluidly connecting a drilling mud or completion fluid outlet of the multi-screen drilling mud screen system to a vibrator hose or a standpipe.

35. The method of claim 33, wherein step c) comprises fluidly connecting a drilling mud or completion fluid inlet of the multi-screen drilling mud screen system to a high-pressure inlet of the drilling mud pump and fluidly connecting a drilling mud or completion fluid outlet of the multi-screen drilling mud screen system to an inlet of a vibrator hose.

36. The method of claim 33, wherein step c) comprises fluidly connecting a drilling mud or completion fluid inlet of the multi-screen drilling mud screen system to an outlet of a vibrator hose and a drilling mud or completion fluid outlet of the multi-screen drilling mud screen system to an inlet of a standpipe.

37. The method of claim 33, wherein step c) comprises fluidly connecting a drilling mud or a completion fluid inlet of the multi-screen drilling mud screen system to an outlet of a first portion of a standpipe and a drilling mud or completion fluid outlet of the multi-screen drilling mud screen system to an inlet of a second portion of the standpipe.

38. The method of claim 33, further comprising the step e) filtering or screening particles from drilling mud or completion fluid.

39. A method of removing and replacing a drilling mud screen in a multi-screen drilling mud screen system comprising the steps:
(a) stopping a drilling mud pump connected to the multi-screen drilling mud screen system of claim 1;
(b) opening the first drilling mud or completion fluid outlet of the first subassembly and/or the second drilling mud or completion inlet of the second subassembly in the multi-screen drilling mud screen system to remove and replace one or more drilling mud screen;
(c) accessing the interior of the multi-screen drilling mud screen system to pull the one or more drilling mud screen from the multi-screen drilling mud screen system and to install one or more replacement drilling mud screen into the multi-screen drilling mud screen system;
(d) closing the first drilling mud or completion fluid outlet of the first subassembly and/or the second drilling mud or completion fluid inlet of the second subassembly in the multi-screen drilling mud screen system; and
(e) operating the drilling mud pump to produce flow of drilling mud or completion fluid through the multi-screen drilling mud screen system.

40. The method of claim 39, wherein step c) comprises:
(c-1) rotating the first body to disengage the first assembly and/or rotating the second body to disengage the second assembly;
(c-2) sliding the first body further into the union system to fully disengage the first assembly and/or sliding the second body into the union system to fully disengage the second assembly.

41. The method of claim 39, where step c) further comprises:
(c-3) lifting, lowering, pivoting, rotating, sliding or otherwise moving one or more of the first assembly, the second assembly, the union system and any combination thereof to open the multi-screen drilling mud screen system to remove the one or more drilling mud screen.

42. The method of claim 39, wherein step d) further comprises using a puller/installer plate of a puller/installer tool to engage and pull the one or more drilling mud screen from the multi-screen drilling mud screen system.

43. The method of claim 39, wherein step d) further comprises using a puller/installer plate and/or a rounded end of a puller/installer tool to install the one or more replacement drilling mud screen into the multi-screen drilling mud screen system and, optionally, using a stop plate, groove or painted line of the puller/installer tool to determine when the one or more replacement drilling mud screen is installed into the multi-screen drilling mud screen system.

44. The method of claim 39, wherein step e) comprises:
(e-1) lifting, lowering, pivoting, rotating, sliding or otherwise moving one or more of a first assembly, a second assembly, the union system and any combination thereof to close the multi-screen drilling mud screen system;
(e-2) sliding the first body to engage the first assembly and/or sliding the second body to engage the second body;
(e-3) rotating the first body to fully engage the first assembly and/or rotating the second body to fully engage the second assembly.

45. A flow loop configuration comprising:
(a) a first drilling mud manifold having a first drilling mud or completion fluid inlet and a plurality of first drilling mud or completion fluid outlets;
(b) a plurality of the drilling mud screen systems of claim 1;
(c) a second drilling mud manifold having a plurality of second drilling mud or completion fluid inlets and a second drilling mud or completion fluid outlet;
(d) wherein one of the plurality of first drilling mud or completion fluid outlets are fluidly connected to each of the first drilling mud or completion fluid inlets of the plurality of drilling mud screen systems; and
(e) wherein each the first drilling mud or completion fluid outlets of the plurality of drilling mud screen systems are fluidly connected to one of the plurality of second drilling mud or completion fluid inlets of the second drilling mud manifold.

46. The flow loop configuration of claim 45 further comprising a first plurality of gate valves, wherein each of the plurality of first drilling mud or completion fluid outlets of the first manifold are fluidly connected to one of the first plurality of gate valves and each of the first plurality of gate valves is fluidly connected to one of the first drilling mud or completion fluid inlets of the plurality of drilling mud screen systems.

47. The flow loop configuration of claim 46 further comprising a second plurality of gate valves, wherein each of the first drilling mud or completion fluid outlets of the plurality of drilling mud screen systems is fluidly connected to one of the second plurality of gate valves and each of the second plurality of gate valves is fluidly connected to one of second drilling mud or completion fluid inlets of the second manifold.

48. The flow loop configuration of claim 47, further comprising a third gate valve, wherein one of the plurality of first drilling mud or completion fluid outlets of the first manifold is fluidly connected to a third drilling mud or completion fluid inlet of the third gate valve and a third drilling mud or completion fluid outlet of the third gate valve is fluidly connected to one of the plurality of drilling mud or completion fluid inlets of the second manifold.

49. A drilling mud screen assembly comprising:
(a) an assembly body having a first end and a second end;
(b) one or more drilling mud or completion fluid inlets at the first end of the assembly body;
(c) one or more drilling mud or completion fluid outlets at the second end of the assembly body;
(d) one or more drilling mud screens fluidly connected to the one or more drilling mud or completion fluid outlet at the second end of the assembly body.

50. The drilling mud screen system of claim 49, wherein the one or more drilling mud screens are structured to filter particles sizes from about 3/16-inches and larger from drilling mud.

51. The drilling mud screen assembly of claim 49, wherein the one or more drilling mud screens are structured to filter particle sizes from about 200 microns to about 2500 microns from completion fluid.

52. A method of installing a flow loop configuration comprising the steps of:
(a) stopping a drilling mud pump to fluidly connect the flow loop configuration of claim 45 to the drilling mud pump;
(b) fluidly connecting the flow loop configuration in line with and immediately upstream or downstream of the drilling mud pump; and
(c) operating the drilling mud pump to produce flow of drilling mud or completion fluid through the flow loop configuration.

53. The method of claim 52, wherein step c) comprises fluidly connecting a drilling mud or completion fluid inlet of the flow loop configuration to a high-pressure outlet of the drilling mud pump and fluidly connecting a drilling mud or completion fluid outlet of the flow loop configuration to a vibrator hose or a standpipe.

54. The method of claim 52, wherein step c) comprises fluidly connecting a drilling mud or completion fluid inlet of the flow loop configuration to a high-pressure inlet of the drilling mud pump and fluidly connecting a drilling mud or completion fluid outlet of the flow loop configuration to an inlet of a vibrator hose.

55. The method of claim 52, wherein step c) comprises fluidly connecting a drilling mud or completion fluid inlet of the flow loop configuration to an outlet of a vibrator hose and a drilling mud or completion fluid outlet of the flow loop configuration to an inlet of a standpipe.

56. The method of claim 52, wherein step c) comprises fluidly connecting a drilling mud or a completion fluid inlet of the flow loop configuration to an outlet of a first portion of a standpipe and a drilling mud or completion fluid outlet of the flow loop configuration to an inlet of a second portion of the standpipe.

57. The method of claim 52, further comprising the step e) filtering or screening particles from drilling mud or completion fluid.

58. The method of claim 52, wherein at least one of the plurality of drilling mud screen systems is structured to filter particles from drilling mud and wherein at least one of the plurality of drilling mud screen systems is structured to filter particles from completion fluid.

59. The method of claim 52, wherein at least one of the plurality of drilling mud screen systems is structured to filter particles sizes from about 3/16-inches and larger from drilling mud.

60. The method of claim 52, wherein at least one of the plurality of drilling mud screen systems is structured to filter particles sizes from about 200 microns to about 2500 microns from completion fluid.

61. The drilling mud screen assembly of claim 49 comprising from about one to about twenty drilling mud screens.

62. The drilling mud screen assembly of claim 49 comprising from about one to about ten drilling mud screens.

63. The drilling mud screen assembly of claim 49 comprising about four drilling mud screens.

64. The drilling mud screen assembly of claim 49, wherein one or more of the assembly body and the drilling mud screen is constructed from AISI 4145 or equivalent material, stainless steel or combinations thereof.

65. The drilling mud screen assembly of claim 49, wherein one or more of the assembly body and the drilling mud screen has a hardened coating.

66. The drilling mud screen assembly of claim 49, wherein the assembly body has a means to engage a puller/installer tool.

67. The drilling mud screen assembly of claim 49, wherein the assembly body has a first portion and a second portion, wherein the first portion has a first length from about 4-inches to about 8-inches, and the second portion has a second length from about 5-inches to about 15-inches.

68. The drilling mud screen assembly of claim 49, wherein the assembly body comprises a centerline, wherein the centerline of the assembly body and an outer surface of the assembly body form an angle, and wherein the angle is from about 30-degrees to about 60-degrees.

69. The drilling mud screen assembly of claim 49, wherein the assembly body comprises a centerline, wherein a plurality of drilling mud or completion fluid inlets are disposed radially around the centerline of the assembly body and a plurality of drilling mud or completion fluid outlets are disposed radially around the centerline of the assembly body.

70. The drilling mud screen assembly of claim 49, wherein each of the one or more drilling mud screen comprises
(a) a drilling mud screen body having a first end and a second end;
(b) a drilling mud or completion fluid inlet at the first end of the drilling mud screen body;
(c) a filter having a first end, a second end and openings, wherein the first end of the filter is fluidly connected to the second end of the drilling mud screen body;
(d) a drilling mud or completion fluid outlet at the openings of the filter; and
(e) an end cap fluidly connected at the second end of the filter.

71. The drilling mud screen system of claim 70, wherein each of the one or more drilling mud screens are structured to filter particles sizes from about 3/16-inches and larger from drilling mud.

72. The drilling mud screen assembly of claim 70, wherein each of the one or more drilling mud screens are structured to filter particle sizes from about 200 microns to about 2500 microns from completion fluid.

73. The drilling mud screen assembly of claim 70, wherein one or more of the drilling mud screen body, the filter and the end cap are constructed of AISI 4145 or equivalent material, tool steel, stainless steel or combinations thereof.

74. The drilling mud screen assembly of claim 70, wherein one or more of the drilling mud screen body, the filter and the end cap has a hardened coating.

75. The drilling mud screen assembly of claim 70, wherein the drilling mud screen body has a means to engage a puller/installer tool.

76. The drilling mud screen assembly of claim 70, wherein the filter comprises a plurality of rods spaced a distance apart to form the openings in the filter.

77. The drilling mud screen assembly of claim 70, wherein the filter comprises a formed sheet having drilled holes or slots spaced apart to form the openings in the filter.

78. The drilling mud screen assembly of claim 70, wherein the filter comprises a plurality of rods spaced apart disposed in a formed sheet having drilled holes or slots spaced apart to form the openings in the filter.

79. The drilling mud screen assembly of claim 70, wherein the filter comprises a wire wrap disposed in a formed sheet having drilled holes or slots spaced apart to form the openings in the filter.

80. A drilling mud screen comprising:
(a) a body having a first end and a second end;
(b) a drilling mud or completion fluid inlet at the first end of the body;
(c) a filter having a first end, a second end and openings, wherein the filter is fluidly connected to the second end of the body;
(d) a drilling mud or completion fluid outlet at the openings of the filter; and
(e) an end cap fluidly connected at the second end of the filter;
(f) wherein the filter comprises:
i. a plurality of rods spaced a distance apart disposed within a formed sheet having drilled holes or slots spaced apart to form the openings in the filter; or
ii. a wire wrap disposed within a formed sheet having drilled holes or slots spaced apart to form the openings in the filter.

81. The drilling mud screen system of claim 79, wherein each of the one or more drilling mud screens are structured to filter particles sizes from about 3/16-inches and larger from drilling mud.

82. The drilling mud screen assembly of claim 79, wherein each of the one or more drilling mud screens are structured to filter particle sizes from about 200 microns to about 2500 microns from completion fluid.

83. The drilling mud screen of claim 79, wherein one or more of the body, the filter and the end cap are constructed of AISI 4145 or equivalent material, tool steel, stainless steel or combinations thereof.

84. The drilling mud screen of claim 79, wherein one or more of the drilling mud screen body, the filter and the end cap has a hardened coating.

85. The drilling mud screen assembly of claim 79, wherein the body has a means to engage a puller/installer tool.

86. The drilling mud screen assembly of claim 79, wherein the filter comprises the plurality of rods spaced a distance apart disposed within the formed sheet having drilled holes or slots to form the openings in the filter.

87. The drilling mud screen of claim 86, wherein each of the plurality of rods have a first end and a second end and wherein each of the rods are tapered from first end to the second end.

88. The drilling mud screen assembly of claim 79, wherein the filter comprises the wire wrap disposed in the formed sheet having drilled holes or slots spaced apart to form the openings in the filter.

89. The drilling mud screen of claim 88, wherein the drilled holes or slots are drilled in offset rows or straight rows from the first end to the second end.

90. The drilling mud screen of claim 79, wherein the filter is tapered from the first end to the second end.

91. The drilling mud screen system of claim 1, further comprising:
(a) a first shoulder connection between the first body and the third body.

92. The drilling mud screen system of claim 91, further comprising:
(a) a second shoulder connection between the second body and the fourth body.

93. The drilling mud screen system of claim 1, further comprising:
(a) a first shoulder connection between the first body and the third body and/or between the first body and the fifth body.

94. The drilling mud screen system of claim 93, further comprising:
(a) a second shoulder connection between the second body and the fourth body and/or between the second body and the fifth body.

95. The drilling mud screen system of claim 1, further comprising:
(a) a first shoulder connection between the first body and the third body comprising:
i. a first box shoulder of the first body at a first box angle with respect to a first perpendicular to a centerline of the first body at a first end point, wherein the first box angle is from about 0 degrees to about 30 degrees;
ii. a first pin shoulder of the third body at a first pin angle with respect to a second perpendicular to the centerline of the first body at a second end point.

96. The drilling mud screen system of claim 95, wherein the first box angle is about 15 degrees and wherein the first pin angle is about 15 degrees.

97. The drilling mud screen system of claim 95, wherein the first box angle is about 0 degrees and wherein the first pin angle is about 0 degrees.

98. The drilling mud screen system of claim 95, further comprising:
(a) a second shoulder connection between the second body and the fourth body comprising:
i. a second box shoulder of the second body at a second box angle with respect to a third perpendicular to a centerline of the second body at a third end point, wherein the second box angle is from about 0 degrees to about 30 degrees;
ii. a second pin shoulder of the fourth body at a second pin angle with respect to a fourth perpendicular to the centerline of the second body at a fourth end point, wherein the second pin angle is from about 0 degrees to about 30 degrees.

99. The drilling mud screen system of claim 98, wherein the second box angle is about 15 degrees and wherein the second pin angle is about 15 degrees.

100. The drilling mud screen system of claim 98, wherein the second box angle is about 0 degrees and wherein the second pin angle is about 0 degrees.

101. The drilling mud screen system of claim 1, wherein the drilling mud screen assembly comprises:
(a) an assembly body having a first end and a second end;
(b) one or more drilling mud or completion fluid inlets at the first end of the assembly body;
(c) one or more drilling mud or completion fluid outlets at the second end of the assembly body; and
(d) one or more drilling mud screens fluidly connected to the one or more drilling mud or completion fluid inlet at the first end of the assembly body.

102. A drilling mud screen assembly comprising:
(a) an assembly body having a first end and a second end;
(b) one or more drilling mud or completion fluid inlets at the first end of the assembly body;
(c) one or more drilling mud or completion fluid outlets at the second end of the assembly body;
(d) one or more drilling mud screens fluidly connected to the one or more drilling mud or completion fluid inlet at the first end of the assembly body.

103. The drilling mud screen system of claim 102, wherein the one or more drilling mud screens are structured to filter particles sizes from about 3/16-inches and larger from drilling mud.

104. The drilling mud screen assembly of claim 102, wherein the one or more drilling mud screens are structured to filter particle sizes from about 200 microns to about 2500 microns from completion fluid.

105. The drilling mud screen assembly of claim 102, wherein each of the one or more drilling mud screen comprises
(a) a drilling mud screen body having a first end and a second end;
(b) a drilling mud or completion fluid inlet at the first end of the drilling mud screen body;
(c) a filter having a first end, a second end and openings, wherein the second end of the filter is fluidly connected to the first end of the drilling mud screen body;
(d) a drilling mud or completion fluid inlet at the openings of the filter; and
(e) an end cap fluidly connected at the first end of the filter.

106. The drilling mud screen system of claim 105, wherein each of the one or more drilling mud screens are structured to filter particles sizes from about 3/16-inches and larger from drilling mud.

107. The drilling mud screen assembly of claim 105, wherein each of the one or more drilling mud screens are structured to filter particle sizes from about 200 microns to about 2500 microns from completion fluid.

108. The drilling mud screen assembly of claim 105, wherein one or more of the drilling mud screen body, the filter and the end cap are constructed of AISI 4145 or equivalent material, tool steel, stainless steel or combinations thereof.

109. The drilling mud screen assembly of claim 105, wherein one or more of the drilling mud screen body, the filter and the end cap has a hardened coating.

110. The drilling mud screen assembly of claim 105, wherein the filter comprises a plurality of rods spaced a distance apart to form the openings in the filter.

111. The drilling mud screen assembly of claim 105, wherein the filter comprises a formed sheet having drilled holes or slots spaced apart to form the openings in the filter.

112. The drilling mud screen assembly of claim 105, wherein the filter comprises a plurality of rods spaced apart disposed in a formed sheet having drilled holes or slots spaced apart to form the openings in the filter.

113. The drilling mud screen assembly of claim 105, wherein the filter comprises a wire wrap disposed in a formed sheet having drilled holes or slots spaced apart to form the openings in the filter.

114. A drilling mud screen comprising:
(a) a body having a first end and a second end;
(b) a drilling mud or completion fluid inlet at the first end of the body;
(c) a filter having a first end, a second end and openings, wherein the second end of the filter is fluidly connected to the second end of the body;
(d) a drilling mud or completion fluid outlet at the openings of the filter; and
(e) an end cap fluidly connected at the first end of the filter;
(f) wherein the filter comprises:
i. a plurality of rods spaced a distance apart disposed within a formed sheet having drilled holes or slots spaced apart to form the openings in the filter; or
ii. a wire wrap disposed within a formed sheet having drilled holes or slots spaced apart to form the openings in the filter.

115. The drilling mud screen system of claim 114, wherein each of the one or more drilling mud screens are structured to filter particles sizes from about 3/16-inches and larger from drilling mud.

116. The drilling mud screen assembly of claim 114, wherein each of the one or more drilling mud screens are structured to filter particle sizes from about 200 microns to about 2500 microns from completion fluid.

117. The drilling mud screen of claim 114, wherein one or more of the body, the filter and the end cap are constructed of AISI 4145 or equivalent material, tool steel, stainless steel or combinations thereof.

118. The drilling mud screen of claim 114, wherein one or more of the drilling mud screen body, the filter and the end cap has a hardened coating.

119. The drilling mud screen assembly of claim 114, wherein the filter comprises the plurality of rods spaced a distance apart disposed within the formed sheet having drilled holes or slots to form the openings in the filter.

120. The drilling mud screen of claim 119, wherein each of the plurality of rods have a first end and a second end and wherein each of the rods are tapered from first end to the second end.

121. The drilling mud screen assembly of claim 114, wherein the filter comprises the wire wrap disposed in the formed sheet having drilled holes or slots spaced apart to form the openings in the filter.

122. The drilling mud screen of claim 121, wherein the drilled holes or slots are drilled in offset rows or straight rows from the first end to the second end.

123. The drilling mud screen of claim 114, wherein the filter is tapered from the first end to the second end.

124. The drilling mud screen of claim 114, wherein an outer surface of the end cap and a centerline of the body form an angle and wherein the angle is from about 30-degrees to about 90-degrees.

125. The drilling mud screen of claim 124, wherein the angle is about 45-degrees.
